(19) United States
(12) Patent Application Publication
(10) Pub. No.: US 2018/0213216 A1
(43) Pub. Date: Jul. 26, 2018

(54) MEDIA DATA TRANSMISSION DEVICE, MEDIA DATA RECEPTION DEVICE, MEDIA DATA TRANSMISSION METHOD, AND MEDIA DATA RECECPTION METHOD

(71) Applicant: LG Electronics Inc., Seoul (KR)

(72) Inventors: Soojin HWANG, Seoul (KR); Jongyeul SUH, Seoul (KR); Sejin OH, Seoul (KR)

(73) Assignee: LG Electronics Inc., Seoul (KR)

(21) Appl. No.: 15/575,947

(22) PCT Filed: Jun. 14, 2016
(86) PCT No.: PCT/KR2016/006289

§ 371 Date: Nov. 21, 2017

Related U.S. Application Data
(60) Provisional application No. 62/180,057, filed on Jun. 16, 2015.
(60) Provisional application No. 62/184,208, filed on Jun. 24, 2015.
(60) Provisional application No. 62/190,269, filed on Jul. 9, 2015.

(51) Int. Cl. H04N 13/161; H04N 13/178; H04N 13/156; H04N 7/01; H04N 13/167; H04N 13/194; H04N 19/44

(52) U.S. Cl. CPC H04N 13/161; H04N 13/178; H04N 13/156; H04N 19/44; H04N 13/167; H04N 13/194; H04N 7/01

(57) ABSTRACT

A media data transmission method according to one embodiment of the present invention comprises the steps of: generating a media file including three-dimensional (3D) video data and meta data; and transmitting the media file, wherein the media file includes, as at least one track, left view image data and right view image data of the 3D video data, and the meta data can include stereoscopic composition type information on the 3D video data.

### TECHNICAL FIELD

The present invention relates to a media data transmission device, a media data reception device, and a media data transmitting and receiving method.

### BACKGROUND ART

As the video signal processing speed has become faster, a solution for encoding/decoding ultra high definition (UHD) video is being developed. A solution for processing UHD video as well as HD video without any problem, when receiving the UHD video by using a legacy (or conventional) HD receiver, is being developed. For example in case an aspect ratio of a video that is being transmitted is different from an aspect ratio of a display device of a receiver, each receiver shall be capable of processing the corresponding video at an aspect ratio best-fitting the display device.

However, in case of a related art device decoding is not supported for a compressed video having a 21:9 format, which corresponds to the aspect ratio of a UHD video. In case a video of 21:9 is being transmitted, a receiver having the aspect ratio of 21:9 is required to directly process and display the video of 21:9, and a receiver having the aspect ratio of 16:9 is required to first receive a video stream having the aspect ratio of 21:9 and then output the received video stream in a letterbox format, or required to first receive a cropped video having the aspect ratio of 16:9 and then output a video signal. Additionally, in case subtitles are included in the stream, the receiver having the aspect ratio of 16:9 shall be capable of processing subtitle information.

As described above, since the aspect ratio of a legacy HD receiver or a receiver that can process UHD video can be different, in case the corresponding video is transmitted or received and then processes, a problem may occur.

In addition, when a media file format includes 3 dimensional (3D) video data, metadata for displaying the video data by a receiver needs to be transmitted therewith. In particular, when the corresponding 3D video data is capable of supporting a 2D service therewith, information on a track or layer used to provide a 2D or 3D service among video data included in the media file format needs to be contained in the media file format therewith.

### DISCLOSURE

### Technical Problem

An object of the present invention devised to provide a digital broadcast system for providing an ultra high definition (UHD) image, multi channel audio, and various additional services. For digital broadcast, there is a need to improve network flexibility in consideration of data transmission efficiency for a large amount of data transmission, robustness of a transceiving network, and a mobile reception device.

An object of the present invention is to provide a method for transceiving signals and an apparatus for transceiving signals that can process different videos having different aspect ratios through a receiver having a display device having a different aspect ratio.

Another object of the present invention is to provide a method for transceiving signals and an apparatus for transceiving signals that can receive or transmit backward compatible video, which can be processed by receivers being capable of respectively processing a HD video and a UHD video, each having a different aspect ratio.

Another object of the present invention is to provide a method for transceiving signals and an apparatus for transceiving signals that can process signaling information, which can differently process different HD videos and UHD videos each having a different aspect ratio in accordance with the specification of each receiver.

Another object of the present invention is to provide metadata for displaying 3D video data included in a media file format in 2D or 3D.

### Technical Solution

The object of the present invention can be achieved by providing a method of transmitting media data, including generating a media file including three-dimensional (3D) video data and metadata, and transmitting the media file, wherein the media file includes left view image data and right view image data of the 3D video data as at least one track, and wherein the metadata includes stereoscopic composition type information of the 3D video data.

The 3D video data may be scalable high efficiency video coding (SHVC)-encoded data.

The metadata may further include information indicating whether two-dimensional (2D) service is capable of being provided using the 3D video data.

The metadata may further include information indicating a number of tracks for the 2D service, included in the media file.

The metadata may further include information indicating an identifier (ID) of a track for a 2D service of at least one track included in the media file.

When the track included in the media file includes a plurality of layers, the metadata may include information on a number of the layers included in the track, information on a number of layers for a 2D service among the plurality of layers, and information on an identifier of the layer for the 2D service.

When the track included in the media file includes a plurality of layer, the metadata may include information indicating a number of layers included in at least one track corresponding to a corresponding one of a left view and right view for a 3D service among the plurality of layers.

In another aspect of the present invention, provided herein is a media data transmission device including a file generator configured to generate a media file including three-dimensional (3D) video data and metadata, and a transmitter configured to transmit the media file, wherein the media file includes left view image data and right view image data of the 3D video data as at least one track, and wherein the metadata includes stereoscopic composition type information of the 3D video data.

The 3D video data may be scalable high efficiency video coding (SHVC)-encoded data.

The metadata may further include information indicating whether two-dimensional (2D) service is capable of being provided using the 3D video data.

The metadata may further include information indicating a number of tracks for the 2D service, included in the media file.

The metadata may further include information indicating an identifier (ID) of a track for a 2D service of at least one track included in the media file.

When the track included in the media file includes a plurality of layers, the metadata may include information on a number of the layers included in the track, information on a number of layers for a 2D service among the plurality of layers, and information on an identifier of the layer for the 2D service.

When the track included in the media file includes a plurality of layer, the metadata may include information indicating a number of layers included in at least one track corresponding to a corresponding one of a left view and right view for a 3D service among the plurality of layers.

### Advantageous Effects

According to an exemplary embodiment of the present invention, videos having different aspect ratios may be processed through a receiver having a display device having a different aspect ratio.

According to an exemplary embodiment of the present invention, backward compatible video, which can be processed by receivers being capable of respectively processing a HD video and a UHD video, each having a different aspect ratio, may be transmitted or received.

According to an exemplary embodiment of the present invention, HD videos and UHD videos each having a different aspect ratio may be processed differently in accordance with the specification of each receiver.

According to an exemplary embodiment of the present invention. 3D video received through a media file format may be displayed in 2D or 3D.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a diagram showing a protocol stack according to an embodiment of the present invention.

FIG. 2 is a diagram showing a service discovery procedure according to one embodiment of the present invention.

FIG. 3 is a diagram showing a low level signaling (LLS) table and a service list table (SLT) according to one embodiment of the present invention.

FIG. 4 is a diagram showing a USBD and an S-TSID delivered through ROUTE according to one embodiment of the present invention.

FIG. 5 is a diagram showing a USBD delivered through MMT according to one embodiment of the present invention.

FIG. 6 is a diagram showing link layer operation according to one embodiment of the present invention.

FIG. 7 is a diagram showing a link mapping table (LMT) according to one embodiment of the present invention.

FIG. 8 is a diagram showing a structure of a broadcast signal transmission device of a next-generation broadcast service according to an embodiment of the present invention.

FIG. 9 is a writing operation of a time interleaver according to an embodiment of the present invention.

FIG. 10 is a block diagram of an interleaving address generator including a main-PRBS generator and a sub-PRBS generator according to each FFT mode, included in the frequency interleaver, according to an embodiment of the present invention.

FIG. 11 is a block diagram illustrating a hybrid broadcast reception apparatus according to an embodiment of the present invention.

FIG. 12 is a diagram showing an overall operation of a DASH-based adaptive streaming model according to an embodiment of the present invention.

FIG. 13 is a block diagram of a receiver according to an embodiment of the present invention.

FIG. 14 is a diagram showing a configuration of a media file according to an embodiment of the present invention.

FIG. 15 is a diagram illustrating a configuration of a file for a hybrid 3D service based on scalable high efficiency video coding (SHVC) according to an embodiment of the present invention.

FIG. 16 is a diagram showing file type box ftyp according to an embodiment of the present invention.

FIG. 17 is a diagram showing a hybrid 3D overall information box (h3oi) according to an embodiment of the present invention.

FIG. 18 is a diagram showing a hybrid 3D overall information box (h3oi) according to another embodiment of the present invention.

FIG. 19 is a diagram showing a track reference (tref) box according to an embodiment of the present invention.

FIG. 20 is a diagram showing a track group (trgr) box according to an embodiment of the present invention.

FIG. 21 is a diagram showing a hybrid 3D video media information (h3vi) box according to an embodiment of the present invention.

FIG. 22 is a diagram showing hybrid 3D video media information (h3vi) according to another embodiment of the present invention.

FIG. 23 is a diagram showing extension of a sample group (sbgp) box according to another embodiment of the present invention.

FIG. 24 is a diagram showing extension of a visual sample group entry according to an embodiment of the present invention.

FIG. 25 is a diagram showing extension of a sub track sample group (stsg) box according to another embodiment of the present invention.

FIG. 26 is a diagram showing a method of transmitting a media file according to an embodiment of the present invention.

FIG. 27 is a diagram showing a media file transmission device according to an embodiment of the present invention.

FIG. 28 illustrates a method for transmitting signals according to an exemplary embodiment of the present invention.

FIG. 29 illustrates a general view of an example of transmitting a high resolution image to fit aspect ratios of receivers according to an exemplary embodiment of the present invention.

FIG. 30 illustrates a general view of an exemplary stream structure transmitting the high resolution image to fit aspect ratios of receivers according to the exemplary embodiment of the present invention of FIG. 29.

FIG. 31 illustrates a general view of another example of transmitting a high resolution image to fit aspect ratios of receivers according to an exemplary embodiment of the present invention.

FIG. 32 illustrates a general view of a method for transceiving signals according to another exemplary embodiment of the present invention.

FIG. 33 illustrates an exemplary output of a subtitle area, when transmission is performed as shown in FIG. 32.

FIG. 34 illustrates an example of displaying a caption window for subtitles in a receiver that can receive UHD video, when transmission is performed as shown in FIG. 32.

FIG. 35 illustrates an exemplary method for encoding or decoding video data in case of transmitting video data according to a first exemplary embodiment of the present invention.

FIG. 36 illustrates an exemplary method for encoding or decoding video data in case of transmitting video data according to a second exemplary embodiment of the present invention.

FIG. 37 illustrates an example of an encoder encoding high-resolution video data according to a first exemplary embodiment of the present invention.

FIG. 38 illustrates an example of original video, which is separated according to the first exemplary embodiment of the present invention, an exemplary resolution of the separated video.

FIG. 39 illustrates an example of a decoder decoding high-resolution video data according to a first exemplary embodiment of the present invention.

FIG. 40 illustrates an example of merging and filtering cropped videos of the first exemplary embodiment of the present invention.

FIG. 41 illustrates a first example of a receiver according to a second exemplary embodiment of the present invention.

FIG. 42 illustrates exemplary operations of a receiver according to a third exemplary embodiment of the present invention.

FIG. 43 illustrates exemplary signaling information that allows video to be displayed according to the first exemplary embodiment of the present invention.

FIG. 44 illustrates detailed syntax values of signaling information according to a first exemplary embodiment of the present invention.

FIG. 45 illustrates an example of a stream level descriptor when following the first exemplary embodiment of the present invention.

FIG. 46 illustrates an exemplary value of information indicating resolution and frame rate of the video given as an example shown above.

FIG. 47 illustrates exemplary information respective to an aspect ratio of the original video. Among the above-described signaling information, the original_UHD_video_aspect_ratio field indicates information related to the aspect ratio of the original UHD video.

FIG. 48 illustrates exemplary direction information of a cropped video.

FIG. 49 illustrates an exemplary method for configuring a video.

FIG. 50 illustrates an exemplary encoding method in case of encoding sub streams.

FIG. 51 illustrates a stream level descriptor according to the first embodiment of the present invention.

FIG. 52 illustrates exemplary signaling information in case of following the third exemplary embodiment of the present invention.

FIG. 53 is illustrates an exemplary field value of an exemplary UHD_video_component_type field.

FIG. 54 is illustrates an exemplary field value of an exemplary UHD_video_include_subtitle field.

FIG. 55 is illustrates exemplary operations of the receiver, in case a format of a transmission video and a display aspect ratio of the receiver are different.

FIG. 56 is a diagram showing signaling information according to the fourth embodiment of the present invention.

FIG. 57 illustrates an exemplary case when the exemplary descriptors are included in other signaling information.

FIG. 58 illustrates an exemplary case when the exemplary descriptors are included in other signaling information.

FIG. 59 illustrates an exemplary case when the exemplary descriptors are included in other signaling information.

FIG. 60 illustrates an exemplary syntax of a payload of a SEI section of video data according to the exemplary embodiments of the present invention.

FIG. 61 illustrates an example of a receiving apparatus that can decode and display video data according to at least one exemplary embodiment of the present invention, in case the video data are transmitted according to the exemplary embodiments of the present invention.

FIG. 62 illustrates a method for receiving signals according to an exemplary embodiment of the present invention.

FIG. 63 illustrates an apparatus for transmitting signals according to an exemplary embodiment of the present invention.

FIG. 64 illustrates an apparatus for receiving signals according to an exemplary embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

Although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The present invention provides apparatuses and methods for transmitting and receiving broadcast signals for future broadcast services. Future broadcast services according to an embodiment of the present invention include a terrestrial broadcast service, a mobile broadcast service, an ultra high definition television (UHDTV) service, etc. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc. The present invention proposes a physical profile (or system) that is optimized to minimize the complexity of a receiver while achieving performance required for a specific use.

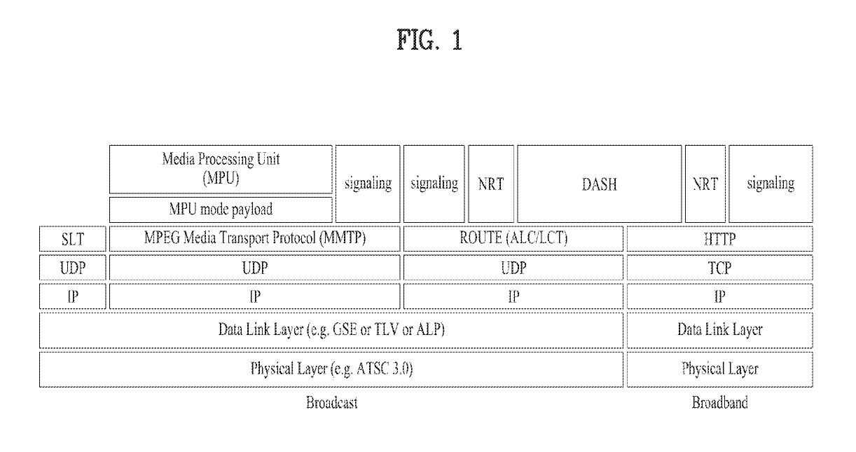

FIG. 1 is a diagram showing a protocol stack according to an embodiment of the present invention.

A service may be delivered to a receiver through a plurality of layers. First, a transmission side may generate service data. The service data may be processed for transmission at a delivery layer of the transmission side and the service data may be encoded into a broadcast signal and transmitted over a broadcast or broadband network at a physical layer.

Here, the service data may be generated in an ISO base media file format (BMFF). ISO BMFF media files may be used for broadcast/broadband network delivery, media encapsulation and/or synchronization format. Here, the service data is all data related to the service and may include service components configuring a linear service, signaling information thereof, non real time (NRT) data and other files.

The delivery layer will be described. The delivery layer may provide a function for transmitting service data. The service data may be delivered over a broadcast and/or broadband network.

Broadcast service delivery may include two methods.

As a first method, service data may be processed in media processing units (MPUs) based on MPEG media transport (MMT) and transmitted using an MMT protocol (MMTP). In this case, the service data delivered using the MMTP may include service components for a linear service and/or service signaling information thereof.

As a second method, service data may be processed into DASH segments and transmitted using real time object delivery over unidirectional transport (ROUTE), based on MPEG DASH. In this case, the service data delivered through the ROUTE protocol may include service components for a linear service, service signaling information thereof and/or NRT data. That is, the NRT data and non-timed data such as files may be delivered through ROUTE.

Data processed according to MMTP or ROUTE protocol may be processed into IP packets through a UDP/IP layer. In service data delivery over the broadcast network, a service list table (SLT) may also be delivered over the broadcast network through a UDP/IP layer. The SLT may be delivered in a low level signaling (LLS) table. The SLT and LLS table will be described later.

IP packets may be processed into link layer packets in a link layer. The link layer may encapsulate various formats of data delivered from a higher layer into link layer packets and then deliver the packets to a physical layer. The link layer will be described later.

In hybrid service delivery, at least one service element may be delivered through a broadband path. In hybrid service delivery, data delivered over broadband may include service components of a DASH format, service signaling information thereof and/or NRT data. This data may be processed through HTrP/TCP/IP and delivered to a physical layer for broadband transmission through a link layer for broadband transmission.

The physical layer may process the data received from the delivery layer (higher layer and/or link layer) and transmit the data over the broadcast or broadband network. A detailed description of the physical layer will be given later.

The service will be described. The service may be a collection of service components displayed to a user, the components may be of various media types, the service may be continuous or intermittent, the service may be real time or non real time, and a real-time service may include a sequence of TV programs.

The service may have various types. First, the service may be a linear audio/video or audio service having app based enhancement. Second, the service may be an app based service, reproduction/configuration of which is controlled by a downloaded application. Third, the service may be an ESG service for providing an electronic service guide (ESG). Fourth, the service may be an emergency alert (EA) service for providing emergency alert information.

When a linear service without app based enhancement is delivered over the broadcast network, the service component may be delivered by (1) one or more ROUTE sessions or (2) one or more MMTP sessions.

When a linear service having app based enhancement is delivered over the broadcast network, the service component may be delivered by (1) one or more ROUTE sessions or (2) zero or more MMTP sessions. In this case, data used for app based enhancement may be delivered through a ROUTE session in the form of NRT data or other files. In one embodiment of the present invention, simultaneous delivery of linear service components (streaming media components) of one service using two protocols may not be allowed.

When an app based service is delivered over the broadcast network, the service component may be delivered by one or more ROUTE sessions. In this case, the service data used for the app based service may be delivered through the ROUTE session in the form of NRT data or other files.

Some service components of such a service, some NRT data, files, etc. may be delivered through broadband (hybrid service delivery).

That is, in one embodiment of the present invention, linear service components of one service may be delivered through the MMT protocol. In another embodiment of the present invention, the linear service components of one service may be delivered through the ROUTE protocol. In another embodiment of the present invention, the linear service components of one service and NRT data (NRT service components) may be delivered through the ROUTE protocol. In another embodiment of the present invention, the linear service components of one service may be delivered through the MMT protocol and the NRT data (NRT service components) may be delivered through the ROUTE protocol. In the above-described embodiments, some service components of the service or some NRT data may be delivered through broadband. Here, the app based service and data regarding app based enhancement may be delivered over the broadcast network according to ROUTE or through broadband in the form of NRT data. NRT data may be referred to as locally cached data.

Each ROUTE session includes one or more LCT sessions for wholly or partially delivering content components configuring the service. In streaming service delivery, the LCT session may deliver individual components of a user service, such as audio, video or closed caption stream. The streaming media is formatted into a DASH segment.

Each MMTP session includes one or more MMTP packet flows for delivering all or some of content components or an MMT signaling message. The MMTP packet flow may deliver a component formatted into MPU or an MMT signaling message.

For delivery of an NRT user service or system metadata, the LCT session delivers a file based content item. Such content files may include consecutive (timed) or discrete (non-timed) media components of the NRT service or metadata such as service signaling or ESG fragments. System metadata such as service signaling or ESG fragments may be delivered through the signaling message mode of the MMTP.

A receiver may detect a broadcast signal while a tuner tunes to frequencies. The receiver may extract and send an SLT to a processing module. The SLT parser may parse the SLT and acquire and store data in a channel map. The receiver may acquire and deliver bootstrap information of the SLT to a ROUTE or MMT client. The receiver may acquire and store an SLS. USBD may be acquired and parsed by a signaling parser.

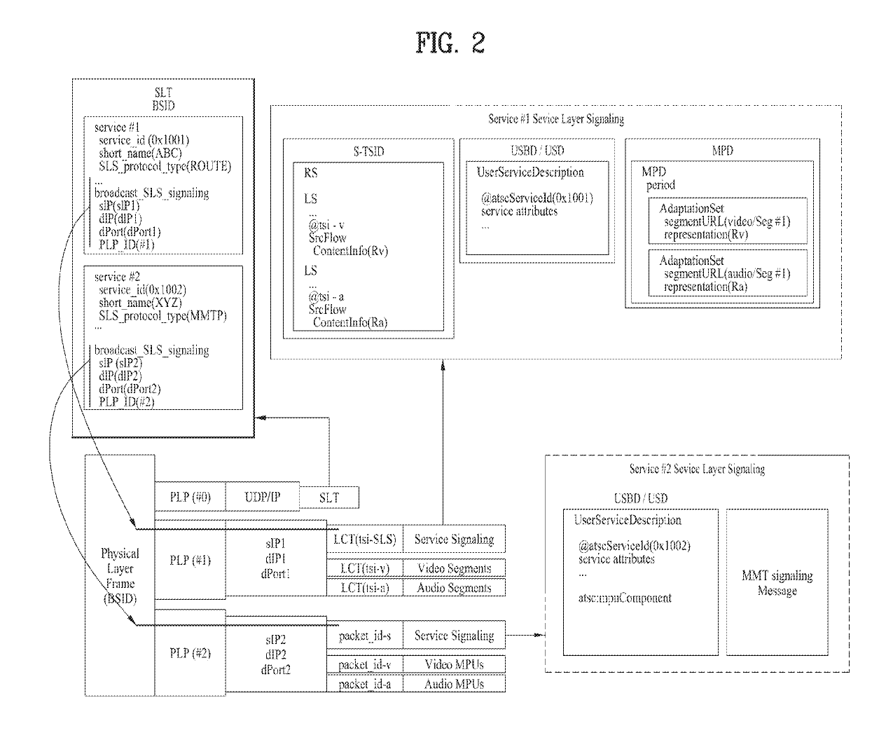

FIG. 2 is a diagram showing a service discovery procedure according to one embodiment of the present invention.

A broadcast stream delivered by a broadcast signal frame of a physical layer may carry low level signaling (LLS). LLS data may be carried through payload of IP packets delivered to a well-known IP address/port. This LLS may include an SLT according to type thereof. The LLS data may be formatted in the form of an LLS table. A first byte of every UDP/IP packet carrying the LLS data may be the start of the LLS table. Unlike the shown embodiment, an IP stream for delivering the LLS data may be delivered to a PLP along with other service data.

The SLT may enable the receiver to generate a service list through fast channel scan and provides access information for locating the SLS. The SLT includes bootstrap information. This bootstrap information may enable the receiver to acquire service layer signaling (SLS) of each service. When the SLS, that is, service signaling information, is delivered through ROUTE, the bootstrap information may include an LCT channel carrying the SLS, a destination IP address of a ROUTE session including the LCT channel and destination port information. When the SLS is delivered through the MMT, the bootstrap information may include a destination IP address of an MMTP session carrying the SLS and destination port information.

In the shown embodiment, the SLS of service #1 described in the SLT is delivered through ROUTE and the SLT may include bootstrap information sIP1, dIP1 and dPort1 of the ROUTE session including the LCT channel delivered by the SLS. The SLS of service #2 described in the SLT is delivered through MMT and the SLT may include bootstrap information sIP2, dIP2 and dPort2 of the MMTP session including the MMTP packet flow delivered by the SLS.

The SLS is signaling information describing the properties of the service and may include receiver capability information for significantly reproducing the service or providing information for acquiring the service and the service component of the service. When each service has separate service signaling, the receiver acquires appropriate SLS for a desired service without parsing all SLSs delivered within a broadcast stream.

When the SLS is delivered through the ROUTE protocol, the SLS may be delivered through a dedicated LCT channel of a ROUTE session indicated by the SLT. In some embodiments, this LCT channel may be an LCT channel identified by tsi=0. In this case, the SLS may include a user service bundle description (USBD)/user service description (USD), service-based transport session instance description (S-TSID) and/or media presentation description (MPD).

Here, USBD/USD is one of SLS fragments and may serve as a signaling hub describing detailed description information of a service. The USBD may include service identification information, device capability information, etc. The USBD may include reference information (URI reference) of other SLS fragments (S-TSID, MPD, etc.). That is, the USBD/USD may reference the S-TSID and the MPD. In addition, the USBD may further include metadata information for enabling the receiver to decide a transmission mode (broadcast/broadband network). A detailed description of the USBD/USD will be given below.

The S-TSID is one of SLS fragments and may provide overall session description information of a transport session carrying the service component of the service. The S-TSID may provide the ROUTE session through which the service component of the service is delivered and/or transport session description information for the LCT channel of the ROUTE session. The S-TSID may provide component acquisition information of service components associated with one service. The S-TSID may provide mapping between DASH representation of the MPD and the tsi of the service component. The component acquisition information of the S-TSID may be provided in the form of the identifier of the associated DASH representation and tsi and may or may not include a PLP ID in some embodiments. Through the component acquisition information, the receiver may collect audio/video components of one service and perform buffering and decoding of DASH media segments. The S-TSID may be referenced by the USBD as described above. A detailed description of the S-TSID will be given below.

The MPD is one of SLS fragments and may provide a description of DASH media presentation of the service. The MPD may provide a resource identifier of media segments and provide context information within the media presentation of the identified resources. The MPD may describe DASH representation (service component) delivered over the broadcast network and describe additional DASH presentation delivered over broadband (hybrid delivery). The MPD may be referenced by the USBD as described above.

When the SLS is delivered through the MMT protocol, the SLS may be delivered through a dedicated MMTP packet flow of the MMTP session indicated by the SLT. In some embodiments, the packet_id of the MMTP packets delivering the SLS may have a value of 00. In this case, the SLS may include a USBD/USD and/or MMT packet (MP) table.

Here, the USBD is one of SLS fragments and may describe detailed description information of a service as in ROUTE. This USBD may include reference information (URI information) of other SLS fragments. The USBD of the MMT may reference an MP table of MMT signaling. In some embodiments, the USBD of the MMT may include reference information of the S-TSID and/or the MPD. Here, the S-TSID is for NRT data delivered through the ROUTE protocol. Even when a linear service component is delivered through the MMT protocol, NRT data may be delivered via the ROUTE protocol. The MPD is for a service component delivered over broadband in hybrid service delivery. The detailed description of the USBD of the MMT will be given below.

The MP table is a signaling message of the MMT for MPU components and may provide overall session description information of an MMTP session carrying the service component of the service. In addition, the MP table may include a description of an asset delivered through the MMTP session. The MP table is streaming signaling information for MPU components and may provide a list of assets corresponding to one service and location information (component acquisition information) of these components. The detailed description of the MP table may be defined in the MMT or modified. Here, the asset is a multimedia data entity, is combined by one unique ID, and may mean a data entity used to one multimedia presentation. The asset may correspond to service components configuring one service. A streaming service component (MPU) corresponding to a desired service may be accessed using the MP table. The MP table may be referenced by the USBD as described above.

The other MMT signaling messages may be defined. Additional information associated with the service and the MMTP session may be described by such MMT signaling messages.

The ROUTE session is identified by a source IP address, a destination IP address and a destination port number. The LCT session is identified by a unique transport session identifier (TSI) within the range of a parent ROUTE session. The MMTP session is identified by a destination IP address and a destination port number. The MMTP packet flow is identified by a unique packet_id within the range of a parent MMTP session.

In case of ROUTE, the S-TSID, the USBD/USD, the MPD or the LCT session delivering the same may be referred to as a service signaling channel. In case of MMTP, the USBD/UD, the MMT signaling message or the packet flow delivering the same may be referred to as a service signaling channel.

Unlike the shown embodiment, one ROUTE or MMTP session may be delivered over a plurality of PLPs. That is, one service may be delivered through one or more PLPs. Unlike the shown embodiment, in some embodiments, components configuring one service may be delivered through different ROUTE sessions. In addition, in some embodiments, components configuring one service may be delivered through different MMTP sessions. In some embodiments, components configuring one service may be divided and delivered in a ROUTE session and an MMTP session. Although not shown, components configuring one service may be delivered through broadband (hybrid delivery).

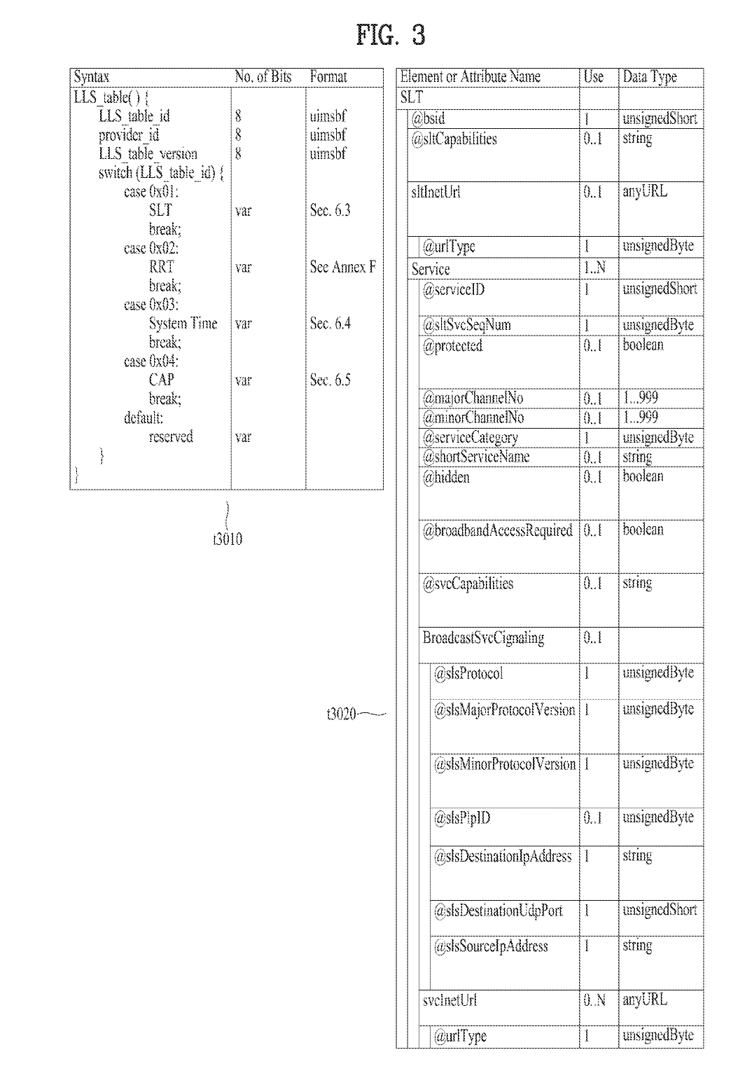

FIG. 3 is a diagram showing a low level signaling (LLS) table and a service list table (SLT) according to one embodiment of the present invention.

One embodiment t3010 of the LLS table may include information according to an LLS_table_id field, a provider_id field, an LLS_table_version field and/or an LLS_table_id field.

The LLS_table_id field may identify the type of the LLS table, and the provider_id field may identify a service provider associated with services signaled by the LLS table. Here, the service provider is a broadcaster using all or some of the broadcast streams and the provider_id field may identify one of a plurality of broadcasters which is using the broadcast streams. The LLS_table_version field may provide the version information of the LLS table.

According to the value of the LLS_table_id field, the LLS table may include one of the above-described SLT, a rating region table (RRT) including information on a content advisory rating, SystemTime information for providing information associated with a system time, a common alert protocol (CAP) message for providing information associated with emergency alert. In some embodiments, the other information may be included in the LLS table.

One embodiment t3020 of the shown SLT may include an @bsid attribute, an @sltCapabilities attribute, an sltInetUrl element and/or a Service element. Each field may be omitted according to the value of the shown Use column or a plurality of fields may be present.

The @bsid attribute may be the identifier of a broadcast stream. The @sltCapabilities attribute may provide capability information required to decode and significantly reproduce all services described in the SLT. The sltInetUrl element may provide base URL information used to obtain service signaling information and ESG for the services of the SLT over broadband. The sltInetUrl element may further include an @urlType attribute, which may indicate the type of data capable of being obtained through the URL.

The Service element may include information on services described in the SLT, and the Service element of each service may be present. The Service element may include an @serviceId attribute, an @sltSvcSeqNum attribute, an @protected attribute, an @majorChannelNo attribute, an @minorChannelNo attribute, an @serviceCategory attribute, an @shortServiceName attribute, an @hidden attribute, an @broadbandAccessRequired attribute, an @svcCapabilities attribute, an BroadcastSvcSignaling element and/or an svclnetUrl element.

The @serviceId attribute is the identifier of the service and the @sltSvcSeqNum attribute may indicate the sequence number of the SLT information of the service. The @protected attribute may indicate whether at least one service component necessary for significant reproduction of the service is protected. The @majorChannelNo attribute and the @minorChannelNo attribute may indicate the major channel number and minor channel number of the service, respectively.

The @serviceCategory attribute may indicate the category of the service. The category of the service may include a linear A/V service, a linear audio service, an app based service, an ESG service, an EAS service, etc. The @shortServiceName attribute may provide the short name of the service. The @hidden attribute may indicate whether the service is for testing or proprietary use. The @broadbandAccessRequired attribute may indicate whether broadband access is necessary for significant reproduction of the service. The @svcCapabilities attribute may provide capability information necessary for decoding and significant reproduction of the service.

The BroadcastSvcSignaling element may provide information associated with broadcast signaling of the service. This element may provide information such as location, protocol and address with respect to signaling over the broadcast network of the service. Details thereof will be described below.

The svcInetUrl element may provide URL information for accessing the signaling information of the service over broadband. The sltInetUrl element may further include an @urlType attribute, which may indicate the type of data capable of being obtained through the URL.

The above-described BroadcastSvcSignaling element may include an @slsProtocol attribute, an @slsMajorProtocolVersion attribute, an @slsMinorProtocolVersion attribute, an @slsPlpId attribute, an @slsDestinationIpAddress attribute, an @slsDestinationUdpPort attribute, and/or an @slsSourceIpAddress attribute.

The @slsProtocol attribute may indicate the protocol used to deliver the SLS of the service (ROUTE, MMT, etc.). The @slsMajorProtocolVersion attribute and the @slsMinorProtocolVersion attribute may indicate the major version number and minor version number of the protocol used to deliver the SLS of the service, respectively.

The @slsPlpId attribute may provide a PLP identifier for identifying the PLP delivering the SLS of the service. In some embodiments, this field may be omitted and the PLP information delivered by the SLS may be checked using a combination of the information of the below-described LMT and the bootstrap information of the SLT.

The @slsDestinationIpAddress attribute, the @slsDestinationUdpPort attribute and the @slsSourceIpAddress attribute may indicate the destination IP address, destination UDP port and source IP address of the transport packets delivering the SLS of the service, respectively. These may identify the transport session (ROUTE session or MMTP session) delivered by the SLS. These may be included in the bootstrap information.

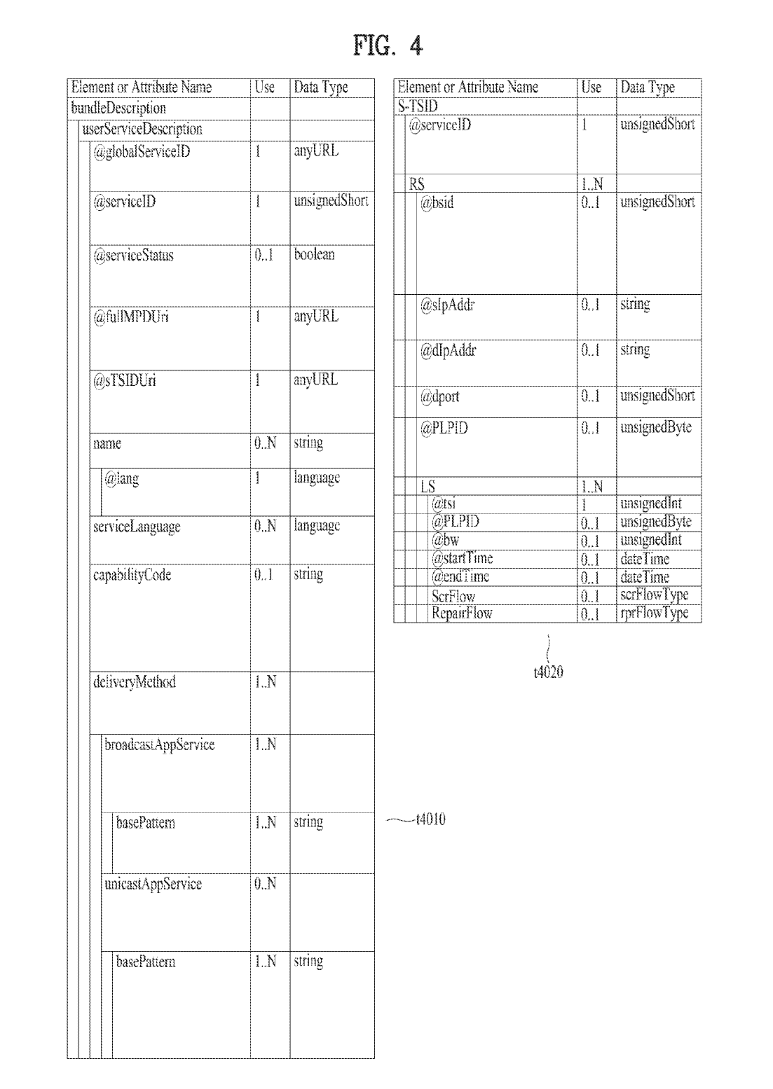

FIG. 4 is a diagram showing a USBD and an S-TSID delivered through ROUTE according to one embodiment of the present invention.

One embodiment t4010 of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, an @serviceStatus attribute, an @fullMPDUri attribute, an @sTSIDUri attribute, a name element, a serviceLanguage element, a capabilityCode element, and/or a deliveryMethod element. Each field may be omitted according to the value of the shown Use column or a plurality of fields may be present.

The @globalServiceID attribute is the globally unique identifier of the service and may be used for link with ESG data (Service@globalServiceID). The @serviceId attribute is a reference corresponding to the service entry of the SLT and may be equal to the service ID information of the SLT. The @serviceStatus attribute may indicate the status of the service. This field may indicate whether the service is active or inactive.

The @fullMPDUri attribute may reference the MPD fragment of the service. The MPD may provide a reproduction description of a service component delivered over the broadcast or broadband network as described above. The @sTSIDUri attribute may reference the S-TSID fragment of the service. The S-TSID may provide parameters associated with access to the transport session carrying the service as described above.

The name element may provide the name of the service. This element may further include an @lang attribute and this field may indicate the language of the name provided by the name element. The serviceLanguage element may indicate available languages of the service. That is, this element may arrange the languages capable of being provided by the service.

The capabilityCode element may indicate capability or capability group information of a receiver necessary to significantly reproduce the service. This information is compatible with capability information format provided in service announcement.

The deliveryMethod element may provide transmission related information with respect to content accessed over the broadcast or broadband network of the service. The deliveryMethod element may include a broadcastAppService element and/or a unicastAppService element. Each of these elements may have a basePattern element as a sub element.

The broadcastAppService element may include transmission associated information of the DASH representation delivered over the broadcast network. The DASH representation may include media components over all periods of the service presentation.

The basePattern element of this element may indicate a character pattern used for the receiver to perform matching with the segment URL. This may be used for a DASH client to request the segments of the representation. Matching may imply delivery of the media segment over the broadcast network.

The unicastAppService element may include transmission related information of the DASH representation delivered over broadband. The DASH representation may include media components over all periods of the service media presentation.

The basePattern element of this element may indicate a character pattern used for the receiver to perform matching with the segment URL. This may be used for a DASH client to request the segments of the representation. Matching may imply delivery of the media segment over broadband.

One embodiment t4020 of the shown S-TSID may have an S-TSID root element. The S-TSID root element may include an @serviceId attribute and/or an RS element. Each field may be omitted according to the value of the shown Use column or a plurality of fields may be present.

The @serviceId attribute is the identifier of the service and may reference the service of the USBD/USD. The RS element may describe information on ROUTE sessions through which the service components of the service are delivered. According to the number of ROUTE sessions, a plurality of elements may be present. The RS element may further include an @bsid attribute, an @sIpAddr attribute, an @dIpAddr attribute, an @dport attribute, an @PLPID attribute and/or an LS element.

The @bsid attribute may be the identifier of a broadcast stream in which the service components of the service are delivered. If this field is omitted, a default broadcast stream may be a broadcast stream including the PLP delivering the SLS of the service. The value of this field may be equal to that of the @bsid attribute.

The @sIpAddr attribute, the @dIpAddr attribute and the @dport attribute may indicate the source IP address, destination IP address and destination UDP port of the ROUTE session, respectively. When these fields are omitted, the default values may be the source address, destination IP address and destination UDP port values of the current ROUTE session delivering the SLS, that is, the S-TSID. This field may not be omitted in another ROUTE session delivering the service components of the service, not in the current ROUTE session.

The @PLPID attribute may indicate the PLP ID information of the ROUTE session. If this field is omitted, the default value may be the PLP ID value of the current PLP delivered by the S-TSID. In some embodiments, this field is omitted and the PLP ID information of the ROUTE session may be checked using a combination of the information of the below-described LMT and the IP address/UDP port information of the RS element.

The LS element may describe information on LCT channels through which the service components of the service are transmitted. According to the number of LCT channel, a plurality of elements may be present. The LS element may include an @tsi attribute, an @PLPID attribute, an @bw attribute, an @startTime attribute, an @endTime attribute, a SrcFlow element and/or a RepairFlow element.

The @tsi attribute may indicate the tsi information of the LCT channel. Using this, the LCT channels through which the service components of the service are delivered may be identified. The @PLPID attribute may indicate the PLP ID information of the LCT channel. In some embodiments, this field may be omitted. The @bw attribute may indicate the maximum bandwidth of the LCT channel. The @startTime attribute may indicate the start time of the LCT session and the @endTime attribute may indicate the end time of the LCT channel.

The SrcFlow element may describe the source flow of ROUTE. The source protocol of ROUTE is used to transmit a delivery object and at least one source flow may be established within one ROUTE session. The source flow may deliver associated objects as an object flow.

The RepairFlow element may describe the repair flow of ROUTE. Delivery objects delivered according to the source protocol may be protected according to forward error correction (FEC) and the repair protocol may define an FEC framework enabling FEC protection.

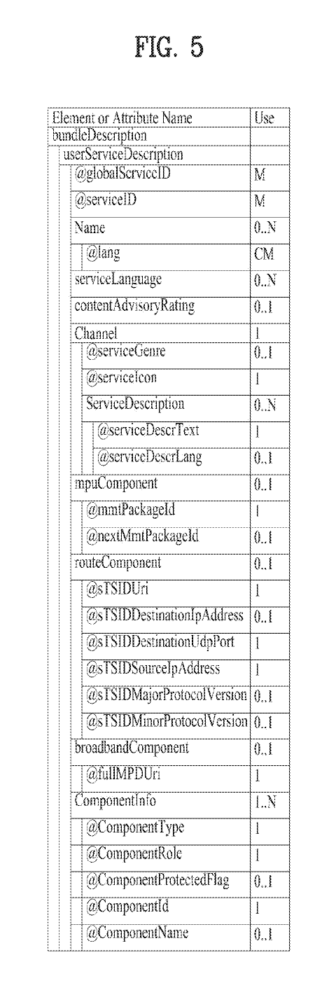

FIG. 5 is a diagram showing a USBD delivered through MMT according to one embodiment of the present invention.

One embodiment of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, a Name element, a serviceLanguage element, a contentAdvisoryRating element, a Channel element, a mpuComponent element, a muteComponent element, a broadbandComponent element, and/or a ComponentInfo element. Each field may be omitted according to the value of the shown Use column or a plurality of fields may be present.

The @globalServiceID attribute, the @serviceId attribute, the Name element and/or the serviceLanguage element may be equal to the fields of the USBD delivered through ROUTE. The contentAdvisoryRating element may indicate the content advisory rating of the service. This information is compatible with content advisory rating information format provided in service announcement. The Channel element may include information associated with the service. A detailed description of this element will be given below.

The mpuComponent element may provide a description of service components delivered as the MPU of the service. This element may further include an @mmtPackageId attribute and/or an @nextMmtPackageId attribute. The @mmtPackageId attribute may reference the MMT package of the service components delivered as the MPU of the service. The @nextMmtPackageId attribute may reference an MMT package to be used after the MMT package referenced by the @mmtPackageId attribute in terms of time. Through the information of this element, the MP table may be referenced.

The routeComponent element may include a description of the service components of the service. Even when linear service components are delivered through the MMT protocol, NRT data may be delivered according to the ROUTE protocol as described above. This element may describe information on such NRT data. A detailed description of this element will be given below.

The broadbandComponent element may include the description of the service components of the service delivered over broadband. In hybrid service delivery, some service components of one service or other files may be delivered over broadband. This element may describe information on such data. This element may further an @fullMPDUri attribute. This attribute may reference the MPD describing the service component delivered over broadband. In addition to hybrid service delivery, the broadcast signal may be weakened due to traveling in a tunnel and thus this element may be necessary to support handoff between broadband and broadband. When the broadcast signal is weak, the service component is acquired over broadband and, when the broadcast signal becomes strong, the service component is acquired over the broadcast network to secure service continuity.

The ComponentInfo element may include information on the service components of the service. According to the number of service components of the service, a plurality of elements may be present. This element may describe the type, role, name, identifier or protection of each service component. Detailed information of this element will be described below.

The above-described Channel element may further include an @serviceGenre attribute, an @serviceIcon attribute and/or a ServiceDescription element. The @serviceGenre attribute may indicate the genre of the service and the @serviceIcon attribute may include the URL information of the representative icon of the service. The ServiceDescription element may provide the service description of the service and this element may further include an @serviceDescrText attribute and/or an @serviceDescrLang attribute. These attributes may indicate the text of the service description and the language used in the text.

The above-described routeComponent element may further include an @sTSIDUri attribute, an @sTSIDDestinationIpAddress attribute, an @sTSIDDestinationUdpPort attribute, an @sTSIDSourceIpAddress attribute, an @sTSIDMajorProtocolVersion attribute, and/or an @sTSIDMinorProtocolVersion attribute.

The @sTSIDUri attribute may reference an S-TSID fragment. This field may be equal to the field of the USBD delivered through ROUTE. This S-TSID may provide access related information of the service components delivered through ROUTE. This S-TSID may be present for NRT data delivered according to the ROUTE protocol in a state of delivering linear service component according to the MMT protocol.

The @sTSIDDestinationIpAddress attribute, the @sTSIDDestinationUdpPort attribute, and the @sTSIDSourceIpAddress attribute may indicate the destination IP address, destination UDP port and source IP address of the transport packets carrying the above-described S-TSID. That is, these fields may identify the transport session (MMTP session or the ROUTE session) carrying the above-described S-TSID.

The @sTSIDMajorProtocolVersion attribute and the @sTSIDMinorProtocolVersion attribute may indicate the major version number and minor version number of the transport protocol used to deliver the above-described S-TSID, respectively.

The above-described ComponentInfo element may further include an @componentType attribute, an @componentRole attribute, an @componentProtectedFlag attribute, an @componentId attribute, and/or an @componentName attribute.

The @componentType attribute may indicate the type of the component. For example, this attribute may indicate whether the component is an audio, video or closed caption component. The @componentRole attribute may indicate the role of the component. For example, this attribute may indicate main audio, music, commentary, etc. if the component is an audio component. This attribute may indicate primary video if the component is a video component. This attribute may indicate a normal caption or an easy reader type if the component is a closed caption component.

The @componentProtectedFlag attribute may indicate whether the service component is protected, for example, encrypted. The @componentId attribute may indicate the identifier of the service component. The value of this attribute may be the asset_id (asset ID) of the MP table corresponding to this service component. The @componentName attribute may indicate the name of the service component.

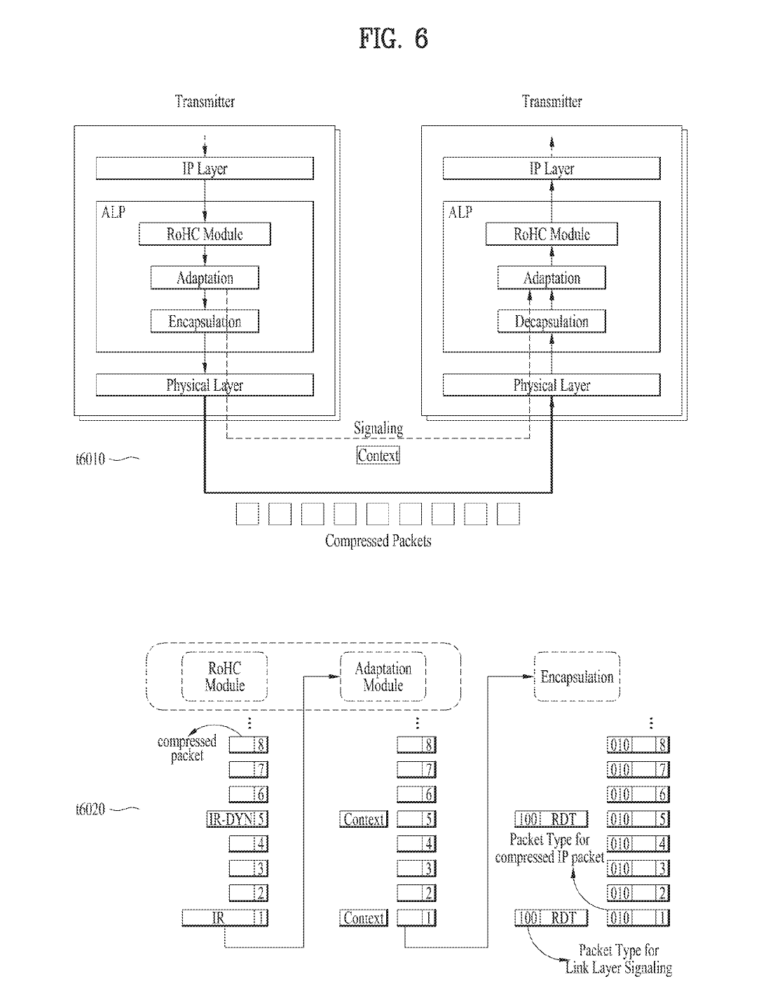

FIG. 6 is a diagram showing link layer operation according to one embodiment of the present invention.

The link layer may be a layer between a physical layer and a network layer. A transmission side may transmit data from the network layer to the physical layer and a reception side may transmit data from the physical layer to the network layer (t6010). The purpose of the link layer is to compress (abstract) all input packet types into one format for processing by the physical layer and to secure flexibility and expandability of an input packet type which is not defined yet. In addition, the link layer may provide option for compressing (abstracting) unnecessary information of the header of input packets to efficiently transmit input data. Operation such as overhead reduction, encapsulation, etc. of the link layer is referred to as a link layer protocol and packets generated using this protocol may be referred to as link layer packets. The link layer may perform functions such as packet encapsulation, overhead reduction and/or signaling transmission.

At the transmission side, the link layer (ALP) may perform an overhead reduction procedure with respect to input packets and then encapsulate the input packets into link layer packets. In addition, in some embodiments, the link layer may perform encapsulation into the link layer packets without performing the overhead reduction procedure. Due to use of the link layer protocol, data transmission overhead on the physical layer may be significantly reduced and the link layer protocol according to the present invention may provide IP overhead reduction and/or MPEG-2 TS overhead reduction.

When the shown IP packets are input as input packets (t6010), the link layer may sequentially perform IP header compression, adaptation and/or encapsulation. In some embodiments, some processes may be omitted. For example, the RoHC module may perform IP packet header compression to reduce unnecessary overhead. Context information may be extracted through the adaptation procedure and transmitted out of band. The IP header compression and adaption procedure may be collectively referred to as IP header compression. Thereafter, the IP packets may be encapsulated into link layer packets through the encapsulation procedure.

When MPEG 2 TS packets are input as input packets, the link layer may sequentially perform overhead reduction and/or an encapsulation procedure with respect to the TS packets. In some embodiments, some procedures may be omitted. In overhead reduction, the link layer may provide sync byte removal, null packet deletion and/or common header removal (compression). Through sync byte removal, overhead reduction of 1 byte may be provided per TS packet. Null packet deletion may be performed in a manner in which reinsertion is possible at the reception side. In addition, deletion (compression) may be performed in a manner in which common information between consecutive headers may be restored at the reception side. Some of the overhead reduction procedures may be omitted. Thereafter, through the encapsulation procedure, the TS packets may be encapsulated into link layer packets. The link layer packet structure for encapsulation of the TS packets may be different from that of the other types of packets.

First, IP header compression will be described.

The IP packets may have a fixed header format but some information necessary for a communication environment may be unnecessary for a broadcast environment. The link layer protocol may compress the header of the IP packet to provide a mechanism for reducing broadcast overhead.

IP header compression may include a header compressor/decompressor and/or an adaptation module. The IP header compressor (RoHC compressor) may reduce the size of each IP packet based on a RoHC method. Then, adaptation module may extract context information and generate signaling information from each packet stream. A receiver may parse signaling information related to a corresponding packet stream and attach the context information to the packet stream. The RoHC decompressor may recover a packet header to reconfigure an original IP packet. Hereinafter, IP header compression may refer to only IP header compressor via header compressor and may be a concept that combines IP header compression and the adaptation procedure by the adaptation module. This may be the same as in decompressing.

Hereinafter, adaptation will be described.

In transmission of a single-direction link, when the receiver does not have context information, the decompressor cannot restore the received packet header until complete context is received. This may lead to channel change delay and turn-on delay. Accordingly, through the adaptation function, configuration parameters and context information between the compressor and the decompressor may be transmitted out of band. The adaptation function may construct link layer signaling using context information and/or configuration parameters. The adaptation function may periodically transmit link layer signaling through each physical frame using a previous configuration parameter and/or context information.

Context information is extracted from the compressed IP packets and various methods may be used according to adaptation mode.

Mode #1 refers to a mode in which no operation is performed with respect to the compressed packet stream and an adaptation module operates as a buffer.

Mode #2 refers to a mode in which an IR packet is detected from a compressed packet stream to extract context information (static chain). After extraction, the IR packet is converted into an IR-DYN packet and the IR-DYN packet may be transmitted in the same order within the packet stream in place of an original IR packet.

Mode #3 (t6020) refers to a mode in which IR and IR-DYN packets are detected from a compressed packet stream to extract context information. A static chain and a dynamic chain may be extracted from the IR packet and a dynamic chain may be extracted from the IR-DYN packet. After extraction, the IR and IR-DYN packets are converted into normal compression packets. The converted packets may be transmitted in the same order within the packet stream in place of original IR and IR-DYN packets.

In each mode, the context information is extracted and the remaining packets may be encapsulated and transmitted according to the link layer packet structure for the compressed IP packets. The context information may be encapsulated and transmitted according to the link layer packet structure for signaling information, as link layer signaling.

The extracted context information may be included in a RoHC-U description table (RDT) and may be transmitted separately from the RoHC packet flow. Context information may be transmitted through a specific physical data path along with other signaling information. The specific physical data path may mean one of normal PLPs, a PLP in which low level signaling (LLS) is delivered, a dedicated PLP or an L signaling path. Here, the RDT may be context information (static chain and/or dynamic chain) and/or signaling information including information associated with header compression. In some embodiments, the RDT may be transmitted whenever context information is changed. In some embodiments, the RDT may be transmitted in every physical frame. To transmit the RDT in every physical frame, a previous RDT may be re-used.

The receiver may select a first PLP and first acquire signaling information of the SLT, the RDT, etc., prior to acquisition of a packet stream. Upon acquring the signaling information, the receiver may combine the information to acquire mapping of service—IP information—context information—PLP. That is, the receiver may recognize IP streams through which a service is transmitted, IP streams transmitted through a PLP, and so on and acquire corresponding context information of the PLPs. The receiver may select a PLP for delivery of a specific packet stream and decode the PLP. The adaptation module may parse the context information and combine the context information with the compressed packets. Thereby, the packet stream may be recovered and transmitted to the RoHC de compressor. Then, decompression may be started. In this case, the receiver may detect an IR packet and start decompression from a first received IR packet according to an adaptation mode (mode 1), may detect an IR-DYN packet and start decompression from a first received IR-DYN packet (mode 2), or may start decompression from any general compressed packet (mode 3).

Hereinafter, packet encapsulation will be described.

The link layer protocol may encapsulate all types of input packets such as IP packets, TS packets, etc. into link layer packets. To this end, the physical layer processes only one packet format independently of the protocol type of the network layer (here, an MPEG-2 TS packet is considered as a network layer packet). Each network layer packet or input packet is modified into the payload of a generic link layer packet.

In the packet encapsulation procedure, segmentation may be used. If the network layer packet is too large to be processed in the physical layer, the network layer packet may be segmented into two or more segments. The link layer packet header may include fields for segmentation of the transmission side and recombination of the reception side. Each segment may be encapsulated into the link layer packet in the same order as the original location.

In the packet encapsulation procedure, concatenation may also be used. If the network layer packet is sufficiently small such that the payload of the link layer packet includes several network layer packets, concatenation may be performed. The link layer packet header may include fields for performing concatenation. In concatenation, the input packets may be encapsulated into the payload of the link layer packet in the same order as the original input order.

The link layer packet may include a header and a payload. The header may include a base header, an additional header and/or an optional header. The additional header may be further added according to situation such as concatenation or segmentation and the additional header may include fields suitable for situations. In addition, for delivery of the additional information, the optional header may be further included. Each header structure may be pre-defined. As described above, if the input packets are TS packets, a link layer header having packets different from the other packets may be used.

Hereinafter, link layer signaling will be described.

Link layer signaling may operate at a level lower than that of the IP layer. The reception side may acquire link layer signaling faster than IP level signaling of the LLS, the SLT, the SLS, etc. Accordingly, link layer signaling may be acquired before session establishment.

Link layer signaling may include internal link layer signaling and external link layer signaling. Internal link layer signaling may be signaling information generated at the link layer. This includes the above-described RDT or the below-described LMT. External link layer signaling may be signaling information received from an external module, an external protocol or a higher layer. The link layer may encapsulate link layer signaling into a link layer packet and deliver the link layer packet. A link layer packet structure (header structure) for link layer signaling may be defined and link layer signaling information may be encapsulated according to this structure.

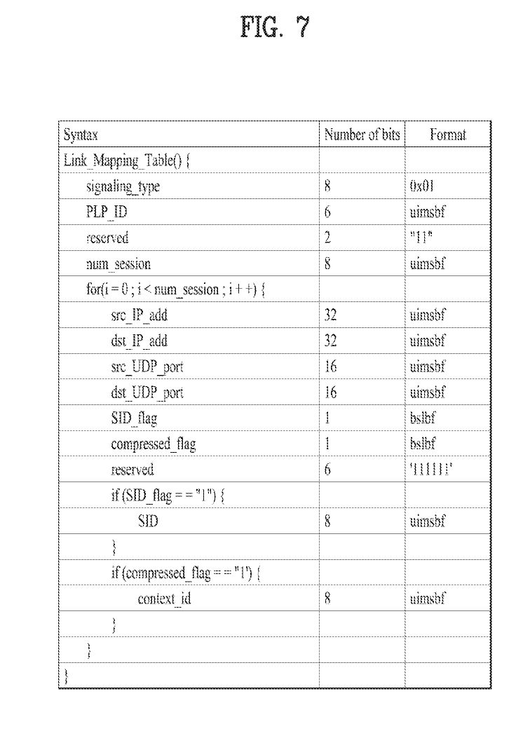

FIG. 7 is a diagram showing a link mapping table (LMT) according to one embodiment of the present invention.

The LMT may provide a list of higher layer sessions carried through the PLP. In addition, the LMT may provide additional information for processing link layer packets carrying the higher layer sessions. Here, the higher layer session may be referred to as multicast. Information on IP streams or transport sessions transmitted through one PLP may be acquired through the LMT. In contrast, information on through which PLP a specific transport session is delivered may be acquired.

The LMT may be transmitted through any PLP identified to deliver the LLS. Here, the PLP for delivering the LLS may be identified by an LLS flag of L detail signaling information of a physical layer. The LLS flag may be a flag field indicating whether the LLS is transmitted through a corresponding PLP with respect to each PLP. Here, the L detail signaling information may be correspond to PLS2 data which will be described later.

That is, the LMT may also be transmitted through the same PLP along with the LLS. Each LMT may describe mapping between PLPs and IP address/port as described above. As described above, the LLS may include an SLT and, in this regard, the IP address/ports described by the LMT may be any IP address/ports related to any service, described by the SLT transmitted through the PLP such as a corresponding LMT.

In some embodiments, the PLP identifier information in the above-described SLT, SLS, etc. may be used to confirm information indicating through which PLP a specific transport session indicated by the SLT or SLS is transmitted may be confirmed.

In another embodiment, the PLP identifier information in the above-described SLT, SLS, etc. will be omitted and PLP information of the specific transport session indicated by the SLT or SLS may be confirmed by referring to the information in the LMT. In this case, the receiver may combine the LMT and other IP level signaling information to identify the PLP. Even in this embodiment, the PLP information in the SLT, SLS, etc. is not omitted and may remain in the SLT, SLS, etc.

The LMT according to the shown embodiment may include a signaling_type field, a PLP_ID field, a num_session field and/or information on each session. Although the LMT of the shown embodiment describes IP streams transmitted through one PLP, a PLP loop may be added to the LMT to describe information on a plurality of PLPs in some embodiments. In this case, as described above, the LMT may describe PLPs of all IP addresses/ports related to all service described by the SLT transmitted together using a PLP loop.

The signaling_type field may indicate the type of signaling information delivered by the table. The value of signaling_type field for the LMT may be set to 0x01. The signaling_type field may signaling_type field may be omitted. The PLP_ID field may identify a target PLP to be described. When the PLP loop is used, each PLP_ID field may identify each target PLP. Fields from the PLP_ID field may be included in the PLP loop. Here, the below-described PLP_ID field may be an identifier of one PLP of the PLP loop and the following fields may be fields corresponding to the corresponding PLP.

The num_session field may indicate the number of higher layer sessions delivered through the PLP identified by the PLP_ID field. According to the number indicated by the num_session field, information on each session may be included. This information may include a src_IP_add field, a dst_IP_add field, a src_UDP_port field, a dst_UDP_port field, an SID_flag field, a compressed_flag field, an SID field, and/or a context_id field.

The src_IP_add field, the dst_IP_add field, the src_UDP_port field, and the dst_UDP_port field may indicate the source IP address, the destination IP address, the source UDP port and the destination UDP port of the transport session among the higher layer sessions delivered through the PLP identified by the PLP_ID field.

The SID_flag field may indicate whether the link layer packet delivering the transport session has an SID field in the optional header. The link layer packet delivering the higher layer session may have an SID field in the optional header and the SID field value may be equal to that of the SID field in the LMT.

The compressed_flag field may indicate whether header compression is applied to the data of the link layer packet delivering the transport session. In addition, presence/absence of the below-described context_id field may be determined according to the value of this field. When header compression is applied (compressed_flag=1), the RDT may be present and the PLP ID field of the RDT may have the same value as the corresponding PLP_ID field related to the present compressed_flag field.

The SID field may indicate a sub stream ID (SID) of link layer packets for delivering a corresponding transfer session. The link layer packets may include the SID having the same value as the present SID field in the optional header. Thereby, the receiver may filter link layer packets using information of the LMT and SID information of a link layer packet header without parsing of all link layer packets.

The context_id field may provide a reference for a context id (CID) in the RDT. The CID information of the RDT may indicate the context ID of the compression IP packet stream. The RDT may provide context information of the compression IP packet stream. Through this field, the RDT and the LMT may be associated.

In the above-described embodiments of the signaling information/table of the present invention, the fields, elements or attributes may be omitted or may be replaced with other fields. In some embodiments, additional fields, elements or attributes may be added.

In one embodiment of the present invention, service components of one service may be delivered through a plurality of ROUTE sessions. In this case, an SLS may be acquired through bootstrap information of an SLT. An S-TSID and an MPD may be referenced through the USBD of the SLS. The S-TSID may describe not only the ROUTE session delivered by the SLS but also transport session description information of another ROUTE session carried by the service components. To this end, the service components delivered through the plurality of ROUTE sessions may all be collected. This is similarly applicable to the case in which the service components of one service are delivered through a plurality of MMTP sessions. For reference, one service component may be simultaneously used by the plurality of services.

In another embodiment of the present invention, bootstrapping of an ESG service may be performed by a broadcast or broadband network. By acquiring the ESG over broadband, URL information of the SLT may be used. ESG information may be requested using this URL.

In another embodiment of the present invention, one service component of one service may be delivered over the broadcast network and the other service component may be delivered over broadband (hybrid). The S-TSID may describe components delivered over the broadcast network such that the ROUTE client acquires desired service components. In addition, the USBD may have base pattern information to describe which segments (which components) are delivered through which path. Accordingly, the receiver can confirm a segment to be requested from the broadband service and a segment to be detected in a broadcast stream.

In another embodiment of the present invention, scalable coding of a service may be performed. The USBD may have all capability information necessary to render the service. For example, when one service is provided in HD or UHD, the capability information of the USBD may have a value of “HD or UHD”. The receiver may check which component is reproduced in order to render the UHD or HD service using the MPD.

In another embodiment of the present invention, through a TOI field of the LCT packets delivered through the LCT channel delivering the SLS, which SLS fragment is delivered using the LCT packets (USBD, S-TSID, MPD, etc.) may be identified.

In another embodiment of the present invention, app components to be used for app based enhancement/an app based service may be delivered over the broadcast network as NRT components or may be delivered over broadband. In addition, app signaling for app based enhancement may be performed by an application signaling table (AST) delivered along with the SLS. In addition, an event which is signaling for operation to be performed by the app may be delivered in the form of an event message table (EMT) along with the SLS, may be signaled in the MPD or may be in-band signaled in the form of a box within DASH representation. The AST, the EMT, etc. may be delivered over broadband. App based enhancement, etc. may be provided using the collected app components and such signaling information.

In another embodiment of the present invention, a CAP message may be included and provided in the above-described LLS table for emergency alert. Rich media content for emergency alert may also be provided. Rich media may be signaled by a CAP message and, if rich media is present, the rich media may be provided as an EAS service signaled by the SLT.

In another embodiment of the present invention, linear service components may be delivered over the broadcast network according to the MMT protocol. In this case, NRT data (e.g., app components) of the service may be delivered over the broadcast network according to the ROUTE protocol. In addition, the data of the service may be delivered over broadband. The receiver may access the MMTP session delivering the SLS using the bootstrap information of the SLT. The USBD of the SLS according to the MMT may reference the MP table such that the receiver acquires linear service components formatted into the MPU delivered according to the MMT protocol. In addition, the USBD may further reference the S-TSID such that the receiver acquires NRT data delivered according to the ROUTE protocol. In addition, the USBD may further reference the MPD to provide a reproduction description of data delivered over broadband.

In another embodiment of the present invention, the receiver may deliver location URL information capable of acquiring a file content item (file, etc.) and/or a streaming component to a companion device through a web socket method. The application of the companion device may acquire components, data, etc. through a request through HTTP GET using this URL. In addition, the receiver may deliver information such as system time information, emergency alert information, etc. to the companion device.

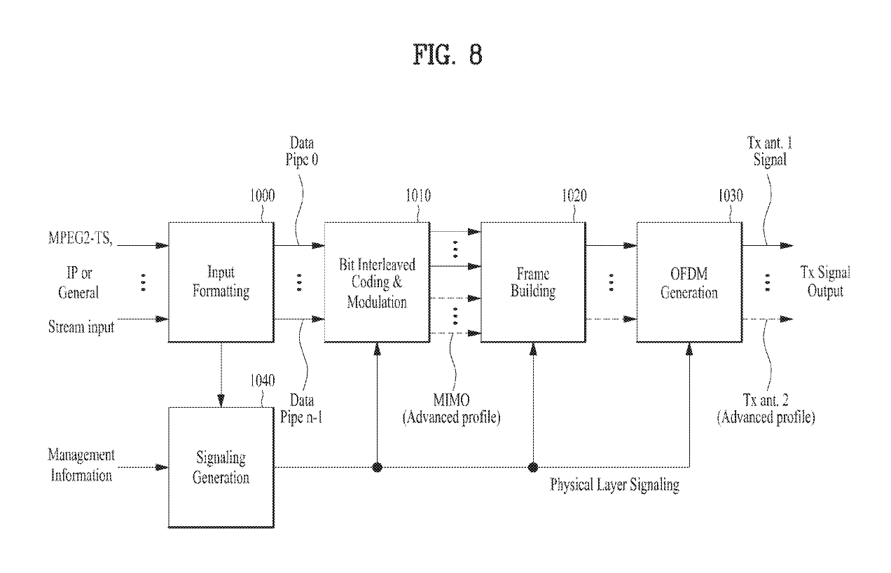

FIG. 8 is a diagram showing a structure of a broadcast signal transmission device of a next-generation broadcast service according to an embodiment of the present invention.

The broadcast signal transmission device of the next-generation broadcast service according to an embodiment of the present invention may include an input format block 1000, a bit interleaved coding & modulation (BICM) block 1010, a frame building block 1020, an orthogonal frequency division multiplexing (OFDM) generation block 1030, and a signaling generation block 1040. An operation of each block of the broadcast signal transmission device will be described.

According to an embodiment of the present invention, input data may use IP stream/packet and MPEG2-TS as main input format and other stream types may be handled as a general stream.

The input format block 1000 may demultiplex each input stream using one or more data pipes to which independent coding and modulation are applied. The data pipe may be a basic unit for robustness control and may affect quality of service (QoS). One or more services or service components may affect one data pipe. The data pipe may be a logical channel in a physical layer for delivering service data or metadata for delivering one or more services or service components.

Since QoS is dependent upon the characteristics of a service provided by the broadcast signal transmission device of the next-generation broadcast service according to an embodiment of the present invention, data corresponding to each service needs to be processed via different methods.

The BICM block 1010 may include a processing block applied to a profile (or system) to which MIMO is not applied and/or a processing block of a profile (or system) to which MIMO is applied and may include a plurality of processing blocks for processing each data pipe.

The processing block of the BICM block to which MIMO is not applied may include a data FEC encoder, a bit interleaver, a constellation mapper, a signal space diversity (SSD) encoding block, and a time interleaver. The processing block of the BICM block to which MIMO is applied is different from the processing block of the BICM to which MIMO is not applied in that a cell word demultiplexer and an MIMO encoding block are further included.

The data FEC encoder may perform FEC encoding on an input BBF to generate a FECBLOCK procedure using external coding (BCH) and internal coding (LDPC). The external coding (BCH) may be a selective coding method. The bit interleaver may interleave output of the data FEC encoder to achieve optimized performance using a combination of the LDPC code and a modulation method. The constellation mapper may modulate cell word from a bit interleaver or a cell word demultiplexer using QPSK, QAM-16, irregular QAM (NUQ-64, NUQ-256, NUQ-1024), or irregular constellation (NUC-16, NUC-64, NUC-256, NUC-1024) and provide a power-normalized constellation point. NUQ has an arbitrary type but QAM-16 and NUQ have a square shape. All of the NUQ and the NUC may be particularly defined with respect to each code rate and signaled by parameter DP_MOD of PLS2 data. The time interleaver may be operated at a data pipe level. A parameter of the time interleaving may be differently set with respect to each data pipe.

The time interleaver according to the present invention may be positioned between the BICM chain and the frame builder. In this case, the time interlever according to the present invention may selectively use a convolution interleaver (CI) and a block interleaver (BI) according to a physical layer pipe (PLP) mode or may use all. The PLP according to an embodiment of the present invention may be a physical path used using the same concept as the aforementioned DP and its term may be changed according to designer intention. The PLP mode according to an embodiment of the present invention may include a single PLP mode or a multiple PLP mode according to the number of PLPs processed by the broadcast signal transmitter or the broadcast signal transmission device. Time interleaving using different Lime interleaving methods according to a PLP mode may be referred to as hybrid time interleaving.

A hybrid time interleaver may include a block interleaver (BI) and a convolution interleaver (CI). In the case of PLP_NUM=1, the BI may not be applied (BI off) and only the CI may be applied. In the case of PLP_NUM>1, both the BI and the CI may be applied (BI on). The structure and operation of the CI applied in the case of PLP_NUM>1 may be different from those of the CI applied in the case of PLP_NUM=1. The hybrid time interleaver may perform an operation corresponding to a reverse operation of the aforementioned hybrid time interleaver.

The cell word demultiplexer may be used to divide a single cell word stream into a dual cell word stream for MIMO processing. The MIMO encoding block may process output of the cell word demultiplexer using a MIMO encoding method. The MIMO encoding method according to the present invention may be defined as full-rate spatial multiplexing (FR-SM) for providing increase in capacity via relatively low increase in complexity at a receiver side. MIMO processing may be applied at a data pipe level. When a pair of constellation mapper outputs, NUQ e_{1,i} and e_{2,i} is input to a MIMO encoder, a pair of MIMO encoder outputs, g1,i and g2,i may be transmitted by the same carrier k and OFDM symbol 1 of each transmission antenna.

The frame building block 1020 may map a data cell of an input data pipe in one frame to an OFDM symbol and perform frequency interleaving for frequency domain diversity.

According to an embodiment of the present invention, a frame may be divided into a preamble, one or more frame signaling symbols (FSS), and a normal data symbol. The preamble may be a special symbol for providing a combination of basic transmission parameters for effective transmission and reception of a signal. The preamble may signal a basic transmission parameter and a transmission type of a frame. In particular, the preamble may indicate whether an emergency alert service (EAS) is currently provided in a current frame. The objective of the FSS may be to transmit PLS data. For rapid synchronization and channel estimation and rapid decoding of PLS data, the FSS may have a pipe pattern with higher density than a normal data symbol.

The frame building block may include a delay compensation block for adjusting timing between a data pipe and corresponding PLS data to ensure co-time between a data pipe and corresponding PLS data at a transmitting side, a cell mapper for mapping a PLS, a data pipe, an auxiliary stream, a dummy stream, and so on to an active carrier of an OFDM symbol in a frame, and a frequency interleaver.

The frequency interleaver may randomly interleave a data cell received from the cell mapper to provide frequency diversity. The frequency interleaver may operate with respect to data corresponding to an OFDM symbol pair including two sequential OFDM symbols or data corresponding to one OFDM symbol using different interleaving seed orders in order to acquire maximum interleaving gain in a single frame.

The OFDM generation block 1030 may modulate an OFDM carrier by the cell generated by the frame building block, insert a pilot, and generate a Lime domain signal for transmission. The corresponding block may sequentially insert guard intervals and may apply PAPR reduction processing to generate a last RF signal.

The signaling generation block 1040 may generate physical layer signaling information used in an operation of each functional block. The signaling information according to an embodiment of the present invention may include PLS data. The PLS may provide an element for connecting a receiver to a physical layer data pipe. The PLS data may include PLS1 data and PLS2 data.

The PLS1 data may be a first combination of PLS data transmitted to FSS in a frame with fixed size, coding, and modulation for transmitting basic information on a system as well as a parameter required to data PLS2 data. The PLS1 data may provide a basic transmission parameter including a parameter required to receive and decode PLS2 data. The PLS2 data may be a second combination of PLP data transmitted to FSS for transmitting more detailed PLS data of a data pipe and a system. PLS2 signaling may further include two types of parameters of PLS2 static data (PLS2-STAT data) and PLS2 dynamic data (PLS2-DYN data). The PLS2 static data may be PLS2 data that is static during duration of a frame group and the PLS2 dynamic data may be PLS2 data that is dynamically changed every frame.

The PLS2 data may include FIC_FLAG information. A fast information channel (FIC) may be a dedicated channel for transmitting cross-layer information for enabling fast service acquisition and channel scanning. The FIC_FLAG information may indicate whether a fast information channel (FIC) is used in a current frame group via a 1-bit field. When a value of the corresponding field is set to 1, the FIC may be provided in the current frame. When a value of the corresponding field is set to 0, the FIC may not be transmitted in the current frame. The BICM block 1010 may include a BICM block for protecting PLS data. The BICM block for protecting the PLS data may include a PLS FEC encoder, a bit interleaver, and a constellation mapper.

The PLS FEC encoder may include a scrambler for scrambling PLS1 data and PLS2 data, a BCH encoding/zero inserting block for performing external encoding on the scrambled PLS 1 and 2 data using a BCH code shortened for PLS protection and inserting a zero bit after BCH encoding, a LDPC encoding block for performing encoding using an LDPC code, and an LDPC parity puncturing block. Only the PLS1 data may be permutated before an output bit of zero insertion is LDPC-encoded. The bit interleaver may interleave each of the shortened and punctured PLS1 data and PLS2 data, and the constellation mapper may map the bit-interleaved PLS1 data and PLS2 data to constellation.

A broadcast signal reception device of a next-generation broadcast service according to an embodiment of the present invention may perform a reverse operation of the broadcast signal transmission device of the next-generation broadcast service that has been described with reference to FIG. 8.

The broadcast signal reception device of a next-generation broadcast service according to an embodiment of the present invention may include a synchronization & demodulation module for performing demodulation corresponding to a reverse operation performed by the broadcast signal transmission device, a frame parsing module for parsing an input signal frame to extract data transmitted by a service selected by a user, a demapping & decoding module for converting an input signal into bit region data, deinterleaving bit region data as necessary, performing demapping on mapping applied for transmission efficiency, and correcting error that occurs in a transmission channel for decoding, an output processor for performing a reverse operation of various compression/signal processing procedures applied by the broadcast signal transmission device, and a signaling decoding module for acquiring and processing PLS information from the signal demodulated by the synchronization & demodulation module. The frame parsing module, the demapping & decoding module, and the output processor may perform the functions using the PLS data output from the signaling decoding module.

Hereinafter, the timer interleaver will be described. A time interleaving group according to an embodiment of the present invention may be directly mapped to one frame or may be spread over P_{I} frames. In addition, each time interleaving group may be divided into one or more (N_{TI}) time interleaving blocks. Here, each time interleaving block may correspond to one use of a time interleaver memory. A time interleaving block in the time interleaving group may include different numbers of XFECBLOCK. In general, the time interleaver may also function as a buffer with respect to data pipe data prior to a frame generation procedure.

The time interleaver according to an embodiment of the present invention may be a twisted row-column block interleaver. The twisted row-column block interleaver according to an embodiment of the present invention may write a first XFECBLOCK in a first column of the time interleaving memory, write a second XFECBLOCK in a next column, and write the remaining XFECBLOCKs in the time interleaving block in the same manner. In an interleaving array, a cell may be read in a diagonal direction to a last row from a first row (a leftmost column as a start column is read along a row in a right direction). In this case, to achieve single memory deinterleaving at a receiver side irrespective of the number of XFECBLOCK in the time interleaving block, the interleaving array for the twisted row-column block interleaver may insert a virtual XFECBLOCK into the time interleaving memory. In this case, to achieve single memory deinterleaving at a receiver side, the virtual XFECBLOCK needs to be inserted into another frontmost XFECBLOCK.

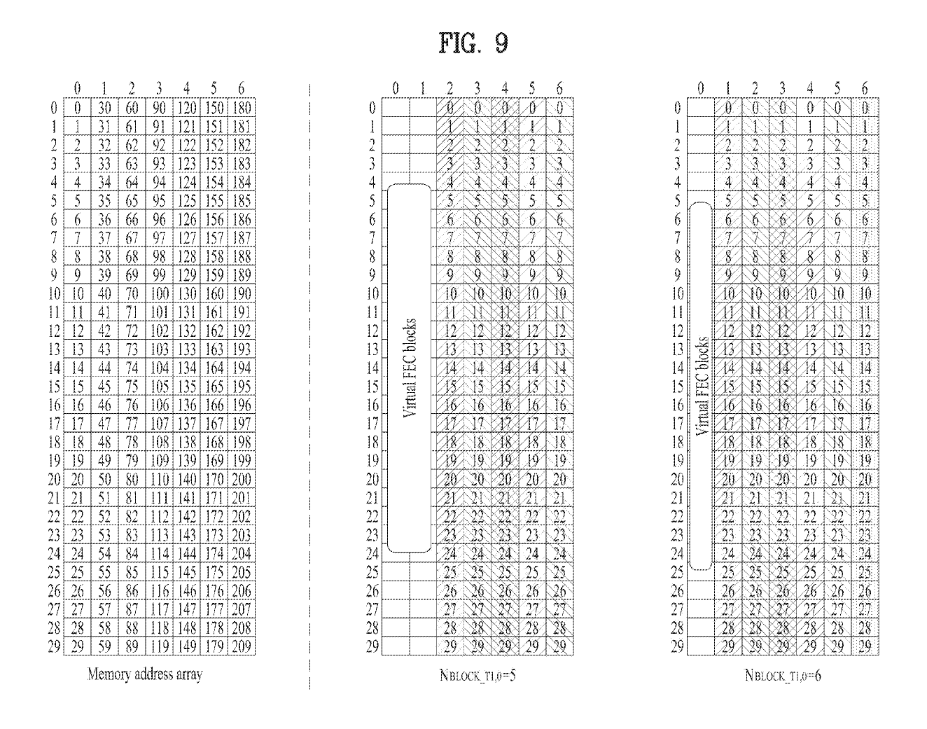

FIG. 9 is a writing operation of a time interleaver according to an embodiment of the present invention.

A block shown in a left portion of the drawing shows a TI memory address array and a block shown in a right portion of the drawing shows a writing operation when two or one virtual FEC blocks are inserted into a frontmost group of TI groups with respect to two consecutive TI groups.

The frequency interleaver according to an embodiment of the present invention may include an interleaving address generator for generating an interleaving address to be applied to data corresponding to a symbol pair.

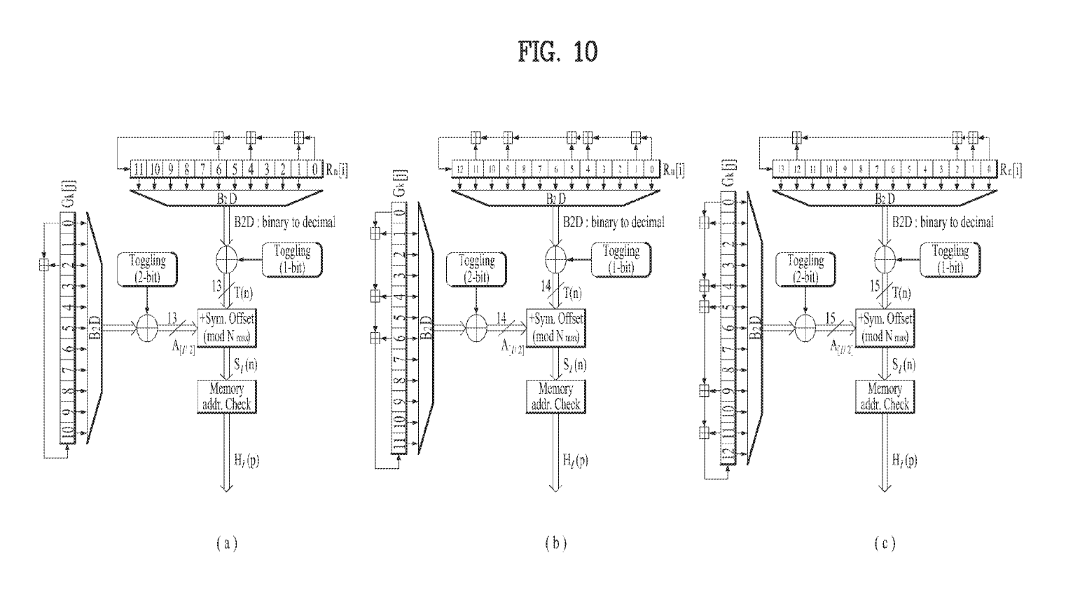

FIG. 10 is a block diagram of an interleaving address generator including a main-PRBS generator and a sub-PRBS generator according to each FFT mode, included in the frequency interleaver, according to an embodiment of the present invention.

(a) is a block diagram of an interleaving address generator with respect to a 8K FFT mode, (b) is a block diagram of an interleaving address generator with respect to a 16K FFT mode, and (c) is a block diagram of an interleaving address generator with respect to a 32K FFT mode.

An interleaving procedure with respect to an OFDM symbol pair may use one interleaving sequence and will be described below. First, an available data cell (output cell from a cell mapper) to be interleaved in one OFDM symbol O_{m,l} may be defined as O_{m,l}=[x_{m,l,0}, . . . , x_{m,l,p}, . . . , x_{m,l,Ndata-1}] with respect to l=0, . . . , N_{sym}−1. In this case, x_{m,l,p} may be a p^{th} cell of a l^{th} OFDM symbol in a m^{th} frame and N_{data} may be the number of data cells. In the case of a frame signaling symbol. N_{data}=C_{FSS}, in the case of normal data, N_{data}=C_{data}, and in the case of a frame edge symbol, N_{data}=C_{FES}. In addition, the interleaving data cell may be defined as P_{m,l}=[v_{m,l,0}, . . . , v_{m,l,Ndata-1}] with respect to l=0, . . . , N_{sym}−1.

With respect to an OFDM symbol pair, an interleaved OFDM symbol pair may be given according to v_{m,l,Hi(p)}=x_{m,l,p}, p=0, . . . , N_{data}−1 for a first OFDM symbol of each pair and given according to v_{m,l,p}=x_{m,l,Hi(p)}, p=0, . . . , N_{data}−1 for a second OFDM symbol of each pair. In this case, Hₗ(p) may be an interleaving address generated based on a cyclic shift value (symbol offset) of a PRBS generator and a sub-PRBS generator.

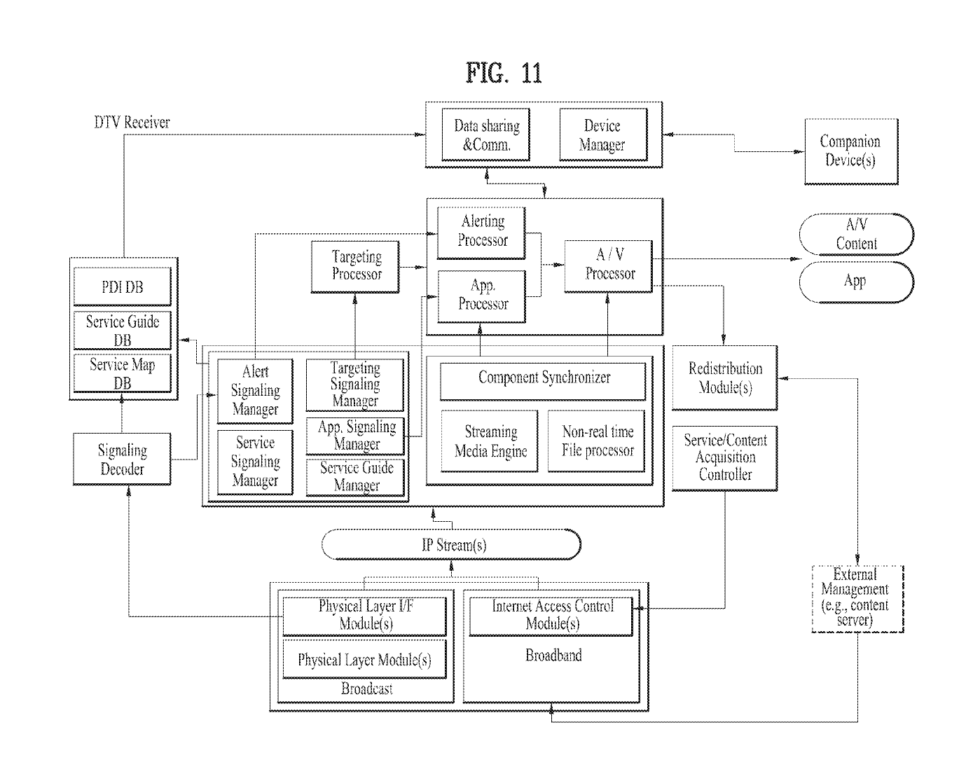

FIG. 11 is a block diagram illustrating a hybrid broadcast reception apparatus according to an embodiment of the present invention.

A hybrid broadcast system can transmit broadcast signals in connection with terrestrial broadcast networks and the Internet. The hybrid broadcast reception apparatus can receive broadcast signals through terrestrial broadcast networks (broadcast networks) and the Internet (broadband). The hybrid broadcast reception apparatus may include physical layer module(s), physical layer I/F module(s), service/content acquisition controller, Internet access control module(s), a signaling decoder, a service signaling manager, a service guide manager, an application signaling manager, an alert signal manager, an alert signaling parser, a targeting signaling parser, a streaming media engine, a non-real time file processor, a component synchronizer, a targeting processor, an application processor, an A/V processor, a device manager, a data sharing and communication unit, redistribution module(s), companion device(s) and/or an external management module.

The physical layer module(s) can receive a broadcast related signal through a terrestrial broadcast channel, process the received signal, convert the processed signal into an appropriate format and deliver the signal to the physical layer I/F module(s).

The physical layer I/F module(s) can acquire an IP datagram from information obtained from the physical layer module. In addition, the physical layer I/F module can convert the acquired IP datagram into a specific frame (e.g., RS frame, GSE, etc.).

The service/content acquisition controller can perform control operation for acquisition of services, content and signaling data related thereto through broadcast channels and/or broadband channels.

The Internet access control module(s) can control receiver operations for acquiring service, content, etc. through broadband channels.

The signaling decoder can decode signaling information acquired through broadcast channels.

The service signaling manager can extract signaling information related to service scan and/or content from the IP datagram, parse the extracted signaling information and manage the signaling information.

The service guide manager can extract announcement information from the IP datagram, manage a service guide (SG) database and provide a service guide.

The application signaling manager can extract signaling information related to application acquisition from the IP datagram, parse the signaling information and manage the signaling information.

The alert signaling parser can extract signaling information related to alerting from the IP datagram, parse the extracted signaling information and manage the signaling information.

The targeting signaling parser can extract signaling information related to service/content personalization or targeting from the IP datagram, parse the extracted signaling information and manage the signaling information. In addition, the targeting signaling parser can deliver the parsed signaling information to the targeting processor.

The streaming media engine can extract audio/video data for A/V streaming from the IP datagram and decode the audio/video data.

The non-real time file processor can extract NRT data and file type data such as applications, decode and manage the extracted data.

The component synchronizer can synchronize content and services such as streaming audio/video data and NRT data.

The targeting processor can process operations related to service/content personalization on the basis of the targeting signaling data received from the targeting signaling parser.

The application processor can process application related information and downloaded application state and represent parameters.

The A/V processor can perform audio/video rendering related operations on the basis of decoded audio/video data and application data.

The device manager can perform connection and data exchange with external devices. In addition, the device manager can perform operations of managing external devices connectable thereto, such as addition/deletion/update of the external devices.

The data sharing and communication unit can process information related to data transmission and exchange between a hybrid broadcast receiver and external devices. Here, data that can be transmitted and exchanged between the hybrid broadcast receiver and external devices may be signaling data, A/V data and the like.

The redistribution module(s) can acquire information related to future broadcast services and content when the broadcast receiver cannot directly receive terrestrial broadcast signals. In addition, the redistribution module can support acquisition of future broadcast services and content by future broadcast systems when the broadcast receiver cannot directly receive terrestrial broadcast signals.

The companion device(s) can share audio, video or signaling data by being connected to the broadcast receiver according to the present invention. The companion device may be an external device connected to the broadcast receiver.

The external management module can refer to a module for broadcast services/content provision. For example, the external management module can be a future broadcast services/content server. The external management module may be an external device connected to the broadcast receiver.

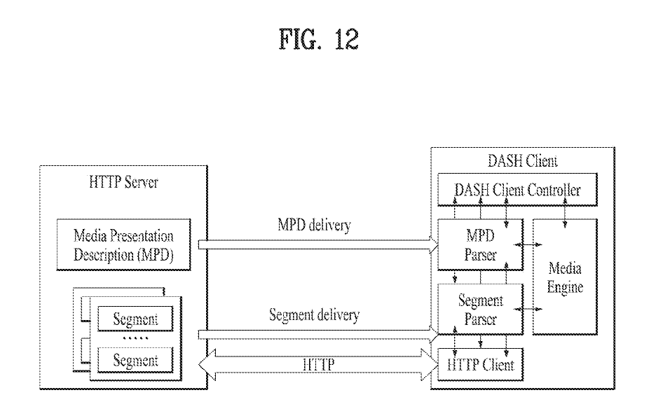

FIG. 12 is a diagram showing an overall operation of a DASH-based adaptive streaming model according to an embodiment of the present invention.

The present invention proposes a next-generation media service providing method for providing HFR content. The present invention proposes related metadata and a method of transmitting the metadata when frame rate information of HFR content for providing smooth movement of an object is provided. Thereby content may be adaptively adjusted and image quality with enhanced content may be provided.

In the case of UHD broadcast, etc., brightness that is not capable of being expressed by existing content, thereby providing sense of high realism. By virtue of introduction of HDR, an expression range of brightness of a content image is increased and, thus, a difference between characteristics for respective scenes of content may be increased compared with a previous case. To effectively express HFR content with HDR on a display, metadata may be defined and transmitted to a receiver. An image of content may be appropriately provided according to intention of a service provider based on the metadata received by the receiver.

The present invention proposes a method of signaling a frame rate parameter related to a video track, a video sample, etc. of content for providing HFR content based on a media file such as ISOBMFF. The present invention proposes a method of storing and signaling a frame rate parameter related to a video track (stream). The present invention proposes a method of storing and signaling a frame rate parameter related to a video sample, a video sample group, or a video sample entry. The present invention proposes a method of storing and signaling a SEI NAL unit containing frame rate related information of HFR content.

The method of storing/transmitting the frame rate information of the HFR content according to the present invention may be used to generate content for supporting HFR. That is, when a media file of content for supporting HFR is generated, a DASH segment operating in MPEG DASH is generated, or MPU operating in MPEG MMT is generated, the method according to the present invention may be used. A receiver (which includes a DASH client, an MMT client, or the like) may acquire frame rate information (flag, parameter, box, etc.) from a decoder and so on and may effectively provide corresponding content based on the information.

The below-described frame rate configuration box or frame rate related flag information may be simultaneously present in a plurality of boxes in a media file, a DASH segment, or MMT MPU. In this case, the frame rate information defined in a higher box may be overridden by frame rate information defined in a lower box. For example, when frame rate information is simultaneously included in a tkhd box and a vmhd box, the frame rate information of the tkhd box may be overridden by the frame rate information of the vmhd.

The DASH-based adaptive streaming model according to the illustrated embodiment may write an operation between an HTTP server and a DASH client. Here, a dynamic adaptive streaming over HTTP (DASH) may be a protocol for supporting HTTP-based adaptive streaming and may dynamically support streaming according to a network situation. Accordingly, AV content reproduction may be seamlessly provided.

First, the DASH client may acquire MPD. The MPD may be transmitted from a service provider such as a HTTP server. The MPD may be transmitted according to delivery according to the aforementioned embodiment. The DASH client may request a server of corresponding segments using access information to a segment described in the MPD. Here, the request may reflect a network state and may be performed.

The DASH client may acquire a corresponding segment and, then, process the segment in a media engine and, then, display the segment on a screen. The DASH client may reflect a reproduction time and/or a network situation in real time and make a request for and acquire a required segment (Adaptive Streaming). Thereby, content may be seamlessly reproduced.

The media presentation description (MPD) may be represented in the form of XML as a file containing detailed information for permitting the DASH client to dynamically acquire a segment. In some embodiments, the MPD may be the same as the aforementioned MPD.

A DASH client controller may reflect a network situation to generate a command for making a request for MPD and/or a segment. The controller may control the acquired information to be used in an internal block such as a media engine.

A MPD parser may parse the acquired MPD in real time. Thereby, the DASH client controller may generate a command for acquiring a required segment.

A segment parser may parse the acquired segment in real time. Internal blocks such as a media engine may perform a specific operation according to information included in a segment.

A HTTP client may make a request for required MPD and/or segment to a HTTP server. The HTTP client may transmit the MPD and/or segments acquired from the server to the MPD parser or the segment parser.

The media engine may display content on a screen using media data included in a segment. In this case, information of the MPD may be used.

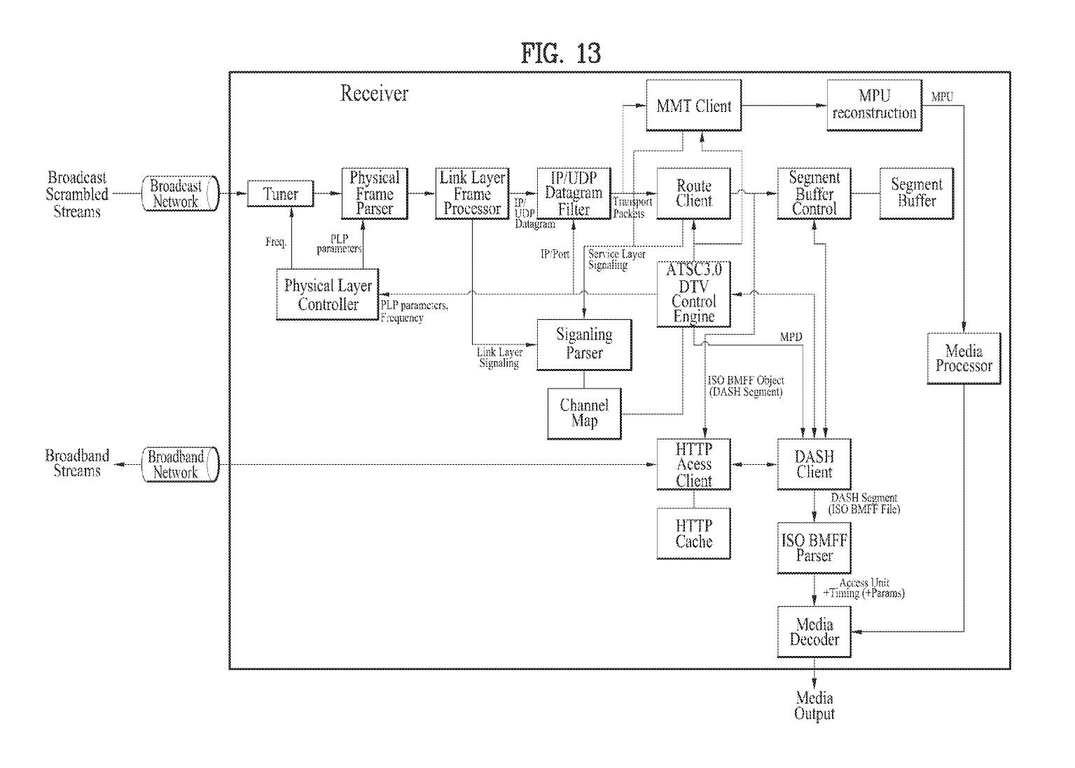

FIG. 13 is a block diagram of a receiver according to an embodiment of the present invention.

The receiver according to the illustrated embodiment may include a tuner, a physical layer controller, a physical frame parser, a link layer frame processor, an IP/UDP datagram filter, a DTV control engine, a route client, a segment buffer control, an MMT client, an MPU reconstruction, a media processor, a signaling parser, a DASH client, an ISO BMFF parser, a media decoder, and/or an HTTP access client. Each detailed block of the receiver may be a hardware processor.

The tuner may receive and process a broadcast signal through a terrestrial broadcast channel to tune the broadcast signal in a proper form (physical frame, etc.). The physical layer controller may control operations of the tuner, the physical frame parser, etc. using RF information, etc. of a broadcast channel as a reception target. The physical frame parser may parse the received physical frame and acquire a link layer frame, etc. via processing related to the physical frame.

The link layer frame processor may acquire link layer signaling, etc. from the link layer frame or may acquire IP/UDP datagram and may perform related calculation. The IP/UDP datagram filter may filter specific IP/UDP datagram from the received IP/UDP datagram. The DTV control engine may mange an interface between components and control each operation via transmission of a parameter, etc.

The route client may process a real-time object delivery over unidirectional transport (ROUTE) packet for supporting real-time object transmission and collect and process a plurality of packets to generate one or more base media file format (ISOBMFF) objects. The segment buffer control may control a buffer related to segment transmission between the route client and the dash client.

The MMT client may process a MPEG media transport (MMT) transport protocol packet for supporting real-time object transmission and collect and process a plurality of packets. The MPU reconstruction may reconfigure a media processing unit (MPU) from the MMTP packet. The media processor may collect and process the reconfigured MPU.

The signaling parser may acquire and parse DTV broadcast service related signaling (link layer/service layer signaling) and generate and/or manage a channel map, etc. based thereon. This component may process low level signaling and service level signaling.

The DASH client may perform real-time streaming or adaptive streaming related calculation and process the acquired DASH segment, etc. The ISO BMFF parser may extract data of audio/video, a related parameter, and so on from the ISO BMFF object. The media decoder may process decoding and/or presentation of the received audio and video data. The HTTP access client may make a request for specific information to the HTTP server and process response to the request.

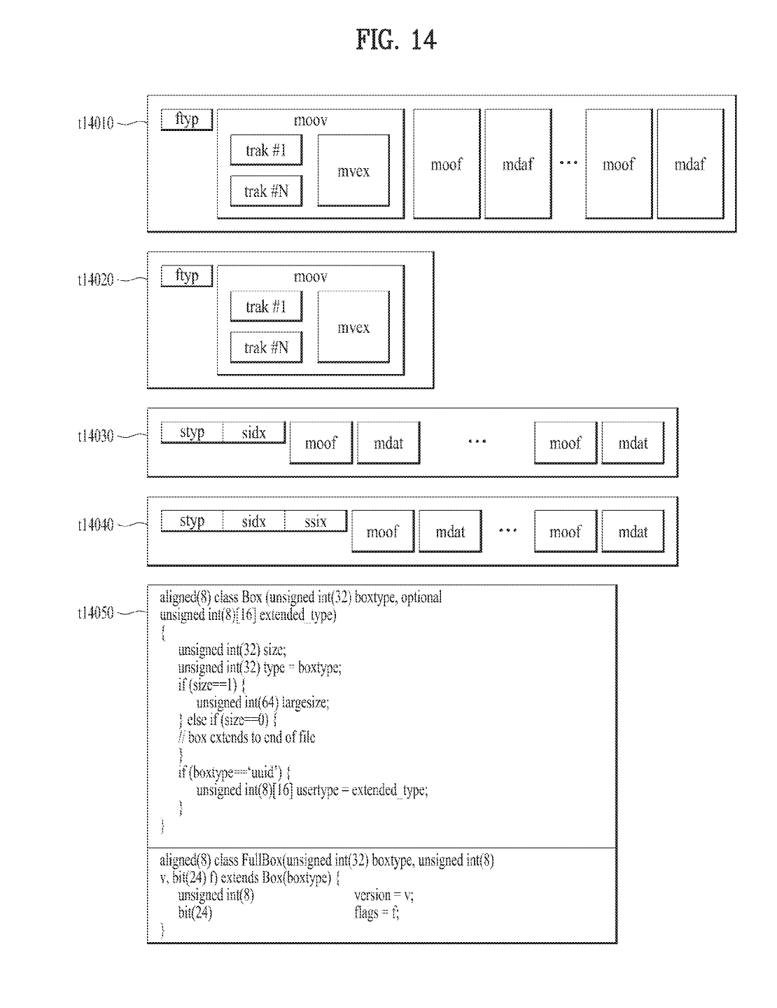

FIG. 14 is a diagram showing a configuration of a media file according to an embodiment of the present invention.

To store and transmit media data such as audio or video, formalized media file format may be defined. In some embodiments, the media file according to the present invention may have a file format based on ISO base media file format (ISO BMFF).

The media file according to the present invention may include at least one box. Here, the box may be a data block or object including media data or metadata related to media data. Boxes may be an inter-hierarchical structure and, thus, media may be classified according to the inter-hierarchical structure such that a media file has a format appropriate to store and/or transmit large-scale media data. The media file may have a structure for easily accessing media information, for example, a structure for permitting a user to move a specific point of media content.

The media file according to the present invention may include a ftyp box, a moov box, and/or a mdat box.

The ftyp box (file-type box) may provide a file type or compatibility related information of a corresponding media file. The ftyp box may include configuration version information of media data of a corresponding media file. A decoder may identify a corresponding media file with reference to the ftyp box.

The moov box (movie box) may be a box including metadata of media data of a corresponding media file. The moov box may function as a container of all metadata. The moov box may be a box of an uppermost layer among metadata related boxes. In some embodiments, only one moov box may be present in a media file.

The mdat box (media data box) may be a box containing actual media data of a corresponding media file. The media data may include an audio sample and/or video samples and the mdat box may function as a container containing the media samples.

In some embodiments, the aforementioned moov box may further include a mvhd box, a trak box, and/or a mvex box as a lower box.

The mvhd box (movie header box) may include media presentation related information of media data included in a corresponding media file. That is, the mvhd box may include information such as media generation time, change time, time interval, period, etc. of corresponding media presentation.

The trak box (track box) may provide information related to a track of corresponding media data. The trak box may include information such as stream related information, presentation related information, and access related information of an audio track or a video track. A plurality of trak boxes may be present according to the number of tracks.

In some embodiments, the trak box may further include a tkhd box (track header box) as a lower box. The tkhd box may include information on a corresponding track indicated by the trak box. The tkhd box may include information such as generation time, change time, and track identifier of a corresponding track.

The mvex box (movie extend box) may indicate that the below-described moof box is present in a corresponding media file. To know all media samples of a specific track, moof boxes need to be scanned.

In some embodiments, the media file according to the present invention may be divided into a plurality of fragments (t14010). Thereby, the media file may be segmented and stored or transmitted. Media data (mdat box) of the media file may be segmented into a plurality of fragments and each fragment may include a moof box and the segmented mdat box. In some embodiments, to use fragments, information of the ftyp box and/or the moov box may be required.

The moof box (movie fragment box) may provide metadata of media data of a corresponding fragment. The moof box may be a box of an uppermost layer among metadata related boxes of a corresponding fragment.

The mdat box (media data box) may include actual media data as described above. The mdat box may include media samples of media data corresponding to each corresponding fragment.

In some embodiments, the aforementioned moof box may include a mfhd box and/or a traf box as a lower box.

The mfhd box (movie fragment header box) may include information related to a relationship of a plurality of fragmented fragments. The mfhd box may include a sequence number and may indicate a sequence of data obtained by segmenting media data of a corresponding fragment. Whether segmented data is omitted may be checked using the mthd box.

The traf box (track fragment box) may include information on a corresponding track fragment. The traf box may provide metadata of a segmented track fragment included in a corresponding fragment. The traf box may provide metadata to decode/reproduce media samples in a corresponding track fragment. A plurality of traf boxes may be present according to the number of track fragments.

In some embodiments, the aforementioned traf box may include a tfhd box and/or a trun box as a lower box.

The tfhd box (track fragment header box) may include header information of a corresponding track fragment. The tfhd box may provide information of a basic sample size, period, offset, and identifier with respect to media samples of a track fragment indicated by the aforementioned traf box.

The trun box (track fragment run box) may include corresponding track fragment related information. The trun box may include information such as a period, size, and reproduction time for each media sample.

The aforementioned media file and fragments of the media file may be processed and transmitted as segments. The segment may include initialization segment and/or media segment.

A file according to the illustrated embodiment t14020 may be a file containing information related to initialization of a media decoder except for media data. The file may correspond to, for example, the aforementioned initialization segment. The initialization segment may include the aforementioned ftyp box and/or moov box.

A file according to the illustrated embodiment t14030 may be a file containing the aforementioned fragment. The file may correspond to, for example, the aforementioned media segment. The media segment may include the aforementioned moof box and/or mdat box. The media segment may further include a styp box and/or a sidx box.

The styp box (segment type box) may provide information for identifying media data of a segmented fragment. The styp box may perform the same function as the aforementioned ftyp box with respect to the segmented fragment. In some embodiments, the styp box may have the same format as the ftyp box.

The sidx box (segment index box) may provide information indicating an index of a segmented fragment. Thereby, the box may indicate a sequence of the corresponding segmented fragment.

In some embodiments (t14040), a ssix box may be further included and the ssix box (sub segment index box) may be further segmented into sub segments and, in this case, may provide information indicating an index of the sub segment.

Boxes of a media file may include further extended information based on the box and FullBox form shown in the illustrated embodiment t14050. In this embodiment, a size field and a largesize field may indicate a length of a corresponding box in units of bytes. The version field may indicate a version of a corresponding box format. The type field may indicate a type and identifier of a corresponding box. The flags field may indicate a flag, etc. related to a corresponding box.

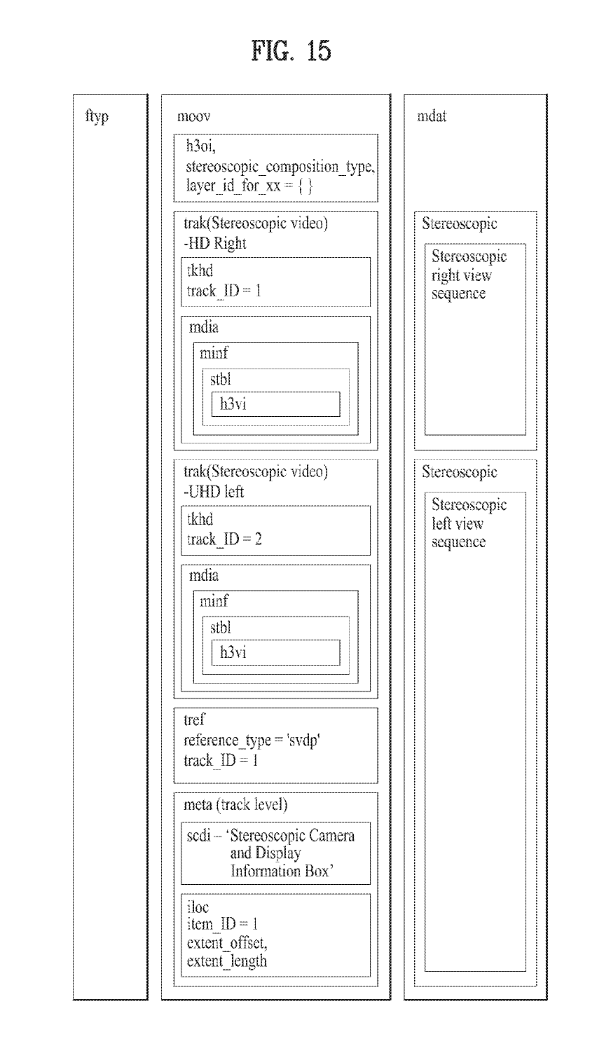

FIG. 15 is a diagram illustrating a configuration of a file for a hybrid 3D service based on scalable high efficiency video coding (SHVC) according to an embodiment of the present invention. 3D content based on SHVC may refer to a left/right sequence type. The configuration of the file according to an embodiment of the present invention may include a fyp box, a moov box, and a mdat box. The moov box may include at least one trak box and the trak box may include at least one of a tkhd box and a mdia box. The mdia box may include a minf box and the minf box may include a stbl box. The stbl box may include an h3vi box that will be described later. The mdat box may include left image and right image sequences of a stereoscopic image configuring the 3D content. According to an embodiment of the present invention, the moov box may further include a hybrid 3d overall information (h3oi) box. The h3oi box may include overall information for providing a SHVC-based hybrid 3d service. Information included in each box will be described below in detail.

The trak box may include temporal and spatial information of media data. Here, the media data may include, for example, stereoscopic video sequences, stereo-monoscopic mixed video sequences, LASeR streams, and a JPEG image. As shown in the diagram, a first trak box according to an embodiment of the present invention may include a right view image of HD resolution of stereoscopic video. In this case, track_ID included in the first trak box may be set to 1. A second trak box may include a left view image of UHD resolution of stereoscopic video. In this case, track_ID included in the second trak box may be set to 2. For stereoscopic video application format (stereoscopic video AF), each of the trak boxes may include at least of a mdia box, a tref box, and a track level meta box, which are related to the stereoscopic video AF.

The mdia box may include a svmi box for a stereoscopic visual type and may include fragment information of stereoscopic content included in a track. The tref box may provide track_ID of a reference track. In the case of a stereoscopic video format, in the file configuration according to an embodiment of the present invention, stereoscopic contents may be stored for left/right view sequence types, respectively, as shown in the drawing. Accordingly, the ‘tref’ box is used for indicating a pair of stereoscopic left and right view sequences for the Left/Right view sequence type. In the aforementioned embodiment, the tref box may define a reference type as svdp and may set a trak with track_ID=1 as a reference track. The tref box for the stereoscopic video AF will be described in detail. When stereoscopic contents are included in one single track, the tref box may be omitted.

A meta box of a track level may include a scdi box and an item location (iloc) box. The scdi box may provide information on at least one of a stereoscopic camera, a display, and visual safety. The iloc box may describe absolute offset of stereoscopic fragments in units of bytes and may be represented using extent_offset. The iloc box may describe sizes of stereoscopic fragments and may be represented using extent_length. For resource referencing, item_ID may be assigned to each fragment of a stereoscopic sequence.

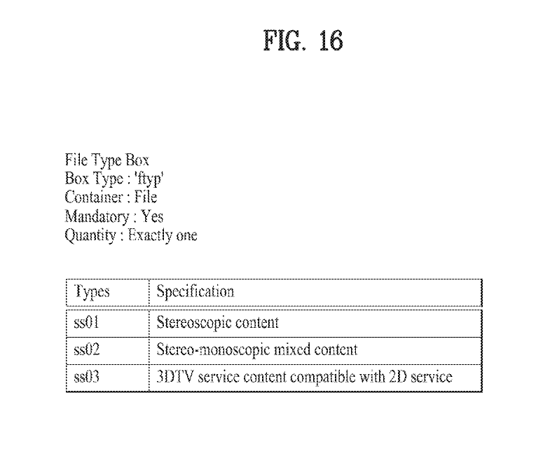

FIG. 16 is a diagram showing file type box ftyp according to an embodiment of the present invention. The ftyp box may use a stereoscopic video media information box described in ISO/IEC 23000-11 as the document of a stereoscopic multimedia application format. The box type may be ftyp and a container may be a file. One file may include only one ftyp box. A brand type of stereoscopic content may include ss01, ss02, and ss03 as shown in the drawing. A type ss01 may refer to stereoscopic content and a type ss02 may refer to stereo-monoscopic mixed content. The stereo-monoscopic mixed content may refer to content in which stereoscopic and monoscopic images are mixed in one content. A type ss03 may refer to 3DTV service content compatible with 2-dimensional (2D) service. According to an embodiment of the present invention, the 3D content may correspond to a type ss03. That is, a HD right-view image and a UHD left-view image are separately included in one file and, thus, only one image may be decoded to be compatible with a 2D service.

FIG. 17 is a diagram showing a hybrid 3D overall information box (h3oi) according to an embodiment of the present invention. The present embodiment relates to an h3oi box when one track includes only one layer. The h3oi box may be included in a moov box or a meta box and only one h3oi box may be included in a moov box or a meta box. The hybrid 3d overall information (h3oi) box may include overall information for providing an SHVC-based hybrid 3D service. The h3oi box may include information on a track and a layer that are included for each view for the case of a 3D service. The h3oi box may include information on a combination of a track and a layer that are required to a 2D service. Here, one track includes only one layer and, thus, the track and the layer may have the same meaning. Fields included in h3oi will now be described, stereoscopic_composition_type information may define stereoscopic_composition_type for a service including a stream with left and right view images being separated in addition to a stereoscopic_composition_type value of a stereoscopic video media information box of ISO/IEC 23000-11. For example, the stereoscopic_composition_type may define an SHVC-based 3D service type. As shown in a lower part of the drawing, when the stereoscopic_composition_type is 0x00, this may indicate a side-by-side type, in the case of 0x01, this may indicate a vertical line interleaved type, in the case of 0x02, this may indicate a frame sequential type, and in the case of 0x03, this may indicate a left/right view sequence type. According to an embodiment of the present invention, for a service including a stream with left and right view images being separated, 0x04 may be defined and this may indicate an SHVC-based 3D service type. Here, the SHVC-based 3D service type may indicate that left view and right view streams are each a type including a track or a layer, single_view_allowed information may indicate whether content included in a corresponding file is capable of providing a 2D service. The stereoscopic_view_allowed may indicate whether content included in the corresponding file is capable of providing a stereoscopic service, number_of_tracks_for_2d information may indicate the number of tracks or layers included in a 2D service. When a track including a base layer is HD and a track including an enhancement layer includes residual data for 4K, a number_of_tracks_for_2d field may be set to 2. track_id_for_2d information may indicate an identifier of a track including an image included in a 2D service. When 2D is served via SHVC, this may indicate DependencyId of a track included in 2D. In particular, in the case of an SHVC stream including a plurality of scalable layers, every layer does not include 2D and, thus, a track included in a 2D service may be obviously signaled using the track_id_for_2d field.

number_of tracks_per_view information may refer to the number of tracks included in one view, i.e., a left or right view. When a left view include one track including a base layer and one track including an enhancement layer, a value of the number_of_track_per_view field may be set to 2. is_right_flag information may indicate whether a current view is a right view. track_id_for_per_view information may be an identifier of a track included for each view included in a 3D service. This may indicate DependencyId of a track included in each view. Tracks included in each view may be obviously identified through the track_id_for_per_view field. In the shown embodiment, this includes each view, a track id for [i], and [j] via 2D arrangement of [i][j] but, in some embodiments, may be arranged via ID arrangement.

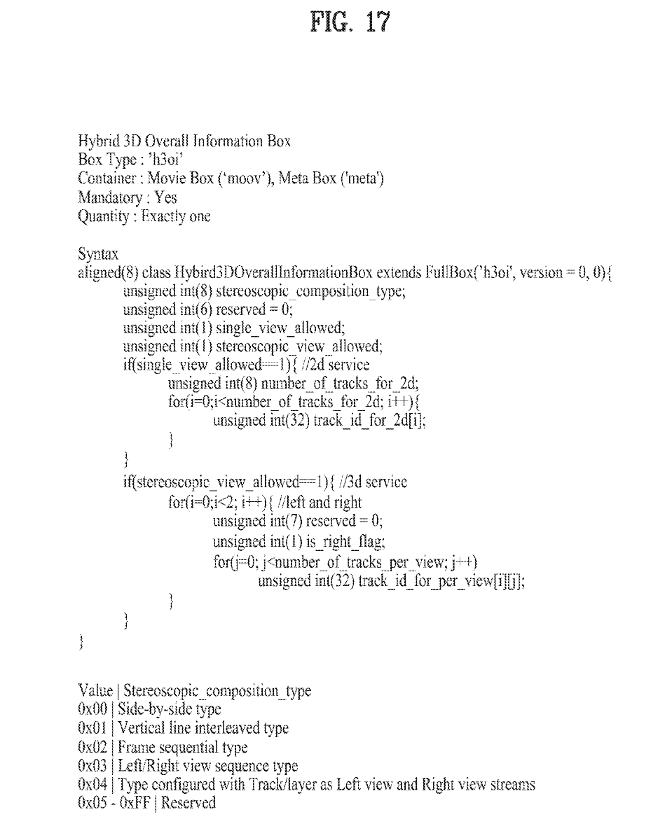

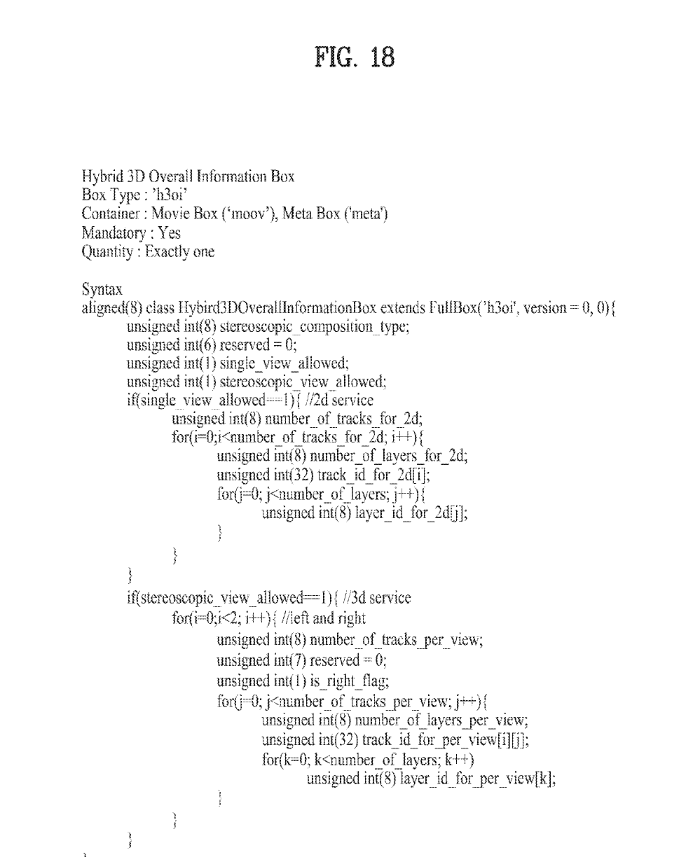

FIG. 18 is a diagram showing a hybrid 3D overall information box (h3oi) according to another embodiment of the present invention. The present embodiment relates to an h3oi box when one track includes a plurality of layers. The h3oi box may be included in a moov box or a meta box and only one h3oi box may be included in a moov box or a meta box. The hybrid 3d overall information (h3oi) box may include overall information for providing a hybrid 3D service. The h3oi box may include information on a track and a layer that are included for each view for the case of a 3D service. The h3oi box may include information on a combination of a track and a layer that are required to a 2D service. Fields included in the h3oi may have the same meaning as fields with the same name that is described with reference to the previous diagrams. In addition, fields added in the present embodiment will now be described. number_of_layers_for_2d information may refer to the number of layers for a 2D service included in each track. layer_id_for_2d information may be an identifier of a layer included in each track. This may indicate DependencyId of a layer included in each track included in a 2D service. number_of_layers_for_per_view may refer to the number of layers included in a specific track included in each view. layer_id_for_per_view information may be an identifier of a layer included in a specific track included in each view for a 3D service. This may indicate DependencyId of a layer included in a specific track included in each view to configure a 3D service. The remaining information of the h3oi box may be the same as Hybird3DOverallInformationBox when one track includes only one layer, as described above.

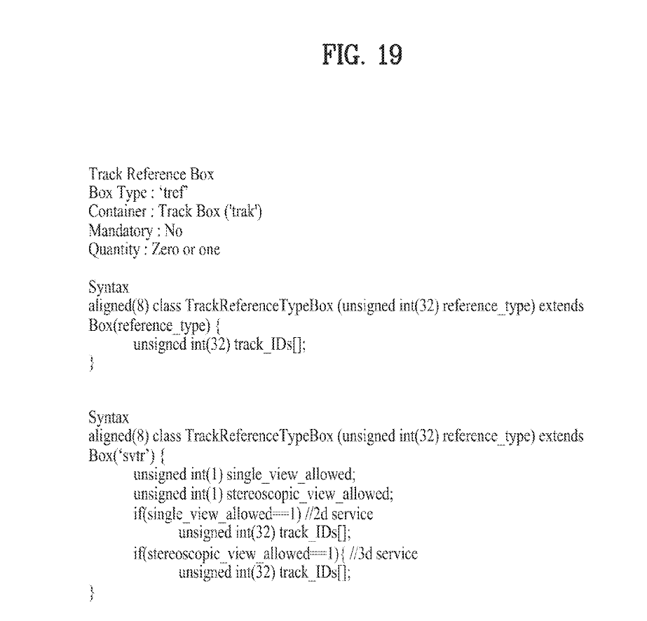

FIG. 19 is a diagram showing a track reference (tret) box according to an embodiment of the present invention. The tref box may indicate a track including a base layer or a track or layer having a correlation with a layer included in a current track. A box type may be tref and may be included in the trak box. The trak box may include one tref box or may not include a tref box, in some embodiment. The tref box may provide a reference indicating a track in presentation, associated with a track included in a trak box included in the tref box. A type of the reference may be determined. As shown, the tref box may include track_ID. The track_ID may be an integer value and may provide reference indicating a track in presentation, associated with a track included in the trak box. Here, track_IDs may be reused or may not be the same as zero. reference_type information may have the following type values. A hint type may indicate that a referenced track includes original media for a corresponding hint track. A cdsc type may indicate that a corresponding track describes a referenced track. A font type may indicate that a corresponding track is defined in a referenced track or is used in delivered fonts. A hind type may indicate that this is dependent upon a referenced hint track. That is, this may be used only when the referenced hint track is used. A vdep type may indicate that a corresponding track includes auxiliary depth video information for a referenced video track. A vplx type may indicate that a corresponding track includes auxiliary parallax video information for a referenced video track. A subt type may indicate that a corresponding track includes subtitles for an arbitrary track in a replaced group included in a referenced track or the corresponding track, a timed text, or overlay graphical information. The reference type according to an embodiment of the present invention may have the following reference type. For example, in the case of ISO base media file format [ISO/IEC 14496-12], a ‘hint’ reference links from the containing hint track to the media data that it hints. The ‘hind’ dependency indicates that the referenced track(s) may contain media data required for decoding of the track containing the track reference. These types may be used to identify a track of a base layer and an enhancement layer for a low/high quality 2D sequence type. In the case of stereoscopic multimedia application format [ISO/IEC 23000-11], svdp may indicate that a corresponding track describes a reference track, and the reference track has dependency upon the referenced track and includes stereoscopic associated with meta information. These types may identify a track of primary view and secondary view for a left/right sequence type. In some embodiments, as shown in a lower part of the drawing, reference_type may be newly defined as ‘svtr’ and track id for 2D and 3D may be included in one track reference (tref) box. Svtr may include single_view_allowed information, stereoscopic_view_allowed information, and track_id information. When the single_view_allowed information is set to 1, the track_group_id information may indicate information for a 2D service. When the stereoscopic_view_allowed information is set to 1, track_id information may indicate information for a 3D service.

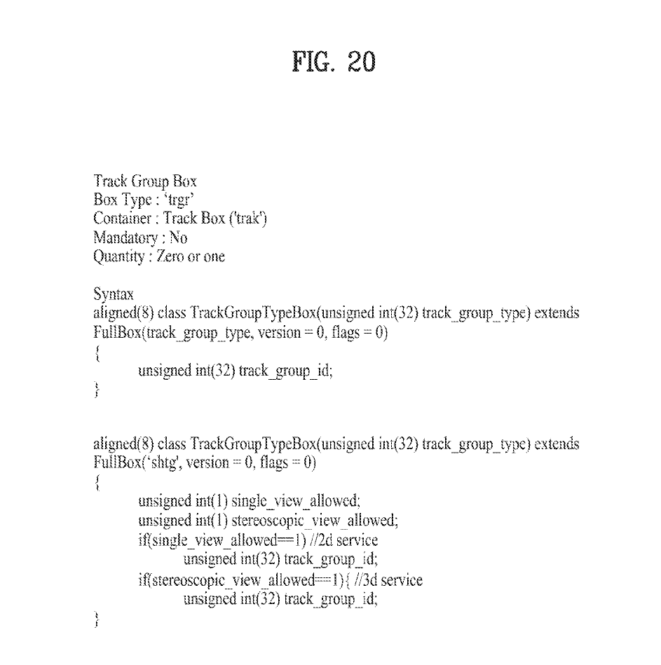

FIG. 20 is a diagram showing a track group (trgr) box according to an embodiment of the present invention. Trgr may indicate whether tracks included in a corresponding group are for a 2D service or a 3D service. A box type may be trgr and may be included in the trak box. The trak box may include one trgr box or may not include a trgr box in some embodiments. The trgr box may indicate a group of tracks or groups may share specific characteristics. Tracks in one group defined by the trgr box may have specific relationship. Fields included in the trgr box may have the following meaning. track_group_type information may indicate a used grouping type and may have one value of the following values, registered values, or values extracted from a specific document. stereoscopic track group (sctg) information may be a stereoscopic track group type to be applied in a hybrid 3D service and may refer to track_group_type when a corresponding track is used in a 3D service. The scalable video track group (svtg) may be a scalable video track group type to be applied to a scalable 2D service and may indicate that a corresponding track is one track for 2D scalable. In some cases, track_group_type for a SHVC-based 2D/3D service may be newly defined as a SHVC track group (shtg) and, as shown in a lower part of the drawing, TrackGroupTypeBox may be defined. shtg may include single_view_allowed information, stereoscopic_view_allowed information, and track_group_id information. When the single_view_allowed information is set to 1, the track_group_id information may indicate information for a 2D service. When the stereoscopic_view_allowed information is set to 1, the track_group_id information may indicate information for a 3D service. This may indicate that one track is configured with a plurality of combinations. That is, a corresponding track is included in each of 2D and 3D services and, thus, may be grouped by each track_group_id. A pair of the track_group_id information and the track_group_type information may identify a track group in a file. Tracks including specific track group type boxes having the same track_group_id may be included in the same track group.

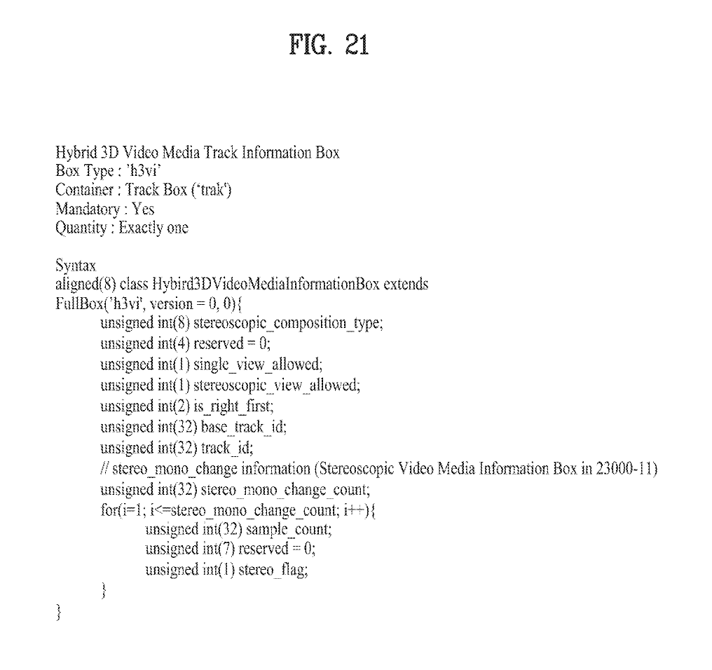

FIG. 21 is a diagram showing a hybrid 3D video media information (h3vi) box according to an embodiment of the present invention. The h3vi box may be used when one track includes only one layer. A box type may be h3vi and may be included in a trak box. The trak box may include only one h3vi box. The h3vi may provide stereoscopic video media information of a stereoscopic visual type. That is, the h3vi box may include at least one of stereoscopic_composition_type information, single_view_allowed information, stereoscopic_view_allowed information, is_right_first information, base_track_id information, track_id information, stereo_mono_change_count information, sample_count information, and/or stereo_flag information. The stereoscopic_composition_type information may define stereoscopic_composition_type for a service configured with a stream with left and right images being separated in addition to a stereoscopic_composition_type value of a stereoscopic video media information box of ISO/IEC 23000-11. For example, a SHVC-based 3D service may correspond thereto. The single_view_allowed information may indicate whether video of a corresponding track is capable of providing a 2D service. That is, this may indicate information on whether video of a corresponding track is used or displayed when a 2D service is provided. The stereoscopic_view_allowed information may indicate whether video of a corresponding track is included in a stereoscopic service. That is, this may indicate whether video of a corresponding track is used when a stereoscopic service is provided. is_right_first information may be an example of is_left_first stated in ISO/IEC 23000-11. In the case of a left/right view sequence type with Stereoscopic_composition_type information of 0x03, the meaning of the is_right_first is now be described. When a value of the field is 0, this may indicate that a corresponding track is used only in a 2D service. When a value of the field is 1, a primary view sequence and a secondary view sequence may indicate a left view image and a right view image, respectively. When a value of the field is 2, a primary view sequence and a secondary view sequence may indicate a right view image and a left view image, respectively. base_track_id information may indicate that a track (layer) as a base of a current track (layer). Here, the base_track_id indicates dependencyID and, thus, may be equal to or smaller than track_id. The track_id information may indicate an id of a current track (layer). This may indicate DependencyId of a layer as an identifier of a layer. The remaining information included in the h3vi may be the same as in a description of a field of stereoscopic video media information box of ISO/IEC 23000-11.

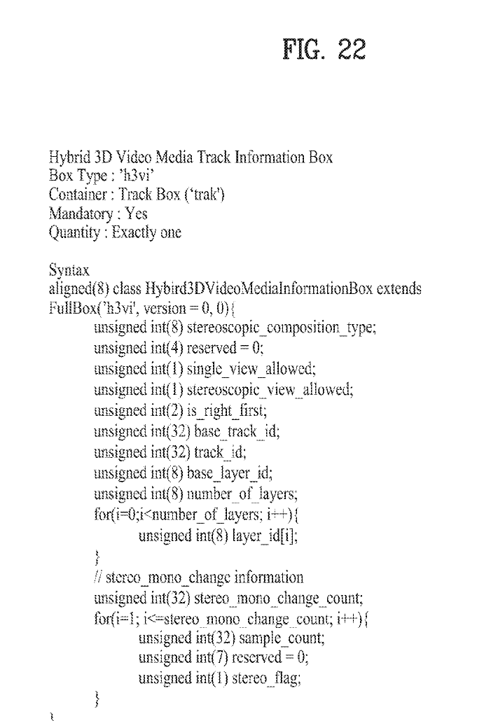

FIG. 22 is a diagram showing hybrid 3D video media information (h3vi) according to another embodiment of the present invention. The h3vi box may be included when a plurality of layers are included in one track. A box type may be h3vi and may be included in a trak. The trak box may include only one h3vi box. The h3vi may provide stereoscopic video media information of a stereoscopic visual type. The h3vi may include at least one of the illustrated pieces of information. That is, the h3vi box may include at least one of stereoscopic_composition_type information, single_view_allowed information, stereoscopic_view_allowed information, is_right_first information, base_track_id information, track_id information, base_layer_id information, number_of_layers information, layer_id information, stereo_mono_change_count information, sample_count information, and/or stereo_flag information.

number_of_layers information may refer to the number of layers included in a current track. The base_layer_id information may indicate an identifier (ID) of a layer as a base, included in base track id. The layer_id information may indicate an identifier of a layer included in a current track. This may indicate DependencyId of a layer as an identifier of a layer. The remaining information included in the h3vi box may have the same meaning as the aforementioned Hybird3DVideoMediaInformationBox of FIG. 21.

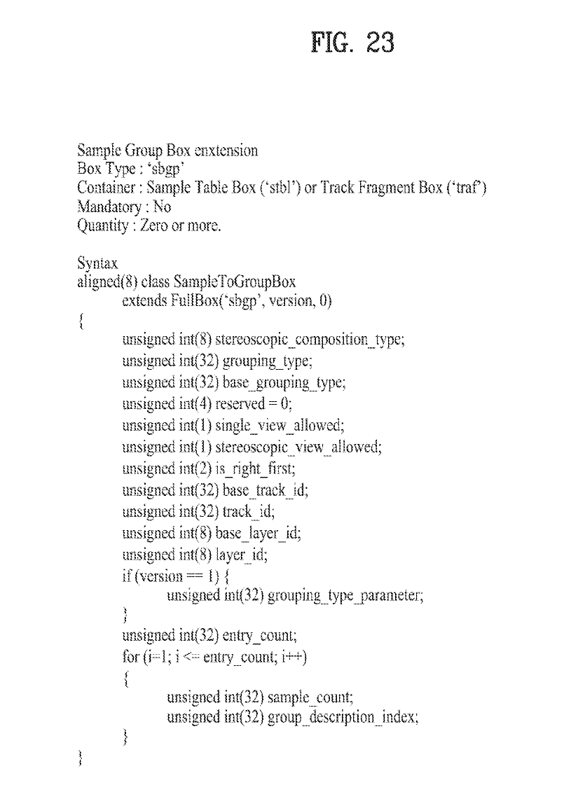

FIG. 23 is a diagram showing extension of a sample group (sbgp) box according to another embodiment of the present invention. When a plurality of layers is included in one track, one layer may include one sample group and, to this end, the sbgp box may be used. A box type may be sbgp and may be included in a sample table (stbl) box or a track fragment (traf) box. The sample table box (stbl) or the track fragment box (traf) may include one sbgp boxes or more and, in some embodiments, may not include sbgp. The sbgp may be used to search for a group including a corresponding sample and may be used to search for a related description of the sample group. The sbgp box may include at least one of the illustrated pieces of information. That is, the sbgp box may include at least one of stereoscopic_composition_type information, grouping_type information, base_grouping_type information, single_view_allowed information, stereoscopic_view_allowed information, is_right_first information, base_track_id information, track_id information, base_layer_id information, layer_id information, grouping_type_parameter information, entry_count information, sample_count information, and/or group_description_index information. The base_grouping_type information may refer to grouping_type as a base of a current grouping_type. When the grouping_type include one layer or more, the base_grouping_type information may indicate grouping_type including base_layer. The remaining information included in the sbgp box may be the same as information included in Hybird3DVideoMediaInformationBox when the aforementioned one track includes one layer.

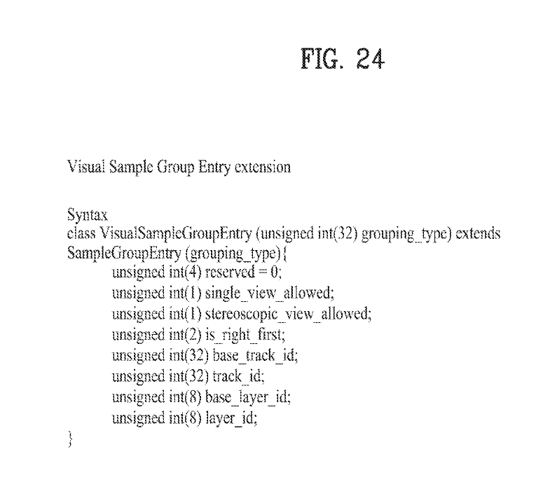

FIG. 24 is a diagram showing extension of a visual sample group entry according to an embodiment of the present invention. When a plurality of layers is included in one track, one layer may include one sample group. In addition, when the same 3D related parameter is applied to one or more samples present in one track or movie fragment, the illustrated information may be added to a visual sample group entry, etc. The visual sample group entry may include single_view_allowed information, stereoscopic_view_allowed information, is_right_first information, base_track_id information, track_id information, base_layer_id information, and/or layer_id information. The base_grouping_type information may refer to grouping_type as a base of a current grouping_type. When the grouping_type includes one or more layers, the base_grouping_type may indicate grouping_type including base_layer. The remaining information may have the same meaning as in a description of a field of Hybird3DVideoMediaInformationBox when one track includes one layer, as described above.

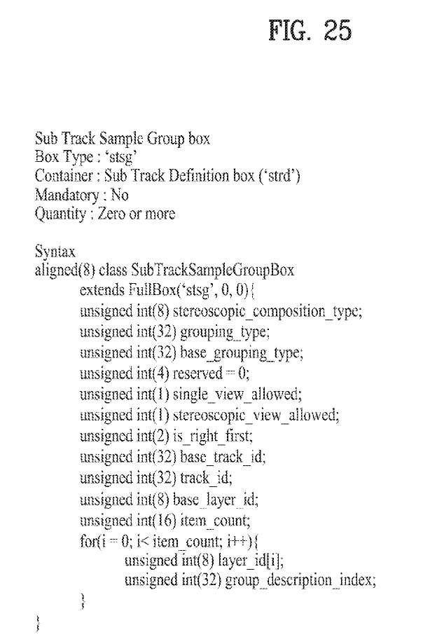

FIG. 25 is a diagram showing extension of a sub track sample group (stsg) box according to another embodiment of the present invention. A sub track may refer to one or more sample groups. When one track includes a plurality of layers, one layer may include one sample group. A sub track formed by collecting a plurality of sample groups may be configured to include one track or some samples of one track. To this end, the stsg box may be used. A box type may be stsg and may be included in a sub track definition (strd) box. The strd may include one stsg box or more and, in some embodiments, may not include stsg. The stsg may define a sub track as one or more sample groups and, to this end, may refer to a sample group description for describing samples of each group. The stsg box may include at least one of the illustrated pieces of information. That is, the stsg box may include at least one of stereoscopic_composition_type information, grouping_type information, base_grouping_type information, single_view_allowed information, stereoscopic_view_allowed information, is_right_first information, base_track_id information, track_id information, base_layer_id information, item_count information, layer_id information, and/or group_description_index information. The layer_id information may be included in equal number to the number of item_count pieces of information using a loop. The grouping_type information may be an integer value for identifying sample grouping. A corresponding value may have the same value as a corresponding SampletoGroup box and SampleGroupDescription boxes. The item_count information may refer to the number of sample groups listed in the stsg box. The remaining information included in the stsg box may have the same meaning as fields of Hybird3DVideoMediaInformationBox when one track includes one layer, as described above.

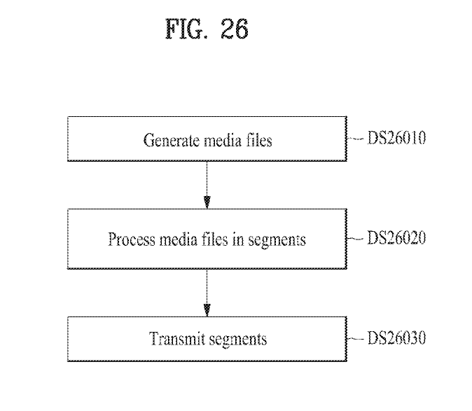

FIG. 26 is a diagram showing a method of transmitting a media file according to an embodiment of the present invention. The method of transmitting a media file according to an embodiment of the present invention may generate media files (DS26010). Here, the generated media files may be based on an ISO base media file format. As described with reference to FIGS. 15 to 25, media files may include a plurality of boxes. The boxes included in the media file may include a left image and a right image based on SHVC. A 3D media file based on SHVC may include 2D compatible 3D video data. In addition, the boxes included in the media file may further include information for describing SHVC-based 3D content. That is, the media file may include 3D media content data and metadata thereof. The metadata may include information for reproduction SHVC-based 3D content in 2D or 3D. As described above, the metadata may include at least one of stereoscopic_composition_type information, single_view_allowed information, stereoscopic_view_allowed information, is_right_first information, base_track_id information, track_id information, stereo_mono_change_count information, sample_count information, and/or stereo_flag information. A description of the information is the same as the above description and, in some embodiments, some of the corresponding information may not be included in the metadata according to the number of layers included in one track included in the media file. When media files are generated, the media files may be processed in segments (DS26020). For transmission, media files may be segmented in a separate segment format and, for example, a DASH segment may correspond thereto. An operation of processing the media files in segments may be omitted in some embodiments. When media files are processed in segments, the generated segments may be transmitted (DS26030). The generated segments may be broadcast through a sky radio wave or may be transmitted via a wired network using a broadband. The transmitted SHVC-based 3D contents may be displayed in 2D or 3D according to receiver performance. The receiver may restore the received segments to a media file and may reproduce the received content in 2D or 3D using the metadata included in the boxes in the media file.

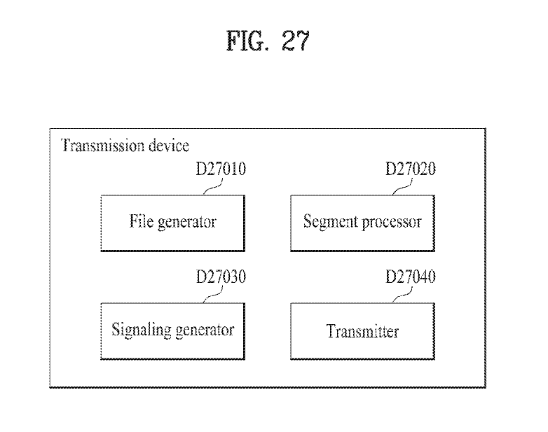

FIG. 27 is a diagram showing a media file transmission device according to an embodiment of the present invention. The media file transmission device according to an embodiment of the present invention may include a file generator D27010, a segment processor D27020, a signaling generator D27030, and a transmitter D27040. Each component may be implemented as one processor or a plurality of processors. Here, the file generator D27010 and the signaling generator D27030 may be implemented as one processor. The file generator D27010 may generate media files. Here, the generated media files may be based on an ISO base media file format. As described with reference to FIGS. 15 to 25, media files may include a plurality of boxes. The boxes included in the media file may include left image data and right image data based on SHVC. The SHVC-based 3D media file may include 2D-compatible 3D video data. The boxes included in the media file may further include information for describing SHVC-based 3D content. That is, the media file may include 3D media content data and metadata thereof. In some embodiments, the metadata may be generated by the file generator D27010 or the signaling generator D27030. The metadata may include information for reproducing the SHVC-based 3D content in 2D or 3D. As described above, the metadata may include at least one of stereoscopic_composition_type information, single_view_allowed information, stereoscopic_view_allowed information, is_right_first information, base_track_id information, track_id information, stereo_mono_change_count information, sample_count information, and/or stereo_flag information. A description of the information is the same as the above description and some of the corresponding information may not be included in the metadata according to the number of layers included in one track included in the media file, in some embodiments. When the media file is generated, the segment processor D27020 may process media files in segments. The media files may be segmented in a separate segment format to be transmitted and, for example, a DASH segment may correspond thereto. The segment processor D27020 may be omitted, in some embodiments. When the media files are processed in segments, the transmitter D27040 may transmit the generated segments. The generated segments may be broadcast through a sky radio wave or may be transmitted via a wired network using a broadband. The transmitted SHVC-based 3D contents may be displayed in 2D or 3D according to receiver performance. The receiver may restore the received segments to a media file and may reproduce the received content in 2D or 3D using the metadata included in the boxes in the media file.

As described above, the media file transmission device or the broadcast signal transmission device according to the present invention may generate a media file including SHVC-based 3D content data and the corresponding media file may be referenced when the receiver reproduces the 3D content data in 2D or 3D. Accordingly, the receiver that receives the media file may decode the received media file and reproduce the media file in 3D or 2D according to decoding capability.

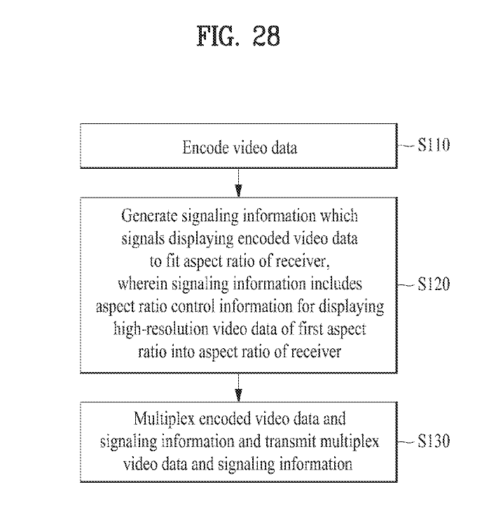

FIG. 28 illustrates a method for transmitting signals according to an exemplary embodiment of the present invention.

Video data are encoded (S110). In case of encoding the video data, according to the exemplary embodiment that will hereinafter be disclosed, encoding information of the video data may be included in the encoded video data.

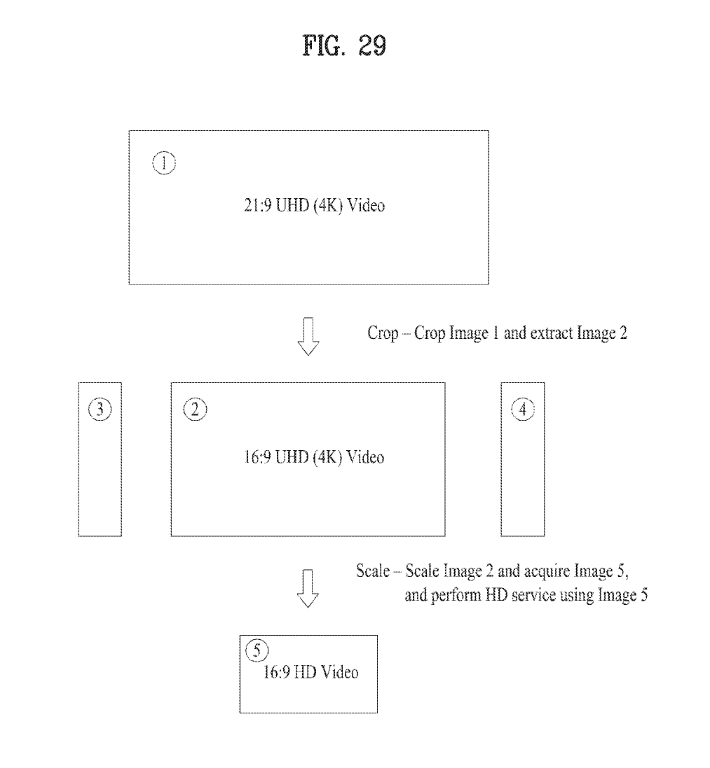

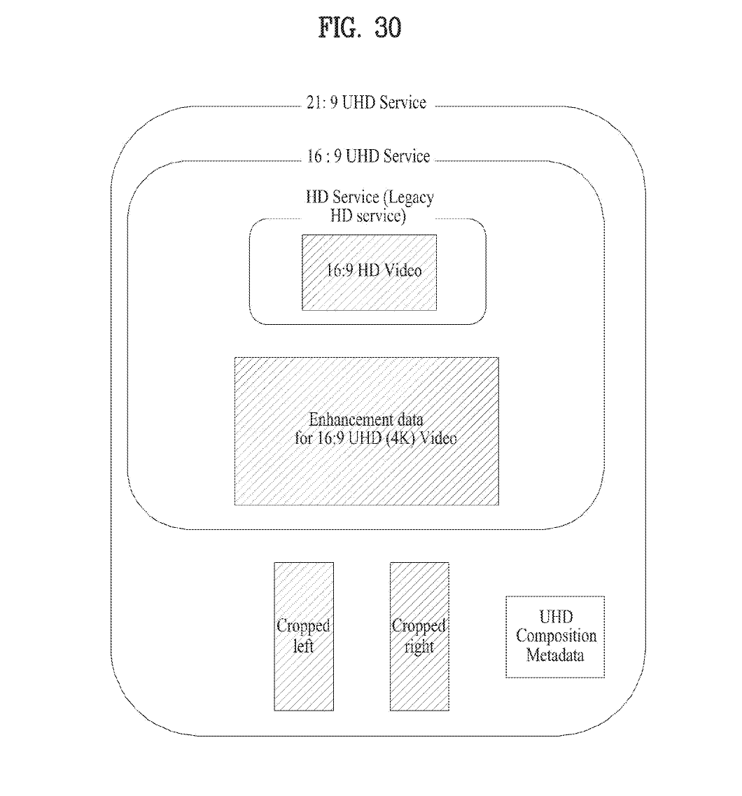

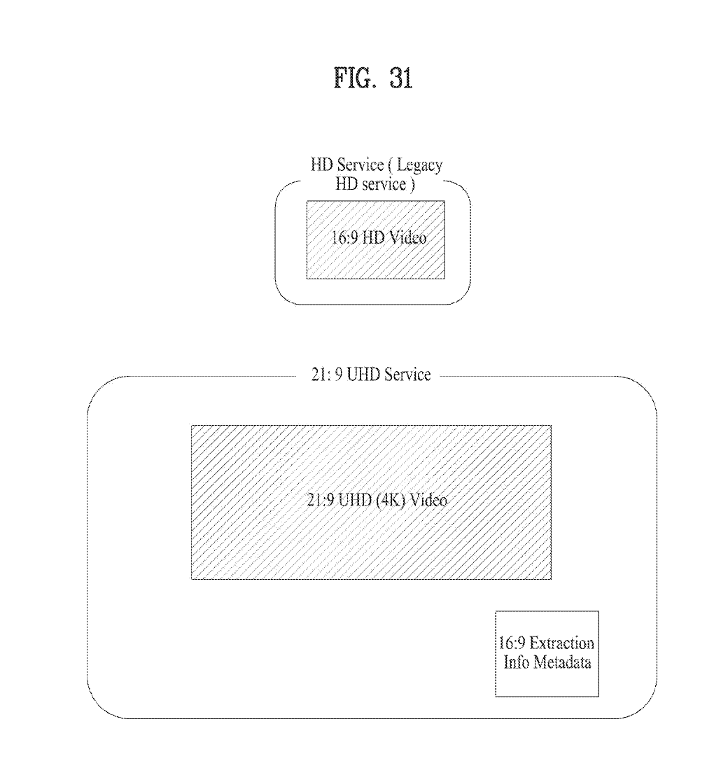

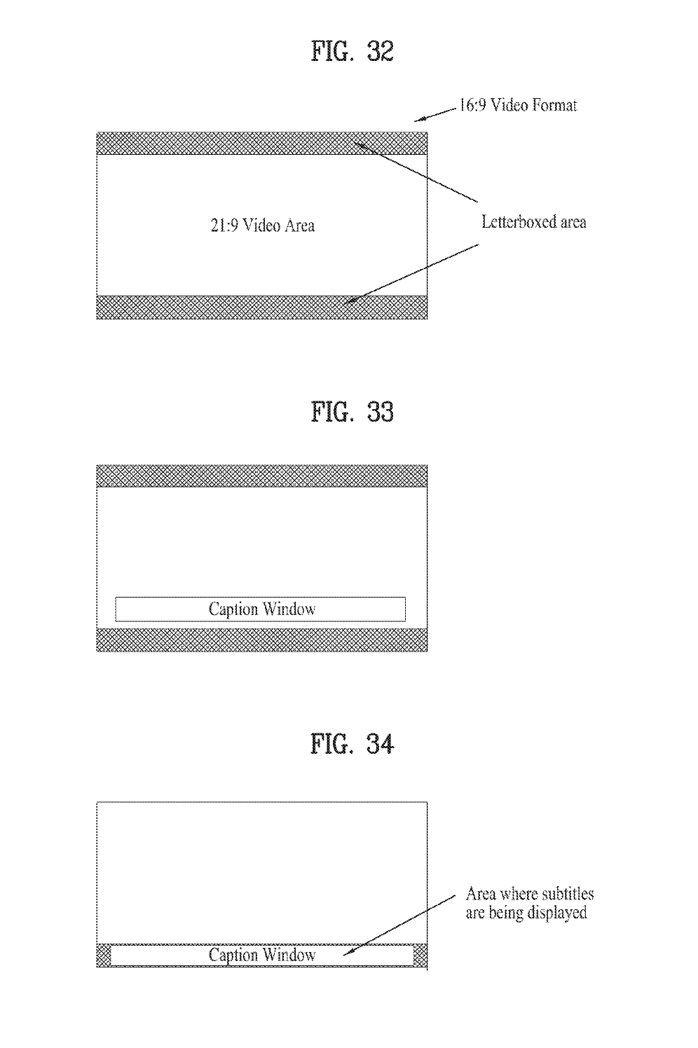

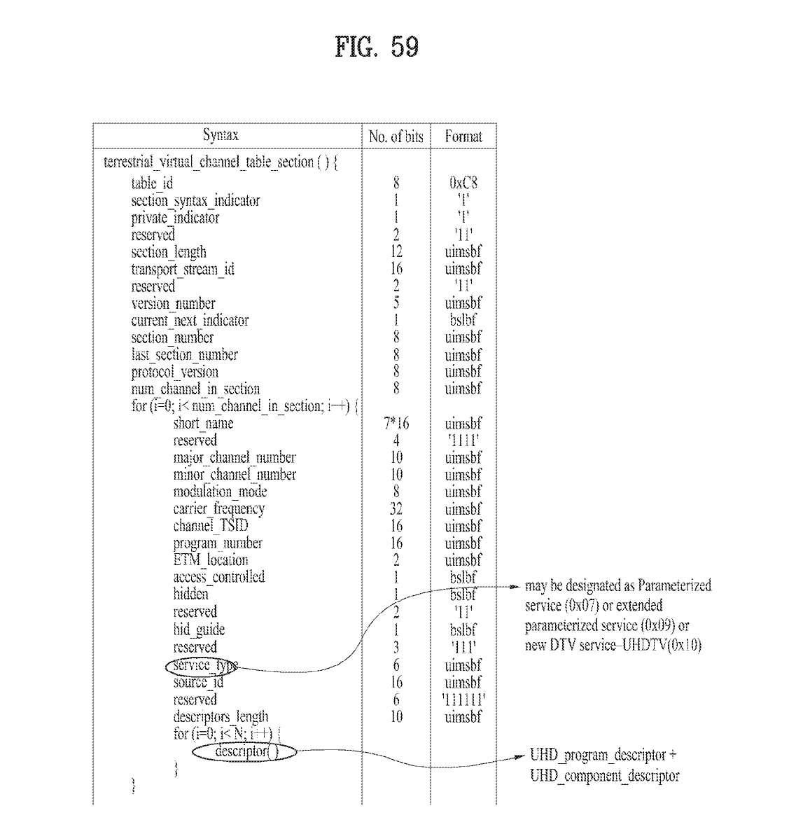

The encoding information that can be included in the encoded video data will be described in detail in FIG. 59. The encoded video data may have different structures depending upon the exemplary embodiments that will hereinafter be disclosed, and such exemplary embodiments may vary in accordance with FIGS. 29 and 30 (First embodiment). FIG. 31 (Second embodiment), and FIGS. 32 to 33 (Third embodiment).

For example, the encoded video data consists of a structure having high-resolution video divided to fit the conventional (or already-existing) aspect ratio and may include information, which allows the divided video data to be merged back to the high-resolution video. Alternatively, the encoded video data may include information allowing the high-resolution video data to be divided to fit the aspect ratio of the receiver or may also include position information of a letter for positioning subtitle information (e.g., AFD bar).

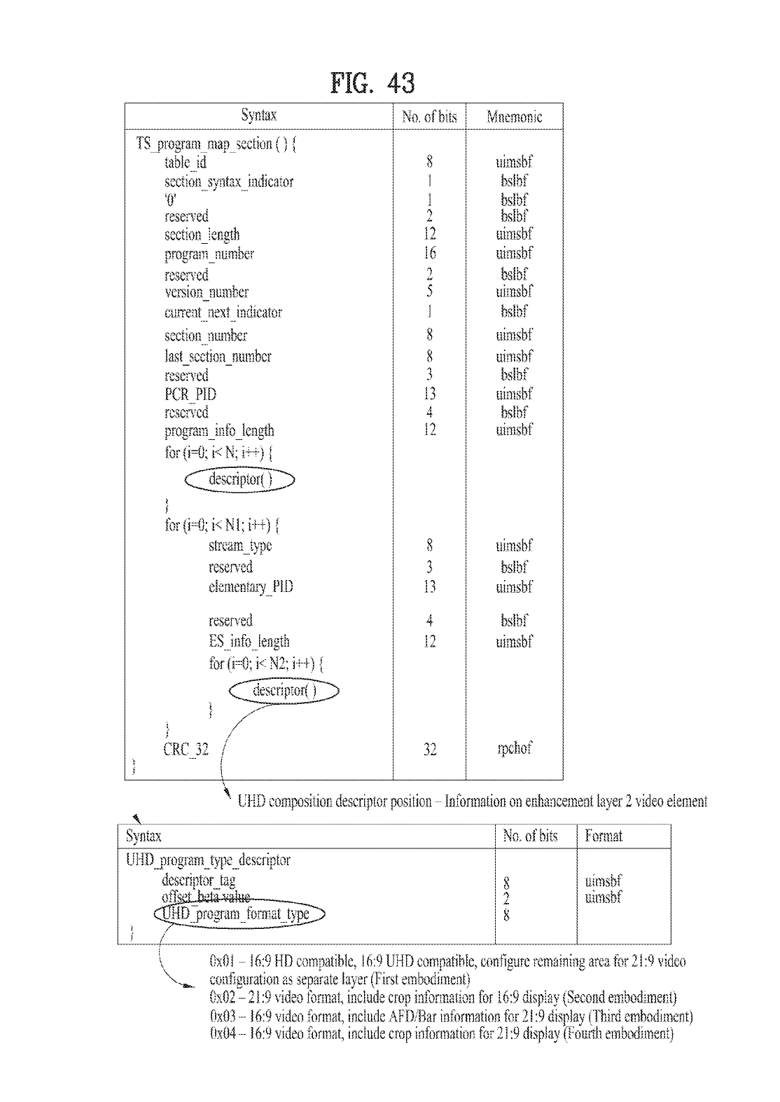

In case the transmitted signal corresponds to a broadcast signal, signaling information that signals displaying the video data to fit the aspect ratio of the receiver, which is provided separately from the encoded video data, is generated (S120). An example of the signaling information may include diverse information, which is given as examples in FIGS. 43 to 54 and FIGS. 56 to 58 according to the respective exemplary embodiment, and, herein, the diverse information, which is given as examples in the drawings mentioned above according to the respective exemplary embodiment, may be generated. The signaling information may include signaling information that signals displaying high-resolution video data having a first aspect ratio on the receiver regardless of the aspect ratio. For example, the signaling information that signals displaying high-resolution video data on the receiver regardless of the aspect ratio may include aspect ratio control information of the high-resolution video data. Examples of the signaling information that is provided separately from the video data are given in FIGS. 43 to 54 and FIGS. 56 to 59.

The encoded video data and the signaling information are multiplexed and the multiplexed video data and signaling information are transmitted (S130).

In case the transmitted data do not correspond to the broadcast signal, generating the signaling information, which is multiplexed with the video data, may be omitted, and video data including aspect ratio control information within the video data section, which is described in step S110, are multiplexed with other data (e.g., audio data) and then outputted.

In case the transmitter transmits the video data in accordance with each exemplary embodiment, even in case there are several types of aspect ratios in the receiver display apparatus, or even in case there are several types of performed, the high-resolution video may be displayed in accordance with the aspect ratio of each corresponding display, or the subtitles may be displayed. Additionally, even in case of the legacy receiver, the high-resolution video data may be displayed in accordance with the aspect ratio of the corresponding receiver. More specifically, the receiver may change the high-resolution video data having the first aspect ratio in accordance with the aspect ratio of the receiver by using screen control information and may then be capable of displaying the changed data.

According to the first exemplary embodiment, the aspect ratio control information may include merging information indicating that the encoded video data are transmitted after being divided and merging the divided video data. According to the second and fourth exemplary embodiments, the aspect ratio control information may include division information that can divide the encoded video data to best fir the aspect ratio. In addition, according to the third exemplary embodiment, the aspect ratio control information may include position information for subtitle positioning, which allows subtitle positions of the video to be changed in accordance with the resolution of the video respective to the encoded video data.

FIG. 29 illustrates a general view of an example of transmitting a high resolution image to fit aspect ratios of receivers according to an exemplary embodiment of the present invention. This example shows an exemplary embodiment of servicing an aspect ratio of 16:9 by using a UHD video having an aspect ratio of 21:9.

21:9 UHD source video (Video (1)) is divided to a 16:9 UHD source video (Video (2)) and left/right cropped video (Video (3) and Video (4)). By performing cropping procedures and so on of the video, a video may be divided into 3 videos.

More specifically, Video (1) is divided to Video (2), Video (3), and Video (4) and then transmitted.

A receiving apparatus that can display UHD video may receive and display Video (2), Video (3), and Video (4).

Additionally, a receiving apparatus that can display HD video may receive Video (2) and may convert the UHD video (Video (2)) of 16:9 to a 16:9 HD video (Video (5)) and may then display the converted video.

FIG. 30 illustrates a general view of an exemplary stream structure transmitting the high resolution image to fit aspect ratios of receivers according to the exemplary embodiment of the present invention of FIG. 29.

The exemplary stream includes 16:9 UHD video, data being cropped both on the left side and the right side, and supplemental data (UHD composition metadata). The 16:9 UHD video may include HD video having an aspect ratio of 16:9, which can provide the related art HD service, and enhancement data, which correspond to a difference between the 16:9 UHD video and the HD video having the aspect ratio of 16:9.

A legacy HD receiver receives and processes the HD video having the aspect ratio of 16:9, and a 16:9 UHD receiver receives and processes enhancement data for the HD video having the aspect ratio of 16:9 and the UHD video having the aspect ratio of 16:9. Additionally, a 21:9 receiver may configure a 21:9 UHD video by using the UHD video having the aspect ratio of 16:9, the cropped left and right data, and the UHD composition metadata, which correspond to supplemental data. The supplemental data (UHD composition metadata) may include left and right crop (or cropping) coordinates information. Therefore, the receiver may use the supplemental data, so as to generate the UHD video having the aspect ratio of 21:9 by using the UHD video having the aspect ratio of 16:9 and the data being cropped both on the left side and the right side.

Therefore, according to the exemplary embodiment of this drawing, 3 scalable services may be provided.

FIG. 31 illustrates a general view of another example of transmitting a high resolution image to fit aspect ratios of receivers according to an exemplary embodiment of the present invention. In this example, the UHD video having the aspect ratio of 21:9 may be transmitted through a stream that is separate from the HD video having the aspect ratio of 16:9.

Since the HD video of 16:9 is not backward compatible with the UHD video having the aspect ratio of 21:9, the transmitter prepares a UHD video stream, which is separate from the HD video stream. In the UHD video stream, crop coordinates information, which can generate the aspect ratio of a 16:9 video, may be included in supplemental information data (16:9 extraction info metadata) and may then be transmitted.

Therefore, the UHD video receiver receives a UHD video stream having the aspect ratio of 21:9. In addition, if the UHD video receiver includes a display apparatus having the aspect ratio of 21:9, the UHD video receiver may extract a UHD video from a stream providing the 21:9 UHD service. In this case, the supplemental information data (16:9 extraction info metadata) may be disregarded (or ignored).

Moreover, if the UHD video receiver includes a display apparatus having the aspect ratio of 16:9, the UHD video receiver may extract a video having the aspect ratio of 16:9 from the UHD video stream by using the supplemental information data and may then provide a respective service.

A HD receiver of the related art may provide a HD video by receiving a HD video stream having an aspect ratio of 16:9.

FIG. 32 illustrates a general view of a method for transceiving signals according to another exemplary embodiment of the present invention.

For example, a video having an aspect ratio of 21:9 is transmitted, yet the video is transmitted as a video having an aspect ratio of 16:9 after scaling the corresponding video format, and yet the corresponding video may be transmitted after including a letterbox area on an upper portion and lower portion within the video having the aspect ratio of 16:9.

FIG. 33 illustrates an exemplary output of a subtitle area, when transmission is performed as shown in FIG. 32. A legacy HD video receiver displays a caption window for the subtitle area in a display screen section instead of the letterbox section.

FIG. 34 illustrates an example of displaying a caption window for subtitles in a receiver that can receive UHD video, when transmission is performed as shown in FIG. 32. In case subtitles are included in a stream that transmits UHD video, the already-existing video is outputted starting from an upper left portion (0,0), and the subtitles are displayed on the letterbox area (lower area, surplus area of the display screen) corresponding to outer portions of an actual video areas, so that subtitles can be displayed on an empty portion of the display screen, thereby minimizing interference of the subtitles with the video area and allowing the screen to be used efficiently.

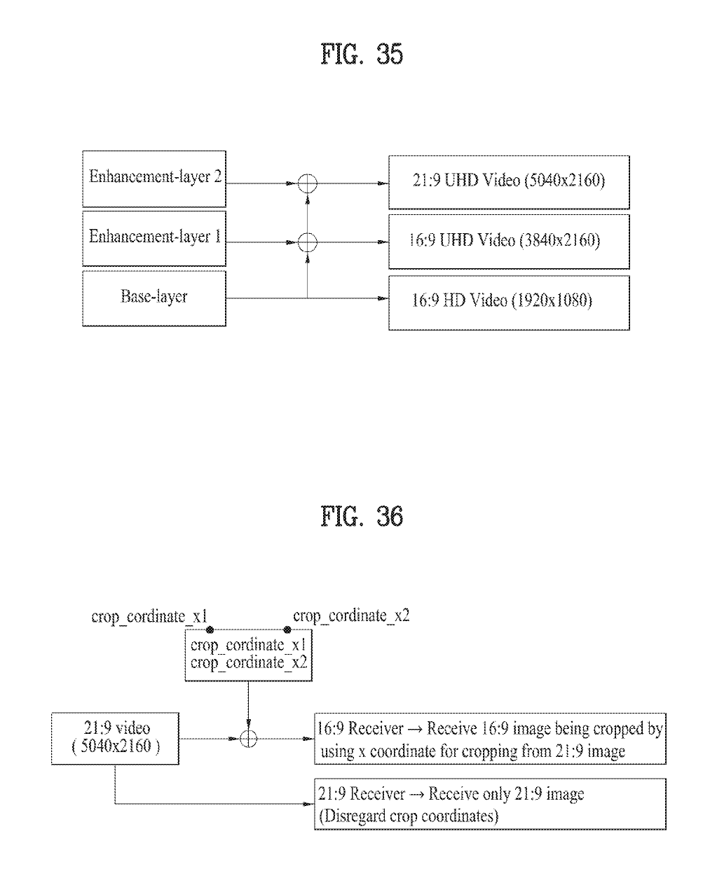

FIG. 35 illustrates an exemplary method for encoding or decoding video data in case of transmitting video data according to a first exemplary embodiment of the present invention.

The transmitter encodes the 16:9 HD video to base layer data, and the transmitter encodes residual data, which configure the 16:9 UHD based upon the data encoded from the base layer data, to enhancement layer 1 data. Additionally, the transmitter encodes the remaining UHD video, which corresponds to 2.5:9 video corresponding to the remaining cropped data respective to the left side and the right side, to enhancement layer 2 data.

The video data being encoded to enhancement layer 2 may be encoded from the overall UHD video having the aspect ratio 21:9 by using correlation and may be encoded as an independent video. Additionally, as described in the first exemplary embodiment, information related to the left/right positions of the data cropped from the left side and the right side may be transmitted.

The information related to the left/right positions of the video data being encoded to enhancement layer2 may be transmitted by using exemplary embodiments, such as a header within a video stream corresponding to enhancement layer2 or a descriptor format of section data of a section level. This will be described later on in more detail.

When the receiver receives only the base layer data and decodes the received data, the receiver may display a 16:9 HD video (1920×1080).

When the receiver decodes the base layer data and the enhancement layer 1 data, the receiver may display a 16:9 UHD video (3840×2160).

And, when the receiver decodes all of the base layer data, the enhancement layer 1 data, and the enhancement layer 2 data, the receiver may display a 21:9 UHD video (5040×2160). In this case, the above-described information related to the left/right positions of the video data, which are encoded to enhancement layer2, may be used.

Therefore, depending upon the performance or function of the receiver, videos having diverse resolution respective to diverse aspect ratios may be displayed. This example corresponds to an example of transmitting a 4K video by dividing the corresponding 4K video to multiple videos, and videos respective to higher resolution may also be transmitted by using the above-described method.

FIG. 36 illustrates an exemplary method for encoding or decoding video data in case of transmitting video data according to a second exemplary embodiment of the present invention.

If, for example, the transmitter divides (or separates or crops) the 16:9 UHD video from the 4K (5040×2160) UHD video, the transmitter may transmit division (or separation or crop) start information of the 16:9 video along with division (or separation or crop) end information. For example, the transmitter transmits crop_cordinate_x1 information corresponding to starting coordinates within the screen along with crop_cordinate_x2 information of ending coordinates. Herein, the crop_cordinate_x1 information indicates starting coordinates of the 16:9 UHD video and the crop_cordinate_x2 information indicates ending coordinates of the 16:9 UHD video.

The receiver receives the 4K (5040×2160) UHD video, and, then, the receiver may disregard the division start information and the division end information and may directly display the 4K (5040×2160) UHD video.

The receiver receives the 4K (5040×2160) UHD video, and, then, the receiver may cut out (or crop) a 16:9 UHD video from the 21:9 UHD video by using the division start information and the division end information and display the cropped video.

According to the second exemplary embodiment, since the 16:9 HD video is transmitted through a separate stream, the receiver may receive and display the 16:9 HD video stream separately from the 4K (5040×2160) UHD video stream.

Therefore, depending upon the performance or function of the receiver, videos having diverse resolution respective to diverse aspect ratios may be displayed. Similarly, this example corresponds to an example of transmitting a 4K video by dividing the corresponding 4K video to multiple videos, and videos respective to higher resolution may also be encoded or decoded by using the above-described method.

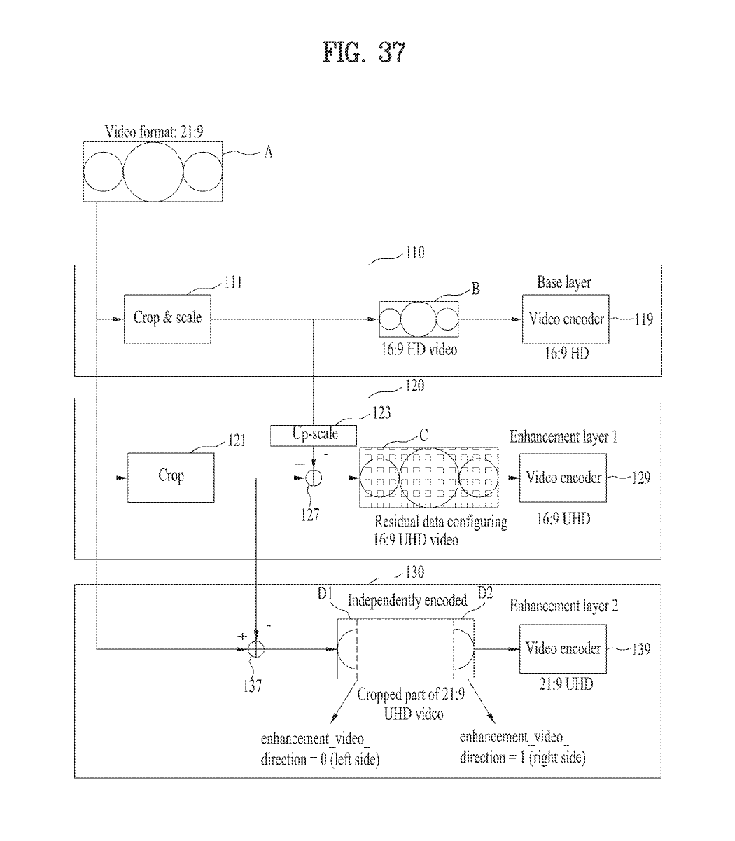

FIG. 37 illustrates an example of an encoder encoding high-resolution video data according to a first exemplary embodiment of the present invention. Herein, 21:9 UHD video data of 4K is given as an example of the high-resolution video data. In this drawing, the data related to the video are respectively indicated as A, B, C, D1, and D2.

An exemplary encoder encoding high-resolution video data may include a base layer encoder 110, a first Enhancement layer data encoder 120, and a second Enhancement layer data encoder 130.

For example, as an exemplary encoder, the encoder encoding a UHD video having an aspect ratio of 21:9 may respectively process and encode base layer data, Enhancement layer 1 data, and Enhancement layer 2 data.

A crop and scale unit 111 of the base layer encoder 110 crops the 21:9 UHD video data (A) to 16:9 and reduces its size by performing scaling, thereby outputting the data s 16:9 HD video data (B). A first encoding unit 119 may encode the 16:9 HD video data as the base layer data and may output the coded data.

A crop unit 121 of the first Enhancement layer data encoder 120 crops the 21:9 UHD video data (A) to 16:9. An up-scaler 123 up-scales the down-scaled data, which are outputted from the crop and scale unit 111 of the base layer encoder 110 and outputs the up-scaled data, and a first calculation unit 127 may output residual data (C) of the 16:9 UHD video by using the data cropped by the crop unit 121 and the data up-scaled by the up-scaler 123. A second encoding 129 may encode the 16:9 UHD video as the Enhancement later 1 data and may output the coded data.

A second calculation unit 137 of the second Enhancement layer data encoder 130 may respectively output left side video data (D1) and right side video data (D2), which respectively correspond to cropped data of the 16:9 video data and the cropped data of 21:9 video data by using the 21:9 UHD video data (A) and the data cropped by the crop unit 121.

Each of the left side video data (D1) and the right side video data (D2) may be respectively identified as information on the left side of the corresponding video and information on the right side of the corresponding video. An example of signaling this information will be described later on. Herein, in this example, the identification information (enhancement_video_direction) of the left side video is given as 0, and the identification information (enhancement_video_direction) of the right side video is given as 1.

When the left side video data (D1) and the right side video data (D2) are transmitted as a single stream, the receiver may perform decoding by using the signaling information. In this case, each of the left side video data (D1) and the right side video data (D2) may be respectively coded or the data may be coded as a single set of video data.

Accordingly, in case of transmitting the left side video data (D1) and the right side video data (D2) through two video streams or through a single stream, signaling may be performed so that the data can be divided (or separated) by using each of the identification information.

A third coding unit 130 may encode the cropped left side video data (D1) and right side video data (D2) as the Enhancement layer 2 data.

Accordingly, when each of the base layer data, the Enhancement layer 1 data, the Enhancement layer 2 data are received, UHD video or HD video data may be recovered.

In case the receiver recovers the Enhancement layer 2 data, decoding may be performed by using a decoding method that is related to each of the base layer data and the Enhancement layer 1 data, or the decoding may be performed independently. Such decoding method may be decided in accordance with the coding method.

FIG. 38 illustrates an example of original video, which is separated according to the first exemplary embodiment of the present invention, an exemplary resolution of the separated video.

An example (a) corresponding to the upper left portion represents the resolution of a UHD video having a resolution of 5040×2160 of an aspect ratio of 21:9.

A 4K UHD video having an aspect ratio of 21:9 has a resolution of 5040×2160. Herein, the video corresponding to 16:9 may signify a video having a resolution of 3840×2160, which is referred to as 4K UHD of 16:9 in the conventional broadcasting.

An example (b) corresponding to the upper right portion illustrates an exemplary video having a resolution of 3480×2160 within a UHD video having a resolution of 5040×2160 of an aspect ratio of 21:9.

In an example (c) corresponding to the lower center portion, the video having a resolution of 3840×2160 corresponds to the enhancement layer 1 data, and in case of combining the video having a resolution of 600×2160 of the left side and the right side as a single video, the combined video corresponding to a video having a resolution of 1200×2160 includes the enhancement layer 1 data. At this point, at the video level, signaling is required to be performed on the resolution of surplus data, and signaling on left/right information may also be performed so as to indicate a direction of the video.

In this example, the identification information (enhancement_video_direction) of the left side video is given as 0, and the identification information (enhancement_video_direction) of the right side video is given as 1.

Furthermore, the remaining video that is to be included in the enhancement layer 2 will not be limited only to the edge areas on the left/right sides, and, as a remaining section corresponding to an area excluding an arbitrary 16:9 video from the 21:9 video, the respective position may be arbitrarily designated. For example, an exemplary embodiment, wherein the 16:9 video that is to be extracted from the 21:9 video is set as the left side area, and wherein the enhancement layer 2 is configured of the remaining 5:9 video on the right side area. Additionally, the resolution may also be different from one another. For example, in addition to 4K, the video may also be divided (or separated) as described above within respect to a 8K UHD video and may be transmitted accordingly.

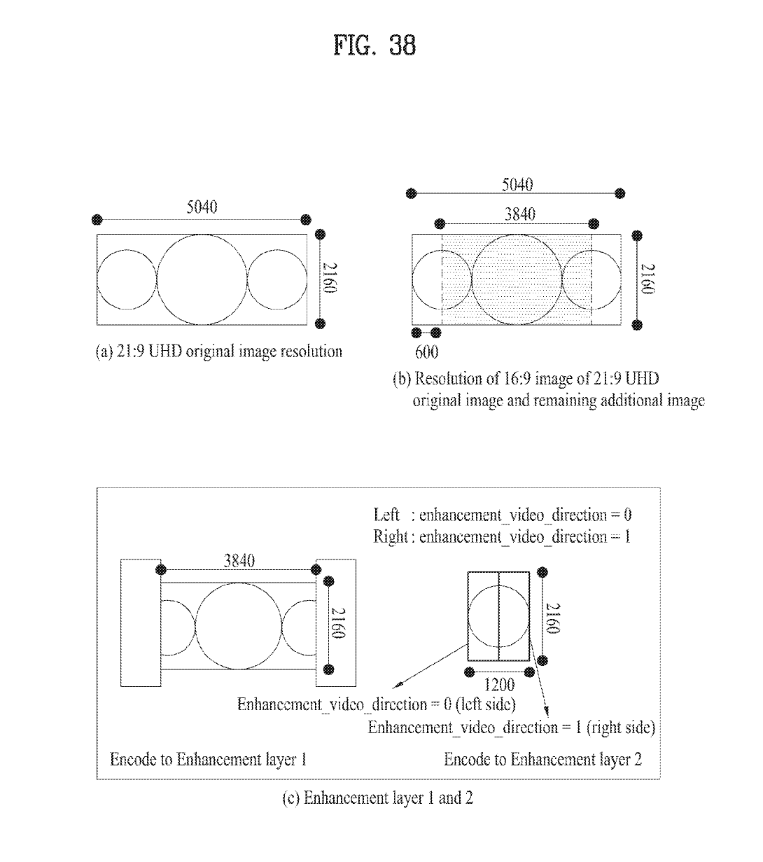

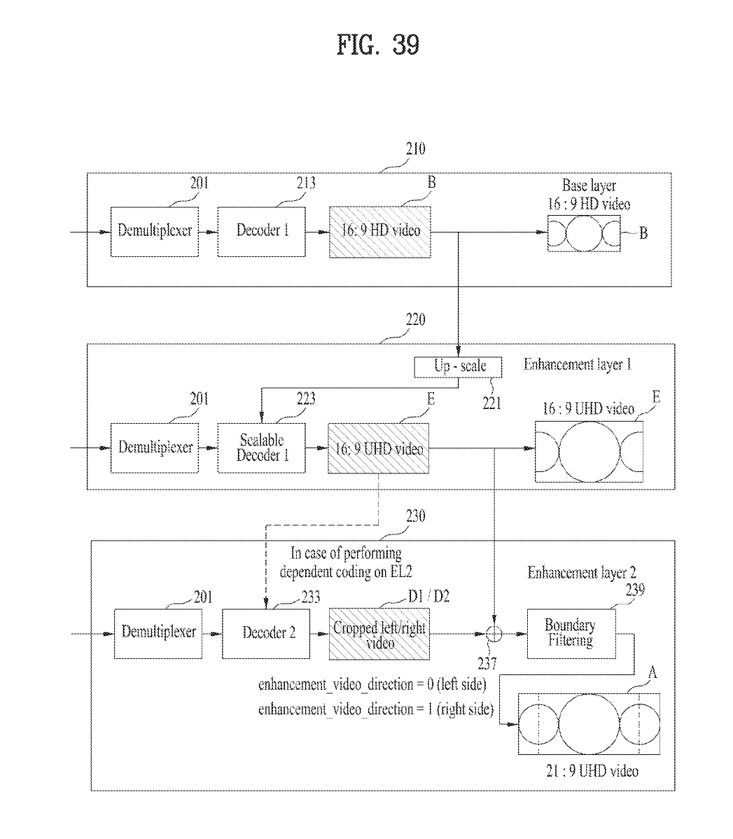

FIG. 39 illustrates an example of a decoder decoding high-resolution video data according to a first exemplary embodiment of the present invention. Herein, 21:9 UHD video data of 4K will be given as an example of the high-resolution video data for simplicity in the description. In this drawing, the data related to the video will be respectively indicated as A, B, D1, D2, and E.

An exemplary decoder decoding high-resolution video data may include at least one of a base layer decoder 210, a first Enhancement layer data decoder 220, and a second Enhancement layer data decoder 230. Depending upon the function of the signal receiving apparatus, decoders having 3 functions may all be included, and a decider of the signal receiving apparatus outputting the already-existing HD video may include only the base layer decoder 210. In this example, a demultiplexer 201 may be shared by each of the decoders, or a separate demultiplexer 201 may be included in each of the decoders.

For example, a decoder decoding the UHD video having the aspect ratio of 21:9 may process and decode each of the base layer data, the Enhancement layer 1 data, and the Enhancement layer 2 data.

A first decoder 213 of the base layer decoder 210 may decode the demultiplexed HD video (B) having the aspect ratio of 16:9 and may output the decoded video.

An up-scaler 221 of the first Enhancement layer data decoder 220 up-scales the base layer data, which are decoded by the base layer decoder 210, and outputs the up-scaled data.

A second decoder 223 may perform scalable decoding by using the base layer data and residual data.

The second decoder 223 decodes the demultiplexed residual data of 16:9, and the second decoder 223 may recover the UHD video (E) having the aspect ratio of 16:9 by using the up-scaled base layer data and the decoded residual data of 16:9.

Meanwhile, a third decoder 233 of the second Enhancement layer data decoder 230 decodes the left side/right side video, and the third decoder 233 merges the outputted UHD video (E) of 16:9 and the decoded left side/right side video (D1/D2) by using the Enhancement layer 1 data, which are decoded by the first Enhancement layer data decoder 220, and may then recover the 21:9 UHD video (A).

In this case, the second Enhancement layer data decoder 230 may use identification information for identifying the left side/right side video, and boundary filtering may be performed, so that the 21:9 UHD video (A) can be continuously and naturally displayed at a portion where the left side/right side video are being merged. In this case, the cropped video corresponding to the cropped left side/right side video undergoes a filtering process for being merged with the 16:9 video.

Herein, although the filtering process may be similar to deblocking filtering, which is used in the conventional (or legacy) codec, instead of being applied to all boundaries of the macro block, the filtering process is applied to the surroundings of the cropped video. Just as the conventional deblocking filter, in order to differentiate the boundary, which is generated by merging (or connecting) the actual edge and the cropped portion, filtering may be performed in accordance with a threshold value. This will be described later on.

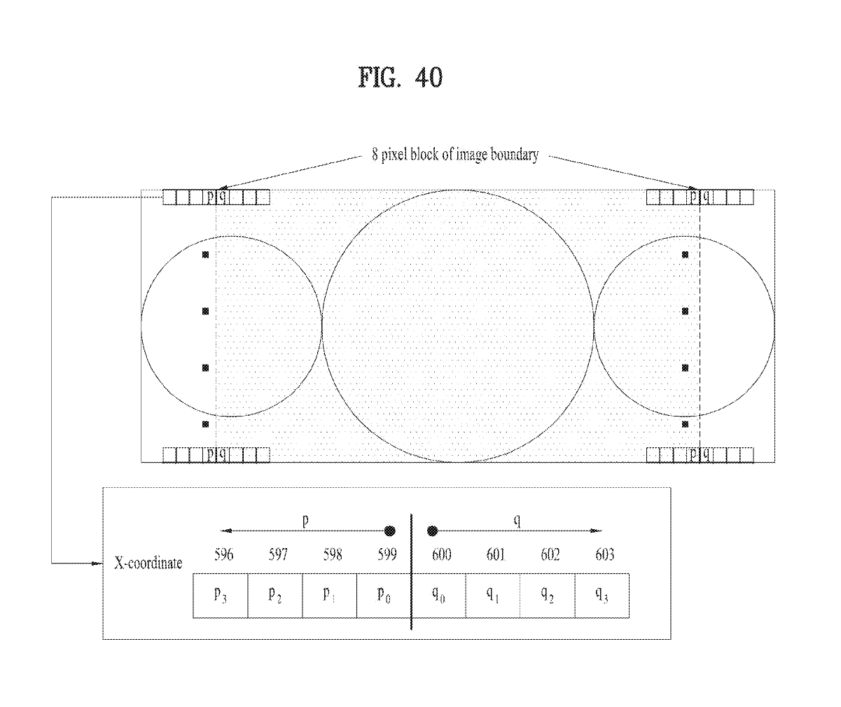

FIG. 40 illustrates an example of merging and filtering cropped videos of the first exemplary embodiment of the present invention. Herein, an example of removing (or eliminating) a blocking artifact from the boundary of the base layer video, the enhancement layer 1 video, and the enhancement layer 2 video will be described.

In this drawing, for example, among the cropped videos with respect to a merged surface, if a left side video and a right side video are separated (or divided or cropped) and encoded, since a blockage artifact occurs at a stitched portion, blurring is performed at the corresponding boundary area. Filtering may be performed in order to differentiate the boundary, which is generated due to cropping, from the edge of the actual video. A method for performing filtering consists of decoding the left and right side videos each having a size of 600×2160 and then merging the decoded video with the 16:9 UHD video, so as to re-configure a video of 21:9, and then performing filtering by using an arbitrary number of pixels along left-and-right horizontal directions. This drawing corresponds to an example of applying filtering respective to 8 pixels along the left-and-right horizontal directions, wherein coordinates information of the stitched portion can be used.

In this drawing, addresses of pixels included in one field are respectively marked as Pi and qi at the merged portion of the first video and the second video, wherein i is assigned with an integer value starting from 0 in accordance with the x-coordinate. An increasing direction of I may vary at the merged portion of the first video and the second video. It will be assumed that an address of pixels along the x-axis of the merged portion corresponds to 596, 597, 598, 599 (pixels with the first video), 600, 601, 602, and 603 (pixel with the second video).

In order to acquire a condition for satisfying Condition 1, which is shown in Equation 1, values P0, P1, P2 . . . satisfying Equation 2 to Equation 4 are updated to values P0′, P1′, P2′ by using a 4-tap filter and a 5-tap filter.

Equation 1 represents Condition 1.

(Abs(P₂−p₀)<b) & (Abs(p₀−p₀)<b)&Abs(p₀−q₀)<((a>>2)+2)) Equation 1

p′₀=(p₂+2*p₁+2*p₀+2*q₀+q₁+4)>>3 Equation 2

p′₁=(p₂+p₁+p₀+q₀+2)>>2 Equation 3

p′₂=(2*p₃+3*p₂+p₁+p₀+q₀+4)>>3 Equation 4

Herein, each of the actual edge and blocking artifact may be differentiated from one another by using Condition 1, which is related to Equation 2 to Equation 4, and Condition 2, which is related to Equation 6.

In case Condition 1 of Equation 1 is not satisfied, as described above, the values of P0 and q0 are updated to values of P0′ and q0′ by using a 3-tap filter, as shown in Equation 5.

p′₀=(2*p₁+p₀+q₁+2)>>2 Equation 5

Condition 2 of Equation 6 corresponds to a condition for filtering a q block, and, in case this condition is satisfied, as shown in Equation 7 to Equation 9, q0, q1, and q2 are updated to values of q0′, q1′, and q2′ by using a 4-tap filter and a 5-tap filter.

Equation 6 represents Condition 2.

(Abs(q₂−q₀)<b)&(Abs(p₀−q₀)<((a>>2)+2)) Equation 6

q′₀=(q₂+2*q₁+2*q₀+2*q₀+p₁+4)>>3 Equation 7

q′₁=(q₂+q₁+q₀+p₀+2)>>2 Equation 8

q′₂=(2*q₃+3*q₂+q₁+q₀+q₀+4)>>3 Equation 9

In case Condition 2 is not satisfied, the value of q0 is updated to a value of q0′ by using Equation 10.

q′₀=(2*q₁+q₀+p₁+2)>>2 Equation 10

α (offset_alpha_value) and β (offset_beta_value) of Conditions 1 and 2 may adjust intensity of the filter by using an offset respective to a QP (quantization parameter). By adjusting the filter intensity by using the offset respective to a QP (quantization parameter), and, accordingly, by adequately allocating an offset of a smoothing filter accordingly, details of the video may be adjusted.

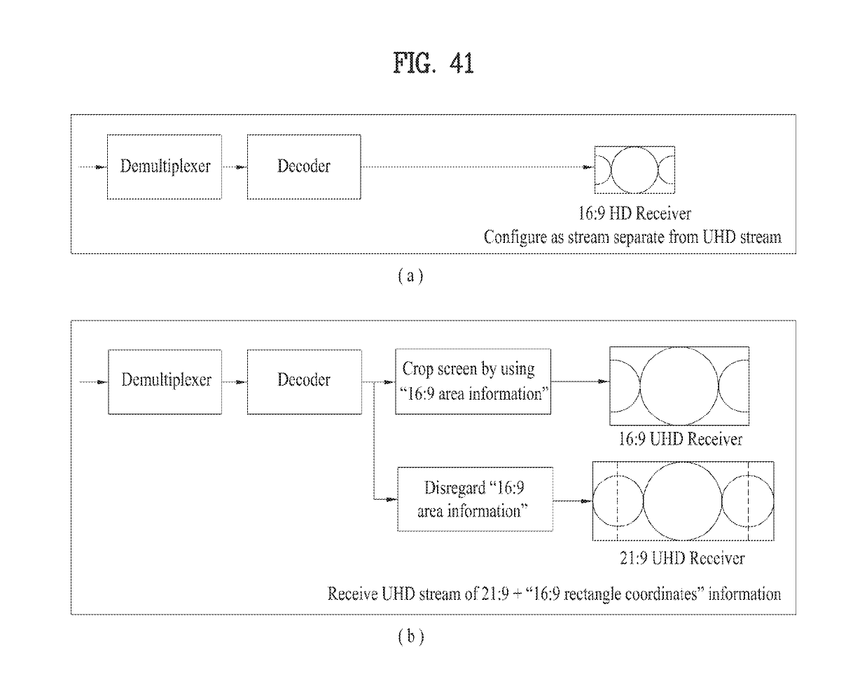

FIG. 41 illustrates a first example of a receiver according to a second exemplary embodiment of the present invention.

According to the second exemplary embodiment of the present invention, a stream of a HD video and a stream of a UHD video may be transmitted through separate streams.

Therefore, a receiver (a) that can display HD video may include a demultiplexer and a decoder, wherein the demultiplexer demultiplexes the HD video stream, and wherein the decoder decodes the corresponding video data, so that a 16:9 HD video can be displayed.

Meanwhile, a receiver (b) that can display UHD video may also include a demultiplexer and a decoder. In this case, the demultiplexer demultiplexes the UHD video stream, and the decoder decodes the corresponding video data, so that a UHD video can be displayed.

At this point, depending upon the performance of the receiver, the UHD video may correspond to a 16:9 UHD video corresponding to a cropped video of a portion of the video or may correspond to a 21:9 UHD video that has not been cropped. As described above in the second exemplary embodiment, depending upon its performance, the receiver may display a decoded UHD video, and, in case of the UHD video having an aspect ratio of 16:9, after cropping the video by using cropping position information (indicated as 16:9 rectangle coordinates) of the original 21:9 UHD video, the cropped video may be displayed. Herein, although description is made by giving the 4K UHD video as an example, the above-described method may be identically applied even if the resolution of the video becomes higher.

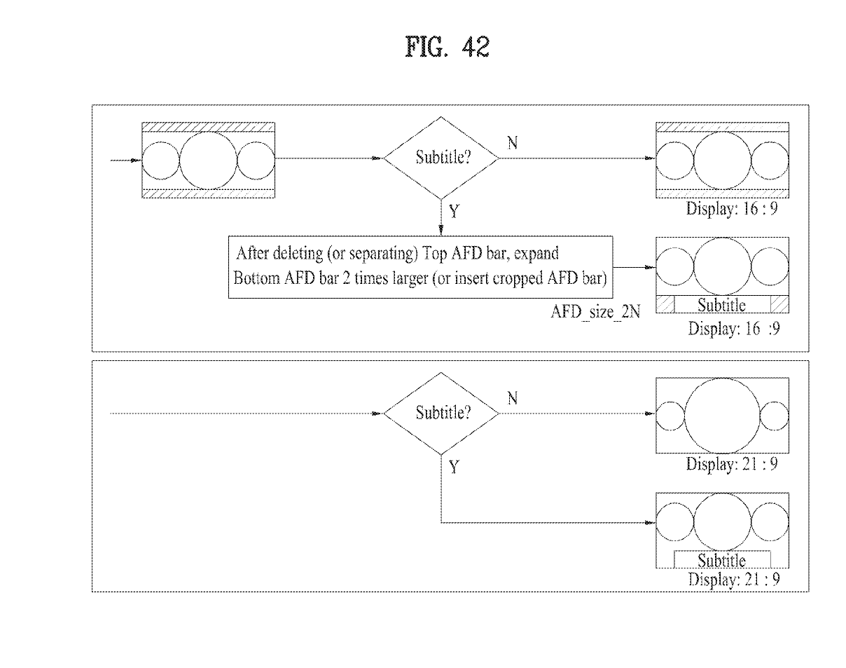

FIG. 42 illustrates exemplary operations of a receiver according to a third exemplary embodiment of the present invention. According to the third exemplary embodiment of the present invention, a UHD video having the aspect ratio of 21:9 is transmitted in a format having a scaled video having an aspect ratio of 16:9 and having a letterbox positioned on upper and lower portions of the video inserted therein. In case of a video having subtitle information displayed, depending upon the performance of the receiver, the subtitle information may be displayed on the 16:9 video or may be displayed on the letterbox.

In this drawing, video (A) shows an example of a 16:9 video being transmitted according to the above-described third exemplary embodiment and a letterbox being displayed on the corresponding video. Depending upon the performance of the receiver, the method for processing this video may vary.

First of all, in case subtitle information (subtitle) for the video does not exist in the receiver including a display having an aspect ratio of 16:9, the receiver may directly display the 16:9 video and the letterbox. Conversely, in case subtitle information for the transmitted video is included, this receiver may delete or separate (or divide) the top letterbox (Top AFD bar) and may expand the bottom letterbox (bottom AFD (Active Format Description) bar) to twice its initial size or may paste (or attach) the top letterbox to the bottom letterbox, so that the video format can be converted to a letterbox (AFD_size_2N) having a size that is two times its initial size and then displayed.

More specifically, when a UHD video of 5040×2160 is given as an example, the receiver inserts a letterbox (AFD bar) each having the size of 3840×N×2 (herein, N represents a height of the letterbox) with respect to the received video on a lower portion of the video, and, by displaying subtitles on the corresponding position, the screen may be efficiently positioned. Herein, 2×N may be equal to 135. More specifically, in case of changing the UHD video format of 5040×2160, which is given as an example, to a (UHD or HD) video format of 16:9, the height of the letterbox (AFD_size_2N), which is being inserted for displaying subtitle information on a bottom (or lower) portion of the video, becomes equal to 515(5040:3840=2160: (2160−X)->X=515=AFD_size_2N). In case the subtitle information for the video does not exist, just as the conventional method, an AFD bar of 3840×N may be inserted in each of the bottom portion and top portion of the video. This may be applied by using the same method even when the resolution of the video becomes higher.

Conversely, in case of transmitting a 21:9 video, and in case subtitles exist, a receiver including a display having an aspect ratio of 21:9 may display subtitles on the corresponding video, and, in case subtitles do not exist, the receiver may directly receive and display the corresponding video.

Hereinafter, in case a video is being transceived according to the exemplary embodiments of the present invention, an example of signaling information of a broadcast signal that can process the video will be given.

FIG. 43 illustrates exemplary signaling information that allows video to be displayed according to the first exemplary embodiment of the present invention. This drawing illustrates an exemplary PMT as the signaling information at a system level, and, herein, the signaling information may include a program level descriptor immediately following a program info_length of the PMT and a stream level descriptor immediately following an ES_info_length field.

This drawing shows an example of a UHD_program_type_descriptor as an example of the program level descriptor.

descriptor_tag indicates an identifier of this descriptor.

As described above, UHD_program_format_type may include information identifying each exemplary embodiment, as described above.

For example, in case the UHD_program_format_type is equal to 0x01, this indicates the first exemplary embodiment of the present invention, which indicates that the transmitted UHD video of 21:9 corresponds to a video format, which can be displayed by using an area corresponding to a difference between a 16:9 HD video, 16:9 UHD video, and 21:9 UHD video and a 16:9 UHD video as separate layer data, or that the transmitted UHD video of 21:9 corresponds to a service type corresponding to the respective video format.

In case the UHD_program_format_type is equal to 0x02, this indicates the second exemplary embodiment of the present invention, which indicates that the transmitted UHD video of 21:9 corresponds to a video format that can be transmitted by using crop information for a 21:9 video or 16:9 video or to a service type respective to the corresponding video format.

In case the UHD_program_format_type is equal to 0x03, this indicates the third exemplary embodiment of the present invention, which indicates that the transmitted UHD video of 21:9 corresponds to a video format that can be transmitted by using letterbox (AFDbar) information for the 21:9 video and 16:9 video or to a service type respective to the corresponding video format.

In case the UHD_program_format_type is equal to 0x04, this indicates the fourth embodiment of the present invention, which indicates that the transmitted UHD video of 16:9 corresponds to a video format that can be transmitted by using crop information for 21:9 video or 16:9 video or to a service type respective to the corresponding video format.

Additionally, as an example of a stream level descriptor, a UHD composition descriptor is given as an example. This descriptor may include information on a stream, which configures a service or program according to the first, second, third, and fourth exemplary embodiments of the present invention.

For example, in case of following the first exemplary embodiment, information identifying a stream transmitting each of the base layer data, enhancement layer 1 data, and enhancement layer 2 data may be included. This will be described later on in more detail.

FIG. 44 illustrates detailed syntax values of signaling information according to a first exemplary embodiment of the present invention.

The information according to the exemplary embodiments of the present invention is signaled as signaling information of a broadcast signal, and, in case the signaling information corresponds to the PMT, the exemplary field values given herein may indicate the following information.

The first exemplary embodiment transmits streams respectively transmitting each of the base layer data, enhancement layer 1 data, and enhancement layer 2 data, and this exemplary embodiment may signal all of the above-mentioned data.

First of all, in the first exemplary embodiment, a program_number field may correspond to program number information respective to a 21:9 UHD program.

Additionally, the following information may be included in the PMT with respect to a stream transmitting the base layer data. Stream_type may be equal to values, such as 0x02, which indicates a video stream respective to a MPEG-2 video codec. Elementary_PID indicates a PID value of an elementary stream, which is included in each program, and, herein, this example indicates an exemplary value of 0x109A. The stream level descriptor may include signaling information related to the MPEG-2 video.

The following information may be included in the PMT with respect to a stream transmitting the first enhancement layer data. Stream_type indicates a video stream respective to a HEVC scalable layer video codec, and, herein, an exemplary value of 0xA1 is given as an example. Elementary_PID indicates a PID value of an elementary stream, which is included in each program, and, herein, this example indicates an exemplary value of 0x109B. A UHDTV_sub_stream_descriptor( ), which corresponds to the stream level descriptor, may include signaling information related to the first enhancement layer, which is required for configuring a 16:9 video by using the base layer.

The following information may be included in the PMT with respect to a stream transmitting the second enhancement layer data. Stream_type indicates a video stream respective to a HEVC scalable layer video codec, and, herein, an exemplary value of 0xA2 is given as an example. Elementary_PID indicates a PID value of an elementary stream, which is included in each program, and, herein, this example indicates an exemplary value of 0x109C. A UHDTV_composition_descriptor( ), which corresponds to the stream level descriptor, may include signaling information related to the second enhancement layer and that is related to the recovery of the 21:9 UHD video.

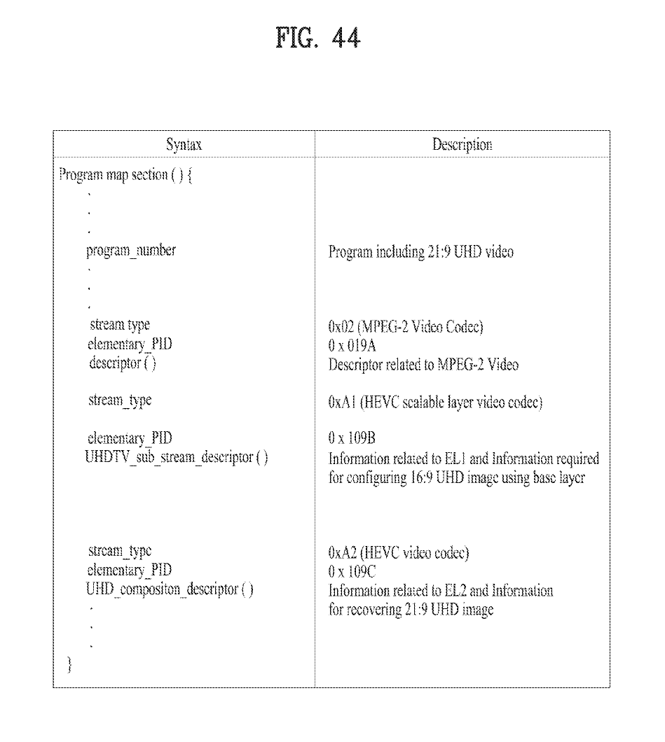

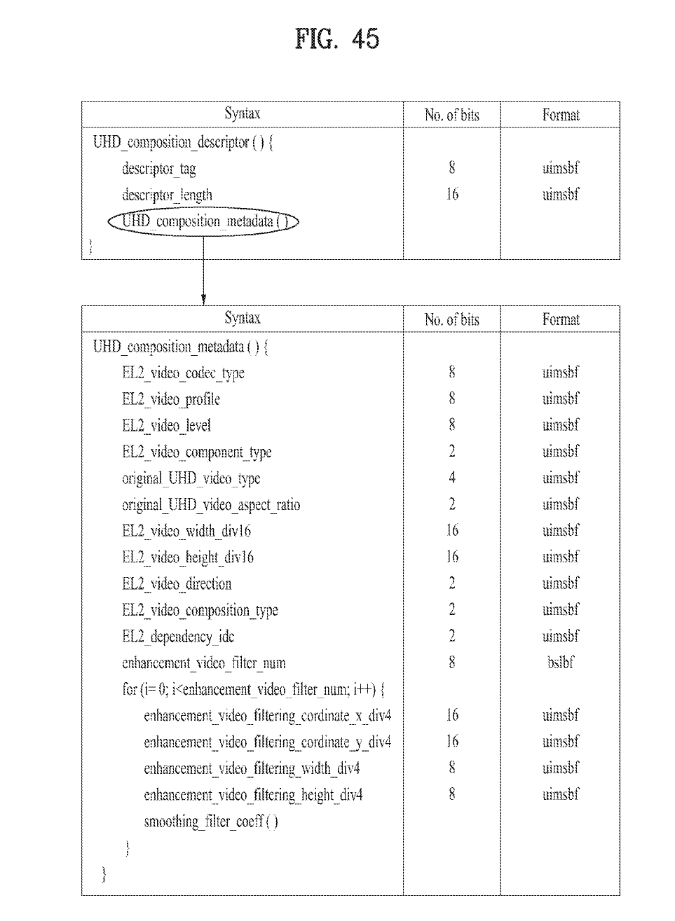

FIG. 45 illustrates an example of a stream level descriptor when following the first exemplary embodiment of the present invention.

According to the example of FIG. 43, UHD_program_format_type, which is included in the program level descriptor, may have a value of 0x01 with respect to the first exemplary embodiment.

The stream level descriptor may include a descriptor_tag value, which can identify this descriptor, descriptor_length indicating the length of this descriptor, and UHD_composition_metadata( ).

In this example, exemplary information being included in the UHD_composition_metadata( ) is given as described below.

An EL2_video_codec_type field indicates codec information of a video element being included in a UHD service. For example, this value may have a value that is identical to the stream_type of the PMT.

An EL2_video_profile field may indicate profile information on the corresponding video stream, i.e., information on the basic specification that is required for decoding the corresponding stream. Herein, requirement information respective to color depth (4:2:0, 4:2:2, and so on), bit depth (8-bit, 10-bit), coding tool, and so on, of the corresponding video stream may be included.

An EL2_video_level field corresponds to level information respective to the corresponding video stream, and, herein, information on a technical element support range, which is defined in the profile, may be included.

In case the corresponding video stream configures a UHD service, an EL2_video_component_type field indicates types of data that are being included. For example, a stream indicates identification information respective to whether the included data correspond to base layer data respective to 16:9 HD, first enhancement layer data of 16:9, second enhancement layer for 21:9 UHD.

An original_UHD_video_type field corresponds to a field for signaling information respective to a UHD video format, and this field may indicate basic information, such as resolution and frame rate, and so on.

An original_UHD_video_aspect_ratio field indicates information related to the aspect ratio of the original UHD video.

An EL2_video_width_div 16 field and an EL2_enhancement_video_height_div 16 field indicate resolution information of a sub_video corresponding to the second enhancement layer data. For example, horizontal and vertical sizes of the video, which is being displayed as the second enhancement layer data, may be expressed in units of a multiple of 16.

An EL2_video_direction field may indicate direction information of a cropped video.

An EL2_video_composition_type field indicates a method of configuring sub_videos, when sub_videos of the UHD video are combined to configure a single video, thereby being transmitted as a single stream.

When compressing left and right sub-videos of the UHD video, an EL2_dependency_idc field indicates information on whether encoding has been performed independently or whether a coding method related to the 16:9 UHD video has been used.

In case of decoding video cropped on the left side and the right side, since a blocked area (artifact) exists in the video, filtering may be applied, and, herein, an enhancement_video_filter_num field indicates whether or not filtering has been applied and also indicates a number of fields.

An enhancement_video_filtering_cordinate_x_div 4 field and an enhancement_video_filtering_cordinate_y_div 4 field respectively indicate coordinates of a first pixel along an X-direction and a Y-direction of a portion of the video to which filtering is to be applied. The actual coordinates may correspond to values equal to the respective field multiplied by 4. For example, in this case, the coordinates may be based upon the UHD video, i.e., the coordinates may be based upon a UHD video, which is recovered by using the base layer, first enhancement layer, and second enhancement layer.

An enhancement_video_filtering_width_div 4 field and an enhancement_video_filtering_width_div 4 field may respectively indicate a size of the video area to which filtering is to be applied in a number of pixels. For example, the size of the area to which filtering is to be applied may correspond to a value that is equal to the actual size being multiplied by 4.

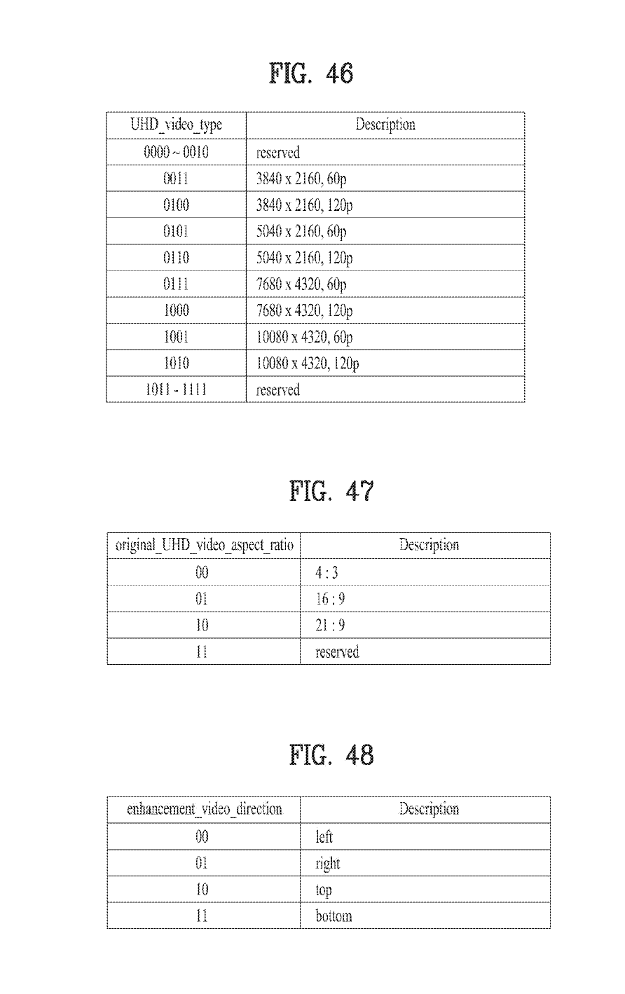

FIG. 46 illustrates an exemplary value of information indicating resolution and frame rate of the video given as an example shown above. Among the signaling information, the original_UHD_video_type field may indicate a resolution and a frame rate of the video, and this drawing shows an example indicating that diverse resolutions and frame rates may be given with respect to the value of this field. For example, in case the original_UHD_video_type field is given a value of 0101, the original video may have 60 frames per second and a resolution of 5040×2160.

FIG. 47 illustrates exemplary information respective to an aspect ratio of the original video. Among the above-described signaling information, the original_UHD_video_aspect_ratio field indicates information related to the aspect ratio of the original UHD video. For example, in case the value of this field is equal to 10, this drawing provides an example that this field indicates an aspect ratio of 21:9.

FIG. 48 illustrates exemplary direction information of a cropped video. Among the above-described signaling information, the EL2_video_direction field shows an example of direction information of the cropped video (second enhancement layer data). For example, in the first exemplary embodiment of the present invention, the cropped left and right video may have direction information, and, in this example, if the value of the information on this direction is equal to 00, this indicates a leftward direction, if the value is equal to 01, this indicates a rightward direction, if the value is equal to 10, this indicates an upward direction, and, if the value is equal to 11, this indicates a downward direction.

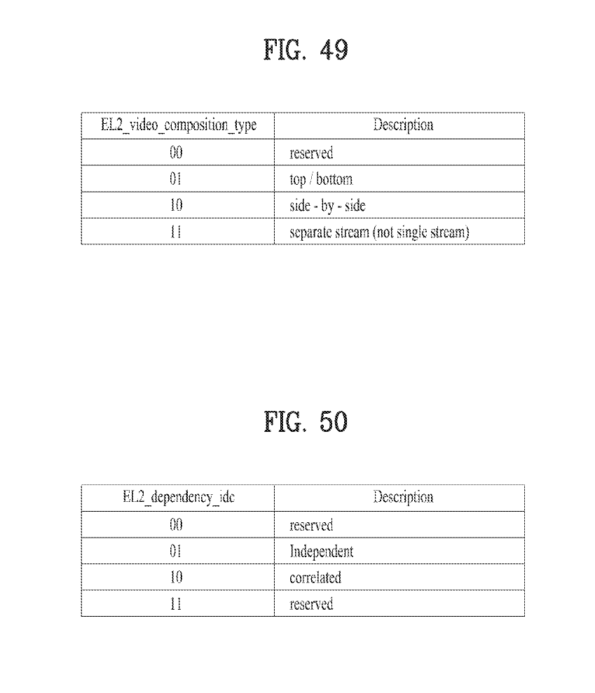

FIG. 49 illustrates an exemplary method for configuring a video. In case the base layer data, the first enhancement layer data, and the second enhancement layer data are combined, the above-described EL2_video_composition_type field provides exemplary signaling information allowing such data to be combined.

For example, in the first exemplary embodiment, when the value of this field is equal to 01, this example indicates that top/bottom second enhancement layer data are combined, and, when the value of this field is equal to 10, this example indicates that the second enhancement layer data are combined side-by-side, and when the value of this field is equal to 11, this example indicates that the sub stream is transmitted to a separate stream other than the sub stream along with the base layer data and the first enhancement layer data.

FIG. 50 illustrates an exemplary encoding method in case of encoding sub streams. The EL2_dependency_idc field, which is described above when following the first exemplary embodiment, may indicate whether the base layer data, the first enhancement layer data, and the second enhancement layer data are encoded by being related to one another or whether they are independently encoded. For example, it may be said that, when encoding specific data, data being used for time estimation or point estimation are encoded in relation with the specific data.

For example, when the value of this field is equal to 01, this may indicate that the second enhancement layer data are independently encoded without any relation with other data, and, when the value of this field is equal to 10, this may indicate that the second enhancement layer data are encoded in relation with other data.

Hereinafter, when following the second exemplary embodiment of the present invention, the following corresponds to a drawing showing an example of signaling information allowing a video to be displayed.

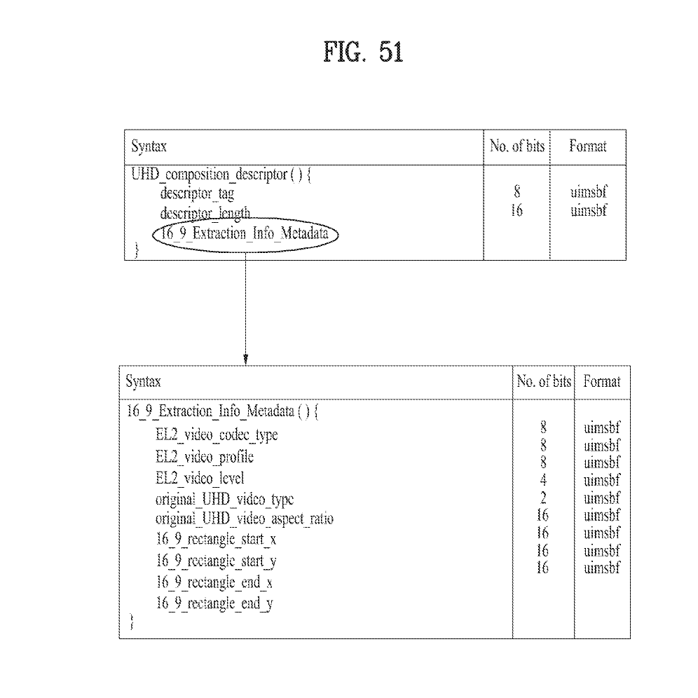

FIG. 51 illustrates a stream level descriptor, which can be included in the PMT of FIG. 43.

When following the second exemplary embodiment of the present invention, a HD video stream and a UHD video stream may be transmitted through separate streams. In addition, the UHD video stream may include metadata that can be converted to another aspect ratio based upon the aspect ratio of the receiver.

Similarly, descriptor_tag and descriptor_length respectively indicate an identifier and a length of this descriptor.

Herein, in case of the second exemplary embodiment, 16_9_extension_info_metadata( ) includes signaling information respective to a stream configuring the UHD video.

For example, an EL2_video_codec_type field indicates codec information of a video element being included in a UHD service. For example, this value may have a value that is identical to the stream_type of the PMT.

An EL2_video_profile field may indicate profile information on the corresponding video stream, i.e., information on the basic specification that is required for decoding the corresponding stream. Herein, requirement information respective to color depth (4:2:0, 4:2:2, and so on), bit depth (8-bit, 10-bit), coding tool, and so on, of the corresponding video stream may be included.

An EL2_video_level field corresponds to level information respective to the corresponding video stream, and, herein, information on a technical element support range, which is defined in the profile, may be included.

An original_UHD_video_type field corresponds to a field for signaling information respective to a UHD video format, and this field may indicate information related to the video, such as resolution and frame rate, and so on.

An original_UHD_video_aspect_ratio field indicates information related to the aspect ratio of the original UHD video.

In case the resolution of the UHD video corresponds to a 21:9 format, such as 5040×2160, a 16_9_rectangle_start_x, field, a 16_9_rectangle_start_y field, a 16_9_rectangle_end_x field, and a 16_9_rectangle_end_y field respectively indicate position information that can designate a valid 16:9 screen area from the 21:9 video. Pixel positions of an upper left portion of the corresponding area may be designated by 16_9_rectangle_start_x and 16_9_rectangle_start_y, and pixel positions of a lower right portion of the corresponding area may be designated by the 16_9_rectangle_end_x and 16_9_rectangle_end_y. By using these fields, the receiver having a 16:9 display format may output only the area that is designated by this field, and the remaining area may be cropped but not displayed.

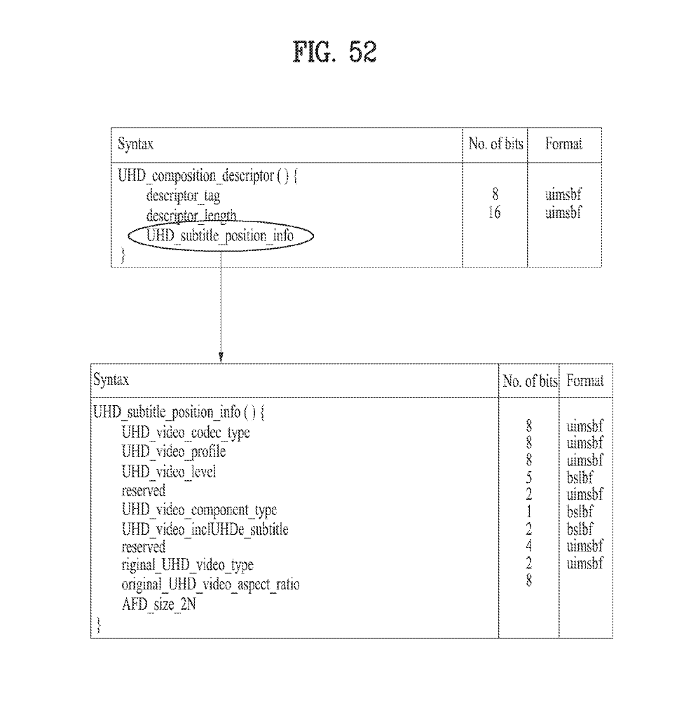

FIG. 52 illustrates exemplary signaling information in case of following the third exemplary embodiment of the present invention.

In case of following the third exemplary embodiment of the present invention, the video having the aspect ratio of 21:9 is transmitted as a video having an aspect ratio of 16:9. At this point, depending upon the screen of the receiver, the receiver including a display of 16:9 displays subtitles on the video as in the related art, and the receiver including a display of 21:9 displays subtitles in an empty portion of the screen.

In this case, a stream level descriptor of the PMT may include the exemplary information presented in this drawing.

Similarly, descriptor_tag and descriptor_length respectively indicate an identifier and a length of this descriptor. UHD_subtitle_position_info( ) may include information on where the subtitles are being positioned.

A UHD_video_codec_type field indicates codec information of a video element being included in a UHD service. For example, this value may have a value that is identical to the stream_type of the PMT.

A UHD_video_profile field may indicate profile information on the corresponding video stream, i.e., information on the basic specification that is required for decoding the corresponding stream. Herein, requirement information respective to color depth (4:2:0, 4:2:2, and so on), bit depth (8-bit, 10-bit), coding tool, and so on, of the corresponding video stream may be included.

A UHD_video_level field corresponds to level information respective to the corresponding video stream, and, herein, information on a technical element support range, which is defined in the profile, may be included.

When converting a 21:9 video to a video format best-fitting a 16:9 display, there are a case when the video is simply cropped and a case when the video is scaled and then inserted in a letterbox area (AFD bar).

A UHD_video_component_type field indicates information on whether the converted 16:9 video corresponds to a scaled video or a cropped video.

A UHD_video_include_subtitle field indicates whether or not the stream corresponds to a stream that is provided with subtitle information within the video respective to the corresponding stream.

An original_UHD_video_type field corresponds to a field for signaling information respective to a UHD video format, and this field may indicate information related to the video, such as resolution and frame rate, and so on.

An original_UHD_video_aspect_ratio field indicates information related to the aspect ratio of the UHD video.

An AFD_size_2N field may indicate that, in case subtitles are not included in the video respective to the stream in the UHD_video_include_subtitle, an AFD bar of (horizontal resolution×AFD_size_2N/2) are respectively added to an upper portion and a lower portion, and, the field may also indicate that, in case of a stream respective to a video having subtitles included therein, an AFD_bar having a size of (horizontal resolution×AFD_size_2N) may be added to a lower portion. During a process of outputting a remaining 21:9 video area excluding the top and bottom letterbox area by using this field, the receiver may perform a function of adjusting subtitle position by having the subtitles displayed on a remaining area after shifting the position of the video upward.

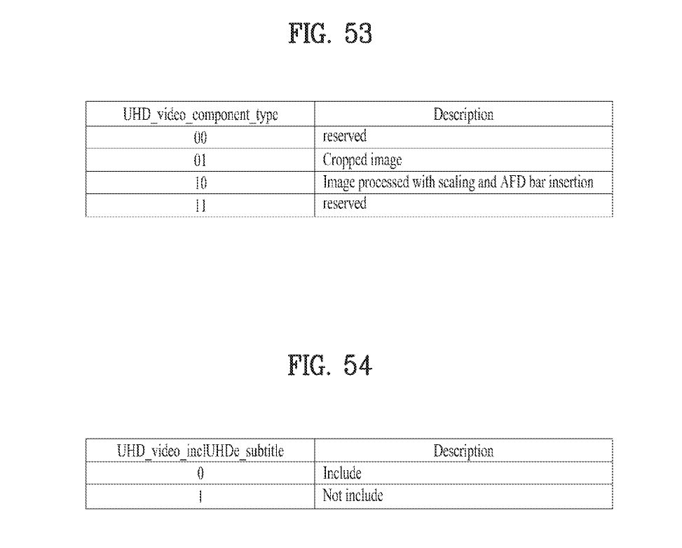

FIG. 53 is illustrates an exemplary field value of an exemplary UHD_video_component_type field. For example, when using this field, identification may be performed as to whether the received 16:9 video corresponds to cropped video or video inserted in the letterbox (AFD bar) after being scaled.

FIG. 54 is illustrates an exemplary field value of an exemplary UHD_video_include_subtitle field. For example, depending upon whether this value is equal to 0 or 1, this field may indicate whether subtitle information is included or whether subtitle information is not included in the stream or the video respective to the stream.

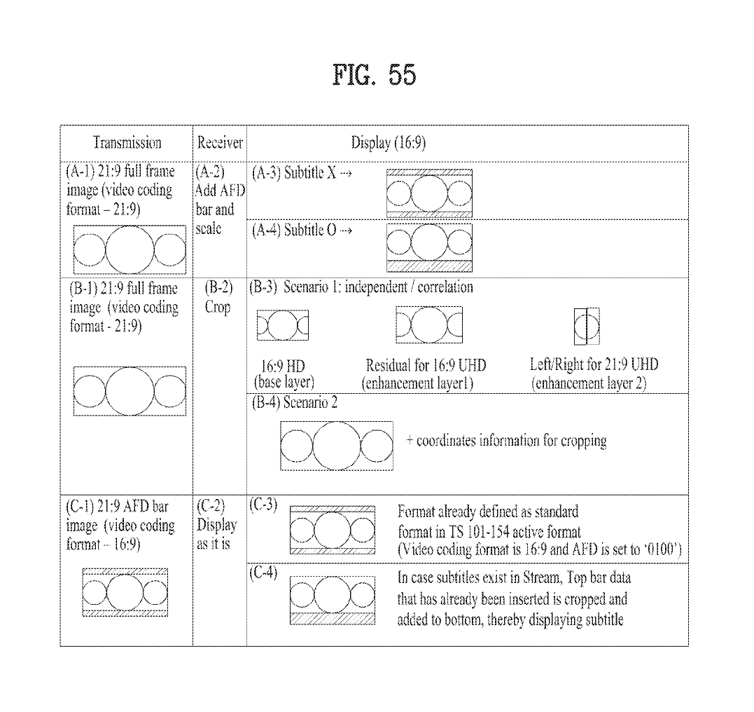

FIG. 55 is illustrates exemplary operations of the receiver, in case a format of a transmission video and a display aspect ratio of the receiver are different.

In this drawing, an example of the format of the video that is being transmitted is shown on a furthermost right side column (A-1, B-1, C-1), the middle column shows exemplary operations (A-2, B-2, C-2) of the receiver, and the last column shows exemplary screens (A-3, A-4, B-3, B-4, C-3, C-4) that can be displayed in accordance with the operations of the receiver. For simplicity in the description, an exemplary transmission video format is given as 21:9, and an exemplary display of the receiver is given as 16:9.

For example, in case the transmission video has a video format of 21:9 (A-1), the receiver inserts a letterbox area (AFD bar) in the corresponding video in accordance with the display apparatus or its performance, and, then, the receiver performs scaling on the corresponding video (A-2). At this point, according to the exemplary signaling information, in case subtitle information does not exist (A-3), the receiver displays the letterbox area on top (or upper) and bottom (or lower) portions of the video, and, in case the subtitle information exists (A-4), the receiver may add the letterbox area to the bottom portion of the video and may display the subtitle information on the letterbox area.

As another example, in case the transmission video has a video format of 21:9 (A-2), the receiver crops the corresponding video (B-2) in accordance with the display apparatus or its performance. In case of the first exemplary embodiment (B-3), the receiver may decode the base layer data, the first enhancement layer data, and the second enhancement layer data, which are encoded either in relation with one another or independently, and may then display the decoded data on a display having the aspect ratio of 16:9. In this case, the second enhancement layer data may not be decoded or may not use the decoded data.

In case of the second exemplary embodiment (B-4), crop coordinates information, which is included in the signaling information, may be displayed on the display of a 16:9 screen.

As yet another example, although the transmission video has a format of 21:9, in case the transmission video has a video format of 16:9, wherein a video format of 21:9 and an AFD bar image are added to the video coding format of 16:9 (C-1), the receiver may directly display the received video (C-2).

At this point, the receiver may identify the 16:9 video coding format as an active format, which corresponds to a format having an AFD added to the video format 16:9, and may directly display the letterbox area on the top and bottom portions (C-3), and, if subtitles exist within the stream, the receiver may cut out (or crop) a bar area, which was initially inserted, and may add it to the bottom portion, and the receiver may then display subtitle information on the corresponding area (C-4).

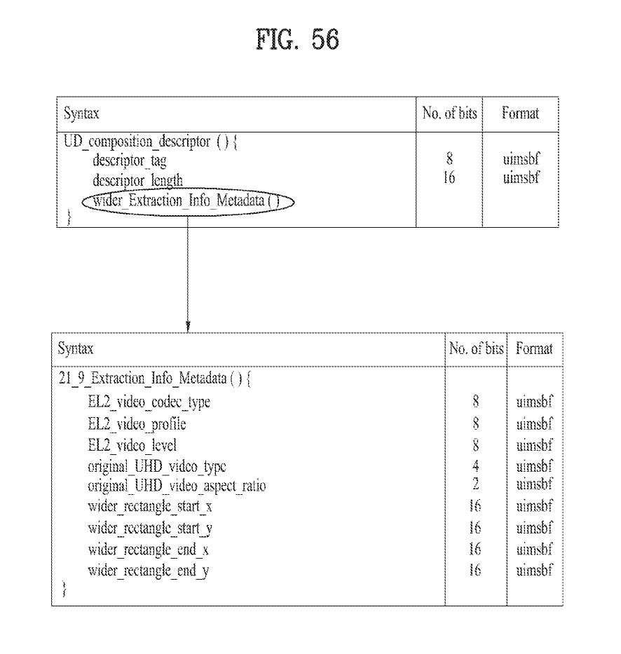

FIG. 56 is a diagram showing an example of a stream level descriptor, which can be included in the PMT of FIG. 43.

According to the fourth embodiment of the present invention, a HD video stream and a UHD video stream may be transmitted through separate streams. In addition, the UHD video stream may include metadata that can be converted to another aspect ratio based upon the aspect ratio of the receiver.

Similarly, descriptor_tag and descriptor_length respectively indicate an identifier and a length of this descriptor.

Herein, in case of the fourth exemplary embodiment, wider_extraction_info_metadata( ) includes signaling information respective to a stream configuring the UHD video.

For example, an EL2_video_codec_type field indicates codec information of a video element being included in a UHD service. For example, this value may have a value that is identical to the stream_type of the PMT.

An EL2_video_profile field may indicate profile information on the corresponding video stream, i.e., information on the basic specification that is required for decoding the corresponding stream. Herein, requirement information respective to color depth (4:2:0, 4:2:2, and so on), bit depth (8-bit, 10-bit), coding tool, and so on, of the corresponding video stream may be included.

An EL2_video_level field corresponds to level information respective to the corresponding video stream, and, herein, information on a technical element support range, which is defined in the profile, may be included.

An original_UHD_video_type corresponds to a field for signaling information respective to a UHD video format, and this field may indicate information related to the video, such as resolution and frame rate, and so on. This may have the same meaning as the original_UHD_video_type according to the first embodiment of the present invention.

An original_UHD_video_aspect_ratio field indicates information related to the aspect ratio of the original UHD video. This may have the same meaning as the original_UHD_video_type according to the first embodiment of the present invention.

In case the resolution of the UHD video corresponds to a 21:9 format, a wider_rectangle_start_x field, a wider_rectangle_start_yfield, a wider_rectangle_end_x field, and a wider_rectangle_end_y field, respectively indicate position information that can designate a valid 21:9 screen area. Pixel positions of an upper left portion of the corresponding area may be designated by wider_rectangle_start_x and wider_rectangle_start_y, and pixel positions of a lower right portion of the corresponding area may be designated by the wider_rectangle_end_x and wider_rectangle_end_y. In this case, these field values may be designated based on the number of lines of a coded video stream or may designate a relative position in horizontal and vertical directions of coded video. For example, wider_rectangle_start_x may be expressed by a pixel number having a value of 1920 or may be expressed by a relative value of 192 corresponding to 10% based on a horizontal size. Accordingly, using these fields, the receiver having a wide aspect ratio such as 21:9 may selectively output an area that is designated by the field among 16:9 areas and the remaining area may be cropped but not displayed.

According to another embodiment of the present invention, fields such as inactive_top_size, inactive_bottom_size, inactive_left_size, and inactive_right_size may be used instead of the aforementioned wider_rectangle_start_x, wider_rectangle_start_y, wider_rectangle_end_x, and wider_rectangle_end_y fields. These fields may designate the number of horizontal lines of an upper portion of an image that is not inevitably output, the number of vertical lines of a lower portion of the image, the number of vertical lines of a left portion of the image, and the number of vertical lines of a right portion of the image, respectively.

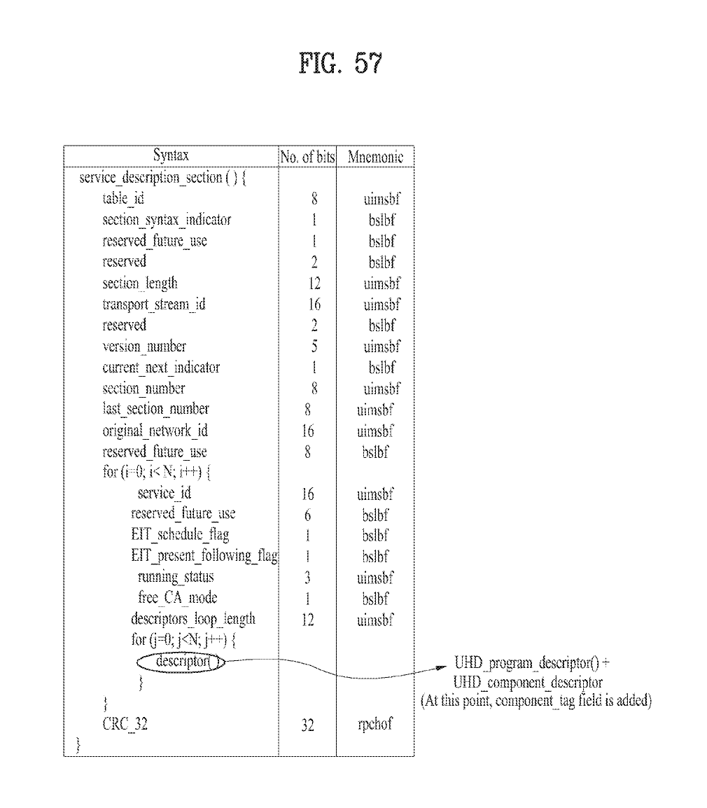

FIG. 57 illustrates an exemplary case when the exemplary descriptors are included in other signaling information.

A table_id field indicates an identifier of the table.

A section_syntax_indicator field corresponds to a 1-bit field that is set to 1 with respect to a SDT table section (section_syntax_indicator: The section section_syntax_indicator is a 1-bit field which shall be set to “1”).

A section_length field indicates a length of the section is a number of bytes (section_length: This is a 12-bit field, the first two bits of which shall be “00”. It specifies the number of bytes of the section, starting immediately following the section_length field and including the CRC. The section_length shall not exceed 1 021 so that the entire section has a maximum length of 1 024 bytes.)

A transport_stream_id field differentiates from another multiplex within the transmitting system and then indicates a TS identifier, which is provided by the SDT (transport_stream_id: This is a 16-bit field which serves as a label for identification of the TS, about which the SDT informs, from any other multiplex within the delivery system.)

A version_number field indicates a version number of this sub table (version_number: This 5-bit field is the version number of the sub_table. The version_number shall be incremented by 1 when change in the information carried within the sub_table occurs. When it reaches value “31”, it wraps around to “0”. When the current_next_indicator is set to “1”, then the version_number shall be that of the currently applicable sub_table. When the current_next_indicator is set to “0”, then the version_number shall be that of the next applicable sub_table.)

A current_next_indicator field indicates whether this sub table is currently applicable or applicable next (current_next_indicator. This 1-bit indicator, when set to “1” indicates that the sub_table is the currently applicable sub_table. When the bit is set to “0”, it indicates that the sub_table sent is not yet applicable and shall be the next sub_table to be valid.)

A section_number field indicates a number of the section (section_number: This 8-bit field gives the number of the section. The section_number of the first section in the sub_table shall be “0x00”. The section_number shall be incremented by 1 with each additional section with the same table_id, transport_stream_id, and original_network_id.)

A last_section_number field indicates a number of the last section (last_section_number: This 8-bit field specifies the number of the last section (that is, the section with the highest section_number) of the sub_table of which this section is part.)

An original_network_id field indicates an identifier of a network ID of the transmitting system (original_network_id: This 16-bit field gives the label identifying the network_id of the originating delivery system.)

A service_id field indicates a service identifier within the TS (service_id: This is a 16-bit field which serves as a label to identify this service from any other service within the TS. The service_id is the same as the program_number in the corresponding program_map_section.)

An EIT_schedule_flag field may indicate whether or not EIT schedule information respective to the service exists in the current TS (EIT_schedule_flag: This is a 1-bit field which when set to “1” indicates that EIT schedule information for the service is present in the current TS, see TR 101 211 [i.2] for information on maximum time interval between occurrences of an EIT schedule sub_table.) If the flag is set to 0 then the EIT schedule information for the service should not be present in the TS.)

An EIT_present_following_flag field may indicate whether or not EIT_present_following information information respective to the service exists within the present TS (EIT_present_following_flag: This is a 1-bit field which when set to “1” indicates that EIT_present_following information for the service is present in the current TS, see TR 101 211 [i.2] for information on maximum time interval between occurrences of an EIT present/following sub_table. If the flag is set to 0 then the EIT present/following information for the service should not be present in the TS)

A running_status field may indicate a status of the service, which is define in Table 6 of the DVB-SI document (running_status: This is a 3-bit field indicting the status of the service as defined in table 6. For an NVOD reference service the value of the running_status shall be set to “0”.)

A free_CA_mode field indicates whether or not all component streams of the service are scrambled (free_CA_mode: This 1-bit field, when set to “0” indicates that all the component streams of the service are not scrambled. When set to “1” it indicates that access to one or more streams may be controlled by a CA system.)

A descriptors_loop_length field indicates a length of an immediately successive descriptor (descriptors_loop_length: This 12-bit field gives the total length in bytes of the following descriptors).

CRC_32 corresponds to a 32-but field including a CRC value (CRC_32: This is a 32-bit field that contains the CRC value that gives a zero output of the registers in the decoder)

The descriptors_loop_length field may include the UHD_program_type_descriptor, which is given as an example in FIG. 16, and the UHD_composition_descriptor, which is given as an example in FIG. 18, FIG. 24, or FIG. 25 according to the exemplary embodiment of the present invention, in the following descriptor locations.

In case the UHD_composition_descriptor is included in the SDT of the DVB, the UHD_composition_descriptor may further include a component_tag field. The component_tag field may indicate a PID value respective to the corresponding stream signaled from the PMT, which corresponds to a PSI level. The receiver may find (or locate) the PID value of the corresponding stream along with the PMT by using the component_tag field.

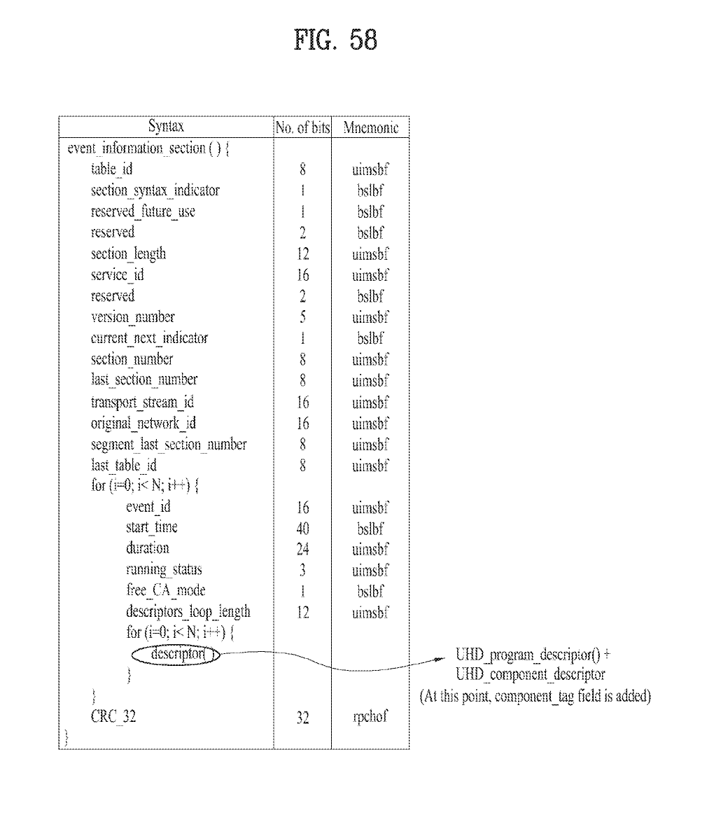

FIG. 58 illustrates an exemplary case when the exemplary descriptors are included in other signaling information. This drawing illustrates an exemplary case when the exemplary descriptors are included in an EIT.

The EIT may follow ETSI EN 300 468. By using this, each field will hereinafter be described as shown below.

A table_id field indicates an identifier of the table.

A section_syntax_indicator field corresponds to a 1-bit field that is set to 1 with respect to a EIT table section (section_syntax_indicator: The section section_syntax_indicator is a 1-bit field which shall be set to “1”)

A section_length field indicates a length of the section is a number of bytes (section_length: This is a 12-bit field. It specifies the number of bytes of the section, starting immediately following the section_length field and including the CRC. The section_length shall not exceed 4 093 so that the entire section has a maximum length of 4 096 bytes.)

A service_id field indicates a service identifier within the TS (service_id: This is a 16-bit field which serves as a label to identify this service from any other service within a TS. The service_id is the same as the program_number in the corresponding program_map_section.)

A version_number field indicates a version number of this sub table (version_number: This 5-bit field is the version number of the sub_table. The version_number shall be incremented by 1 when change in the information carried within the sub_table occurs. When it reaches value 31, it wraps around to 0. When the current_next_indicator is set to “1”, then the version_number shall be that of the currently applicable sub_table. When the current_next_indicator is set to “0”, then the version_number shall be that of the next applicable sub_table.)

A current_next_indicator field indicates whether this sub table is currently applicable or applicable next (current_next_indicator: This 1-bit indicator, when set to “1” indicates that the sub_table is the currently applicable sub_table. When the bit is set to “0”, it indicates that the sub_table sent is not yet applicable and shall be the next sub_table to be valid.)

A section_number field indicates a number of the section (section_number: This 8-bit field gives the number of the section. The section_number of the first section in the sub_table shall be “0x00”. The section_number shall be incremented by 1 with each additional section with the same table_id, service_id, transport_stream_id, and original_network_id. In this case, the sub_table may be structured as a number of segments. Within each segment the section_number shall increment by 1 with each additional section, but a gap in numbering is permitted between the last section of segment and the first section of the adjacent segment.)

A last_section_number field indicates a number of the last section (last_section_number: This 8-bit field specifies the number of the last section (that is, the section with the highest section_number) of the sub_table of which this section is part.)

A transport_stream_id field differentiates from another multiplex within the transmitting system and then indicates a TS identifier, which is provided by the SDT (transport_stream_id: This is a 16-bit field which serves as a label for identification of the TS, about which the EIT informs, from any other multiplex within the delivery system.)

An original_network_id field indicates an identifier of a network ID of the transmitting system (original_network_id: This 16-bit field gives the label identifying the network_id of the originating delivery system.)

A segment_last_section_number field indicates a last section number of this segment of this sub table (segment_last_section_number. This 8-bit field specifies the number of the last section of this segment of the sub_table. For sub_tables which are not segmented, this field shall be set to the same value as the last_section_number field.)

A last_table_id field is (last_table_id: This 8-bit field identifies the last table_id used (see table 2).)

An event_id field indicates an identification number of an event. (event_id: This 16-bit field contains the identification number of the described event (uniquely located within a service definition)

A start_time field includes a start time of an event (start_time: This 40-bit field contains the start time of the event in Universal Time, Co-ordinated (UTC) and Modified Julian Date (MJD) (see annex C). This field is coded as 16 bits giving the 16 LSBs of MID followed by 24 bits coded as 6 digits in 4-bit Binary Coded Decimal (BCD). If the start time is undefined (e.g. for an event in a NVOD reference service) all bits of the field are set to “1”.)

A running_status field may indicate a status of the event, which is defined in Table 6 of the DVB-SI document (running_status: This is a 3-bit field indicting the status of the service as defined in table 6. For an NVOD reference event the value of the running_status shall be set to “0”.)

A free_CA_mode field indicates whether or not all component streams of the service are scrambled (free_CA_mode: This 1-bit field, when set to “0” indicates that all the component streams of the service are not scrambled. When set to “1” it indicates that access to one or more streams may be controlled by a CA system.)

A descriptors_loop_length field indicates a length of an immediately successive descriptor (descriptors_loop_length: This 12-bit field gives the total length in bytes of the following descriptors.)

CRC_32 corresponds to a 32-but field including a CRC value (CRC_32: This is a 32-bit field that contains the CRC value that gives a zero output of the registers in the decoder)

The descriptors_loop_length field may include the UHD_program_type_descriptor, which is given as an example in FIG. 16, and the UHD_composition_descriptor, which is given as an example in FIG. 18, FIG. 24, or FIG. 25 according to the exemplary embodiment of the present invention, in the following descriptor locations.

In case the UHD_composition_descriptor is included in the EIT of the DVB, the UHD_composition_descriptor may further include a component_tag field. The component_tag field may indicate a PID value respective to the corresponding stream signaled from the PMT, which corresponds to a PSI level. The receiver may find (or locate) the PID value of the corresponding stream along with the PMT by using the component_tag field.

FIG. 59 illustrates an exemplary case when the exemplary descriptors are included in other signaling information.

The VCT may follow an ATSC PSIP standard. According to ATSC PSIP, the description of each field is as follows. The description of each bit is disclosed as described below.

A table_id field indicates an 8-bit unsigned integer, which indicates a type of a table section. (table_id—An 8-bit unsigned integer number that indicates the type of table section being defined here. For the terrestrial_virtual_channel_table_section( ), the table_id shall be 0xC8)

A section_syntax_indicator field corresponds to a 1-bit field, which is set to 1 with respect to a VCT table section (section_syntax_indicator—The section_syntax_indicator is a one-bit field which shall be set to ‘1’ for the terrestrial_virtual_channel_table_section( )).

A private_indicator field is set to 1 (private_indicator—This 1-bit field shall be set to ‘1’)

A section_length field indicates a length of a section in a number of bytes. (section_length—This is a twelve bit field, the first two bits of which shall be ‘00’. It specifies the number of bytes of the section, starting immediately following the section_length field, and including the CRC.)

A transport_stream_id field indicates a MPEG-TS ID as in the PMT, which can identify the TVCT (transport_stream_id—The 16-bit MPEG-2 Transport Stream ID, as it appears in the Program Association Table (PAT) identified by a PID value of zero for this multiplex. The transport_stream_id distinguishes this Terrestrial Virtual Channel Table from others that may be broadcast in different PTCs.)

A version_number field indicates a version number of the VCT (version_number—This 5 bit field is the version number of the Virtual Channel Table. For the current VCT (current_next_indicator=‘1’), the version number shall be incremented by 1 whenever the definition of the current VCT changes. Upon reaching the value 31, it wraps around to 0. For the next VCT (current_next_indicator=‘0’), the version number shall be one unit more than that of the current VCT (also in module 32 arithmetic). In any case, the value of the version_number shall be identical to that of the corresponding entries in the MGT)

A current_next_indicator field indicates whether this VCT table is currently applicable or applicable next (current_next_indicator—A one-bit indicator, which when set to ‘1’ indicates that the Virtual Channel Table sent is currently applicable. When the bit is set to ‘0’, it indicates that the table sent is not yet applicable and shall be the text table to become valid. This standard imposes no requirement that “next” tables (those with current_next_indicator set to ‘0’) must be sent. An update to the currently applicable table shall be signaled by incrementing the version_number field)

A section_number field indicates a number of a section (section_number—This 8 bit field gives the number of this section. The section_number of the first section in the Terrestrial Virtual Channel Table shall be 0x00. It shall be incremented by one with each additional section in the Terrestrial Virtual Channel Table)

A last_section_number field indicates a number of the last section (last_section_number—This 8 bit field specifies the number of the last section (that is, the section with the highest section_number) of the complete Terrestrial Virtual Channel Table.)

A protocol_version field indicates a protocol version for parameters that are to be defined differently from the current protocols in a later process (protocol_version—An 8-bit unsigned integer field whose function is to allow, in the future, this table type to carry parameters that may be structured differently than those defined in the current protocol. At present, the only valid value for protocol_version is zero. Non-zero values of protocol_version may be used by a future version of this standard to indicate structurally different tables)

A num_channels_in_section field indicates a number of virtual channels in this VCT (num_channels_in_section—This 8 bit field specifies the number of virtual channels in this VCT section. The number is limited by the section length)

A short_name field indicates a name of the virtual channel (short_name—The name of the virtual channel, represented as a sequence of one to seven 16-bit code values interpreted in accordance with the UTF-16 representation of Unicode character data. If the length of the name requires fewer than seven 16-bit code values, this field shall be padded out to seven 16-bit code values using the Unicode NUL character (0x0000). Unicode character data shall conform to The Unicode Standard, Version 3.0 [13].)

A major_channel_number field indicates a number of major channels related to the virtual channel (major_channel_number—A 10-bit number that represents the “major” channel number associated with the virtual channel being defined in this iteration of the ‘for’ loop. Each virtual channel shall be associated with a major and a minor channel number. The major channel number, along with the minor channel number, act as the user's reference number for the virtual channel. The major_channel_number shall be between 1 and 99. The value of major_channel_number shall be set such that in no case is a major_channel_number/minor_channel_number pair duplicated within the TVCT. For major_channel_number assignments in the U.S., refer to Annex B.)

A minor_channel_number field indicates a number of minor channels related to the virtual channel (minor_channel_number—A 10-bit number in the range 0 to 999 that represents “minor” or “sub”-channel number. This field, together with major_channel_number, performs as a two-part channel number, where minor_channel_number represents the second or right-hand part of the number. When the service_type is analog television, minor_channel_number shall be set to 0. Services whose service_type is ATSC_digital_television, ATSC_video_only, or unassociated/small_screen_service shall use minor numbers between 1 and 99. The value of minor_channel_number shall be set such that in no case is a major_channel_number/minor_channel_number pair duplicated within the TVCT. For other types of services, such as data broadcasting, valid minor virtual channel numbers are between 1 and 999.)

A modulation_mode mode indicates a modulation mode of a carrier related to the virtual channel (modulation_mode—An 8-bit unsigned integer number that indicates the modulation mode for the transmitted carrier associated with this virtual channel. Values of modulation_mode shall be as defined in Table 6.5. For digital signals, the standard values for modulation mode (values below 0x80) indicate transport framing structure, channel coding, interleaving, channel modulation, forward error correction, symbol rate, and other transmission-related parameters, by means of a reference to an appropriate standard. The modulation_mode field shall be disregarded for inactive channels)

A carrier_frequency field corresponds to a field that can identify a carrier frequency (carrier_frequency—The recommended value for these 32 bits is zero. Use of this field to identify carrier frequency is allowed, but is deprecated.)

A channel_TSID field indicates a MPEG-2 TS ID that is related to TS transmitting an MPEG-2 program, which is referenced by this virtual channel (channel_TSID—A 16-bit unsigned integer field in the range 0x0000 to 0xFFFF that represents the MPEG-2 Transport Stream ID associated with the Transport Stream carrying the MPEG-2 program reference by this virtual channel8. For inactive channel, channel_TSID shall represent the ID of the Transport Stream that will carry the service when it becomes active. The receiver is expected to use the channel_TSID to verify that any received Transport Stream is actually the desired multiplex. For analog channels (service_type 0x01), channel_TSID shall indicate the value of the analogTSID included in the VBI of the NTSC signal. Refer to Annex D Section 9 for a discussion on use of the analog TSID)

A program_number field indicates an integer value that is defined in relation with this virtual channel and PMT (program_number—A 16-bit unsigned integer number that associates the virtual channel being defined here with the MPEG-2 PROGRAM ASSOCIATION and TS PROGRAM MAP tables. For virtual channels representing analog services, a value of 0xFFFF shall be specified for program_number. For inactive channels (those not currently present in the Transport Stream), program_number shall be set to zero. This number shall not be interpreted as pointing to a Program Map Table entry.)

An ETM_location field indicates the presence and location (or position) of the ETM (ETM_location—This 2-bit field specifies the existence and the location of an Extended Text Message (ETM) and shall be as defined in Table 6.6.)

An access_controlled field may designate an event that is related to the access controlled virtual channel (access_controlled—A 1-bit Boolean flag that indicates, when set, that the events associated with this virtual channel may be access controlled. When the flag is set to ‘0’, event access is not restricted)

A hidden field may indicate a case when the virtual channel is not accessed due to a direct channel input made by the user (hidden—A 1-bit Boolean flag that indicates, when set, that the virtual channel is not accessed by the user by direct entry of the virtual channel number. Hidden virtual channels are skipped when the user is channel surfing, and appear as if undefined, if accessed by direct channel entry. Typical applications for hidden channels are test signals and NVOD services. Whether a hidden channel and its events may appear in EPG displays depends on the state of the hide_guide bit.)

A hide_guide field may indicate whether or not the virtual channel and its events can be displayed on the EPG (hide_guide—A Boolean flag that indicates, when set to ‘0’, for a hidden channel, that the virtual channel and its events may appear in EPG displays. This bit shall be ignored for channels which do not have the hidden bit set, so that non-hidden channels and their events may always be included in the EPG displays regardless of the state of the hide_guide bit. Typical applications for hidden channels with the hide_guide bit set to ‘1’ are test signals and services accessible through application-level pointers.)

A service_type field indicates a service type identifier (service_type—This 6-bit field shall carry the Service Type identifier. Service Type and the associated service_type field are defined in A/53 Part 1[1] to identify the type of service carried in this virtual channel. Value 0x00 shall be reserved. Value 0x01 shall represent analog television programming. Other values are defined in A/53 Part 3[3], and other ATSC Standards may define other Service Types9)

A source_id field corresponds to an identification number identifying a program source related to the virtual channel (source_id—A 16-bit unsigned integer number that identifies the programming service associated with the virtual channel. In this context, a source is one specific source of video, text, data, or audio programming. Source ID value zero is reserved. Source ID values in the range 0x0001 to 0x0FFF shall be unique within the Transport Stream that carries the VCT, while values 0x1000 to 0xFFFF shall be unique at the regional level. Values for source_ids 0x1000 and above shall be issued and administered by a Registration Authority designated by the ATSC.)

A descriptors_length field indicates a length of a following (or subsequent) descriptor (descriptors_length—Total length (in bytes) of the descriptors for this virtual channel that follows)

Descriptors may be included in descriptor( ). (descriptor( )—Zero or more descriptors, as appropriate, may be included.)

In case a video service is being transmitted according to the exemplary embodiments of the present invention, the service_type field may be given a value indicating a parameterized service (0x07) or an extended parameterized service (0x09) or a scalable UHDTV service.

Additionally, the UHD_program_type_descriptor, which is given as an example in FIG. 43, and the UHD_composition_descriptor, which is given as an example in FIG. 45, 51, or 52 may be located in a descriptor location.

Hereinafter, in case video data are being transmitted according to the exemplary embodiments of the present invention, a syntax of the video data will be disclosed.

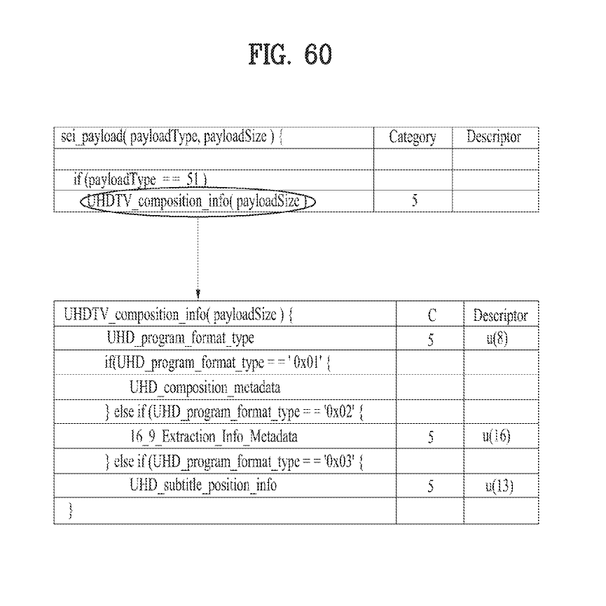

FIG. 60 illustrates an exemplary syntax of a payload of a SEI section of video data according to the exemplary embodiments of the present invention.

In a SEI payload, in case payloadType is set to a specific value (in this example, 51), information (UHD_composition_info(payload Size)) signaling the format of the video data as given in the example may be included.

The UHD_program_format_type is identical to the example shown in FIG. 43, and, herein, for example, in case the UHD_program format_type is equal to 0x01, as an example indicating the first exemplary embodiment of the present invention, this indicates that the transmitted UHD video of 21:9 corresponds to a video format that can display the 16:9 HD video, the 16:9 UHD video, and an area representing a difference between the 21:9 UHD video and the 16:9 UHD video by using separate layer data.

At this point, the video data may include a UHD_composition_metadata value. This value is already given as an example in FIG. 45.

In case the UHD_program_format_type is equal to 0x02, as an example indicating the second exemplary embodiment of the present invention, this indicates that the transmitted UHD video of 21:9 corresponds to a video format that can be displayed by using crop information for the 21:9 video or the 16:9 video.

At this point, the video data may include a 16_9_Extraction_Info_Metadata value. This value is already given as an example in FIG. 51.

In case the UHD_program_format_type is equal to 0x03, as an example indicating the third exemplary embodiment of the present invention, this indicates that the transmitted UHD video of 21:9 corresponds to a video format that can be displayed by using letterbox (AFDbar) information for the 16:9 video and the 21:9 video.

At this point, the video data may include a UHD_subtitle_position_info value. This value is already given as an example in FIG. 52.

A video decoder of the receiver may perform parsing of a UHDTV_composition_info SEI message, which is respectively given as an example as described above. The UHDTV_composition_info ( ) is received through a SEI RBSP (raw byte sequence payload), which corresponds to an encoded video data source.

The video decoder parses an AVC or HEVC NAL unit, and, in case the nal_unit_type value is equal to a value corresponding to the SEI data, the video decoder reads the UHDTV_composition_info SEI message having a payloadType of 51.

Additionally, by decoding the UHDTV_composition_info( ), which is given as an example in this drawing, UHD_composition information, 16:9 extraction information, or UHD_subtitle_position information respective to the current video data may be acquired. By using the information of the video data section, the receiver may determine the configuration information of the 16:9 HD and UHD and 21:9 UHD streams, thereby being capable of performing final output of the UHD video.

Accordingly, the receiver may determine video data according to the exemplary embodiment, which is disclosed in the present invention, from the signaling information section and the video data section, and, then, the receiver may convert the video format respectively and may display the converted video data to fit the receiver.

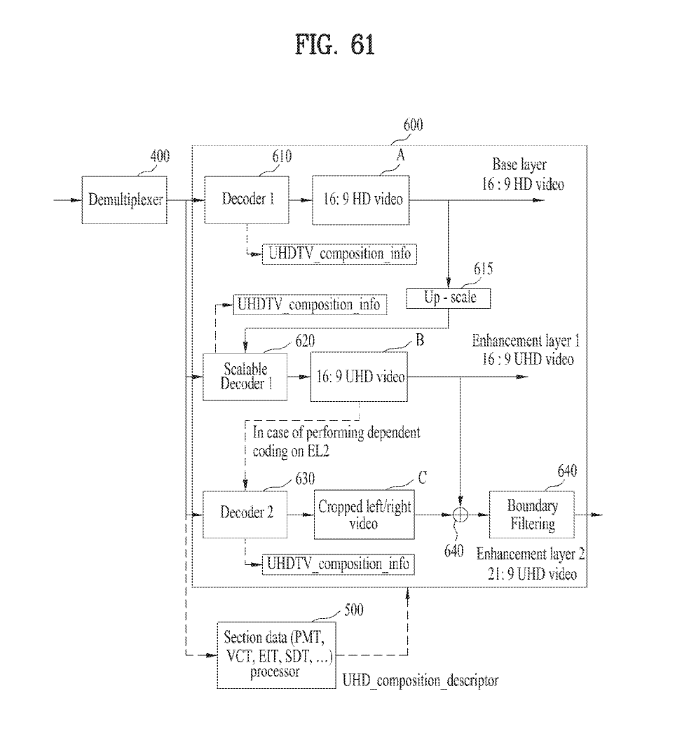

FIG. 61 illustrates an example of a receiving apparatus that can decode and display video data according to at least one exemplary embodiment of the present invention, in case the video data are transmitted according to the exemplary embodiments of the present invention.

An example of a signal receiving apparatus according to the present invention may include a demultiplexer 400, a signaling information processing unit 500, and a video decoder 600.

The demultiplexer 400 may demultiplex each of the video streams and signaling information according to the exemplary embodiment of the present invention. For example, the video streams may include streams transmitting videos, which are given as examples in FIGS. 29 to 32.

The signaling information processing unit 500 may decode the signaling information, which is given as an example in FIGS. 43 to 54 and FIGS. 56 to 59, or may decode a part (or portion) of the signaling information depending upon the performance of the receiver. For example, the signaling information processing unit 500 may decode signaling information of at least one of the descriptors shown in FIGS. 45, 51, and 52.

The video decoder 600 may decode the video data, which are demultiplexed by the demultiplexer 400 in accordance with the signaling information that is processed by the signaling information processing unit 500. In this case, the video data may be decoded by using coding information or signaling information of the video data respective to the syntax of the video data, which are given as an example in FIG. 60.

The video decoder 600 may include at least one video decoder among a first decoder 610, a second decoder 620, and a third decoder 630.

For example, according to the first exemplary embodiment of the present invention, the video decoder 600 may include a first decoder 610, a second decoder 620,

and a third decoder 630.

The first decoder 610 may decode and output the demultiplexed 16:9 HD video. In this case, the first decoder 610 may decode the coding information (UHDTV_composition_info), which is given as an example in FIG. 32. The video data, which are decoded by the first decoder 610, may be outputted as 16:9 HD video data(A), which correspond to base layer data.

An up-scaler 615 may up-scale the 16:9 HD video data, which correspond to base layer data, so as to output 21:9 video data.

The second decoder 620 may perform scalable decoding by using the up-scaled base layer data and residual data. In this case, the second decoder 620 may decode the coding information (UHDTV_composition_info), which is given as an example in FIG. 60. The video data, which are decoded by the second decoder 620, may be outputted as 16:9 UHD video data(B), which correspond to second enhancement layer data.

The third decoder 630 may output the data that are cropped from the 21:9 video data as the decoded video data(C). The third decoder 630 may also perform decoding in association with the 16:9 UHD video data(B) in accordance with the coding method. Similarly, in this case, the first decoder 630 may decode the coding information (UHDTV_composition_info), which is given as an example in FIG. 60.

Additionally, a merging unit 640 may merge and output the 16:9 UHD video data(B), which are outputted from the second decoder 620, and the cropped data, which are outputted from the third decoder 630.

Furthermore, a filtering unit 640 may perform filtering on a merged portion of the video. The filtering method is given above as an example in FIG. 40 and Equation 1 to Equation 10.

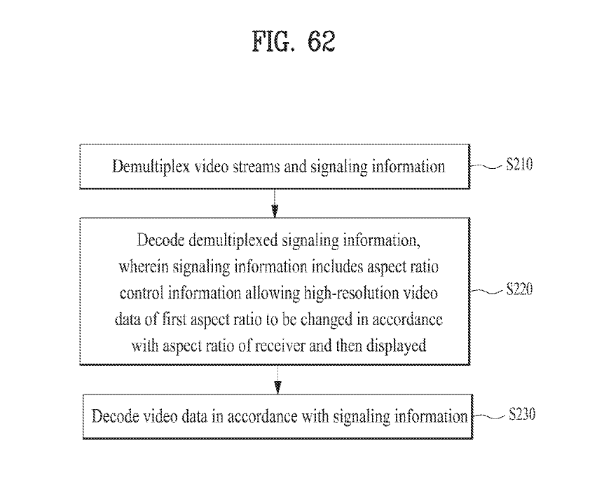

FIG. 62 illustrates a method for receiving signals according to an exemplary embodiment of the present invention.

A signaling receiving method according to an exemplary embodiment of the present invention multiplexes video streams and signaling information (S210).

Video data being included in a video stream may have different structures depending upon the exemplary embodiments, and such exemplary embodiments may vary in accordance with FIGS. 29 and 30 (First embodiment), FIG. 31 (Second embodiment), FIGS. 32 to 34 (Third embodiment), and Fourth embodiment. For example, the received video data may include data, which allow high-resolution video to be divided to fit the conventional (or already-existing) aspect ratio and transmitted accordingly, and which allow the divided data to be merged back to the high-resolution video. Alternatively, the received video data may include information allowing the high-resolution video data to be divided to fit the aspect ratio of the receiver or may also include position information of a letter for positioning subtitle information (e.g., AFD bar).

In case the signal being received corresponds to a broadcast signal, the signaling information, which is given as an example in FIGS. 43 to 54 and FIGS. 56 to 59, may be demultiplexed separately from the video data.

In case the signal being received corresponds to a broadcast signal, the demultiplexed signaling information is decoded (S220). In case the received signal does not corresponds to a broadcast signal, step S220 is omitted, and the signaling information within the video data is decoded in the video data decoding step described below. The demultiplexed signaling information that is included in the broadcast signal may include diverse information, which are given as examples in FIGS. 43 to 54 and FIGS. 56 to 59 according to the respective exemplary embodiment, and, herein, the diverse information, which are given as examples in the above-mentioned drawings according to the respective exemplary embodiment, may be decoded. The signaling information may include signaling information that signals displaying high-resolution video data having a first aspect ratio on the receiver regardless of the aspect ratio. For example, the signaling information that signals displaying high-resolution video data on the receiver regardless of the aspect ratio may include aspect ratio control information of the high-resolution video data.

Video data are decoded with respect to the signaling information according to the exemplary embodiment (S230). Video data information including coding information respective to a video data syntax, which is given as an example in FIG. 60, may be included in the video data. In case of decoding the video data, the corresponding video data may be outputted as decoded, or may be merged, or may be outputted after positioning subtitles therein. In case the received video data correspond to the high resolution being divided to fit the already-existing aspect ratio and transmitted accordingly, the signaling information may include data that can merge the received video data back to the high-resolution video. Alternatively, the signaling information may include information allowing the high-resolution video data to be divided to fit the aspect ratio of the receiver or may also include position information of a letter for positioning subtitle information (e.g., AFD bar).

More specifically, the receiver may change the high-resolution video data having the first aspect ratio in accordance with the aspect ratio of the receiver by using screen control information and may then be capable of displaying the changed data.

According to the first exemplary embodiment, the aspect ratio control information may include merging information indicating that the encoded video data are transmitted after being divided and merging the divided video data. According to the second and fourth exemplary embodiments, the aspect ratio control information may include division information that can divide the encoded video data to best fir the aspect ratio. In addition, according to the third exemplary embodiment, the aspect ratio control information may include position information for subtitle positioning, which allows subtitle positions of the video to be changed in accordance with the resolution of the video respective to the encoded video data.

Therefore, in case the transmitter transmits the video data in accordance with each exemplary embodiment, even in case there are several types of aspect ratios in the receiver display apparatus, or even in case there are several types of performed, the high-resolution video may be displayed in accordance with the aspect ratio of each corresponding display, or the subtitles may be displayed. Additionally, even in case of the legacy receiver, the high-resolution video data may be displayed in accordance with the aspect ratio of the corresponding receiver.

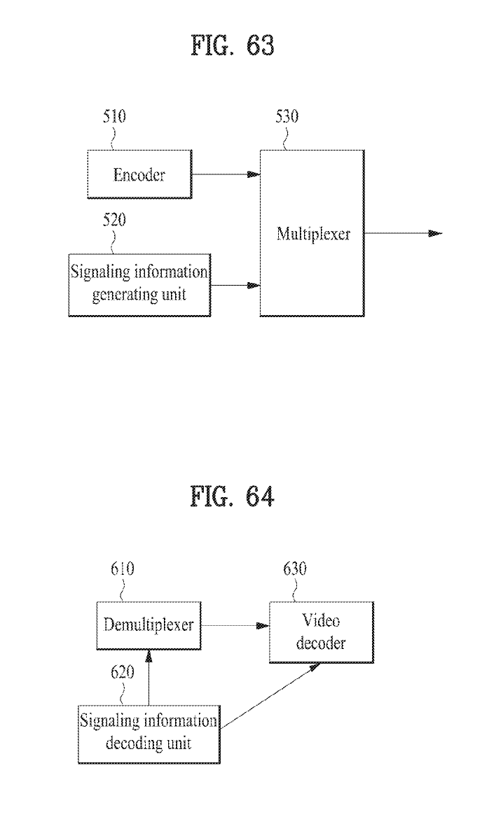

FIG. 63 illustrates an apparatus for transmitting signals according to an exemplary embodiment of the present invention.

A signal transmitting apparatus according to an exemplary embodiment may include an encoder 510, a signaling information generating unit 520, and a multiplexer 530.

The encoder 510 encodes video data. In case of encoding the video data, according to the exemplary embodiment of the present invention, encoding information of the video data may be included in the encoded video data. The encoding information that can be included in the encoded video data has already been described above in detail in FIG. 60.

The encoded video data may have different structures depending upon the disclosed exemplary embodiments, and such exemplary embodiments may vary in accordance with FIGS. 29 and 30 (First embodiment), FIG. 31 (Second embodiment), FIGS. 32 to 34 (Third embodiment), and Fourth embodiment.

For example, the encoded video data consists of a structure having high-resolution video divided to fit the conventional (or already-existing) aspect ratio and may include information, which allows the divided video data to be merged back to the high-resolution video. Alternatively, the encoded video data may include information allowing the high-resolution video data to be divided to fit the aspect ratio of the receiver or may also include position information of a letter for positioning subtitle information (e.g., AFD bar).

In case the transmitted signal corresponds to a broadcast signal, the signal transmitting apparatus according to an exemplary embodiment includes a signaling information generating unit 520, which is provided separately from the encoder 510. The signaling information generating unit 520 generates signaling information that signals displaying the encoded video data to fit the aspect ratio of the receiver. An example of the signaling information may include diverse information, which are given as examples in FIGS. 43 to 54 and FIGS. 56 to 59 according to the respective exemplary embodiment, and, herein, the diverse information, which are given as examples in the drawings according to the respective exemplary embodiment, may be generated. The signaling information may include signaling information that signals displaying high-resolution video data having a first aspect ratio on the receiver regardless of the aspect ratio. For example, the signaling information that signals displaying high-resolution video data on the receiver regardless of the aspect ratio may include aspect ratio control information of the high-resolution video data.

The multiplexer 530 multiplexes the encoded video data and the signaling information and transmits the multiplexed video data and signaling information.

In case the transmitter transmits the video data in accordance with each exemplary embodiment, even in case there are several types of aspect ratios in the receiver display apparatus, or even in case there are several types of performed, the high-resolution video may be displayed in accordance with the aspect ratio of each corresponding display, or the subtitles may be displayed. Additionally, even in case of the legacy receiver, the high-resolution video data may be displayed in accordance with the aspect ratio of the corresponding receiver.

In case the transmitted data do not correspond to the broadcast signal, the signaling information generating unit 520, which generates signaling information that is multiplexed with the video data, may be omitted, and the multiplexer 530 multiplexes video data including only signaling information within an encoded video data section with other data (e.g., audio data) and outputs the multiplexed data.

FIG. 64 illustrates an apparatus for receiving signals according to an exemplary embodiment of the present invention.

A signal receiving apparatus according to the exemplary embodiment may include a demultiplexer 610, a signaling information decoding unit 620, and a video decoder 630.

The demultiplexer 610 demultiplexes the video streams and the signaling information.

Video data being included in a video stream may have different structures depending upon the exemplary embodiments, and such exemplary embodiments may vary in accordance with FIGS. 29 and 30 (First embodiment), FIG. 31 (Second embodiment), FIGS. 32 to 34 (Third embodiment), and Fourth embodiment. For example, the received video data may include data, which allow high-resolution video to be divided to fit the conventional (or already-existing) aspect ratio and transmitted accordingly, and which allow the divided data to be merged back to the high-resolution video. Alternatively, the received video data may include information allowing the high-resolution video data to be divided to fit the aspect ratio of the receiver or may also include position information of a letter for positioning subtitle information (e.g., AFD bar).

The signaling information decoding unit 620 decodes the demultiplexed signaling information. The demultiplexed signaling information may include diverse information, which are given as examples in FIGS. 43 to 54 and FIGS. 56 to 59 according to the respective exemplary embodiment, and, herein, the diverse information, which are given as examples in the above-mentioned drawings according to the respective exemplary embodiment, may be decoded. The signaling information may include signaling information that signals displaying high-resolution video data having a first aspect ratio on the receiver regardless of the aspect ratio. For example, the signaling information that signals displaying high-resolution video data on the receiver regardless of the aspect ratio may include aspect ratio control information of the high-resolution video data.

The video decoder 630 decodes video data with respect to the signaling information according to the exemplary embodiment. Video data information including coding information respective to a video data syntax, which is given as an example in FIG. 60, may be included in the video data. In case of decoding the video data, the corresponding video data may be outputted as decoded, or may be merged, or may be outputted after positioning subtitles therein.

In case the received high-resolution video data are divided to fit the already-existing aspect ratio and transmitted accordingly, the aspect ratio control information may include data that can merge the received high-resolution video data back to the high-resolution video. Alternatively, the signaling information may include information allowing the high-resolution video data to be divided to fit the aspect ratio of the receiver or may also include position information of a letter for positioning subtitle information (e.g., AFD bar).

Therefore, in case the transmitter transmits the video data in accordance with each exemplary embodiment, even in case there are several types of aspect ratios in the receiver display apparatus, or even in case there are several types of performed, the high-resolution video may be displayed in accordance with the aspect ratio of each corresponding display, or the subtitles may be displayed. Additionally, even in case of the legacy receiver, the high-resolution video data may be displayed in accordance with the aspect ratio of the corresponding receiver.

Modules or units may be processors executing consecutive processes stored in a memory (or a storage unit). The steps described in the aforementioned embodiments can be performed by hardware/processors. Modules/blocks/units described in the above embodiments can operate as hardware/processors. The methods proposed by the present invention can be executed as code. Such code can be written on a processor-readable storage medium and thus can be read by a processor provided by an apparatus.

While the embodiments have been described with reference to respective drawings for convenience, embodiments may be combined to implement a new embodiment. In addition, designing computer-readable recording media storing programs for implementing the aforementioned embodiments is within the scope of the present invention.

The apparatus and method according to the present invention are not limited to the configurations and methods of the above-described embodiments and all or some of the embodiments may be selectively combined to obtain various modifications.

The methods proposed by the present invention may be implemented as processor-readable code stored in a processor-readable recording medium included in a network device. The processor-readable recording medium includes all kinds of recording media storing data readable by a processor. Examples of the processor-readable recording medium include a ROM, a RAM, a CD-ROM, a magnetic tape, a floppy disk, an optical data storage device and the like, and implementation as carrier waves such as transmission over the Internet. In addition, the processor-readable recording medium may be distributed to computer systems connected through a network, stored and executed as code readable in a distributed manner.

### MODE FOR CARRYING OUT THE PRESENT INVENTION

Various embodiments have been described in the best mode for carrying out the invention.

### INDUSTRIAL APPLICABILITY

The present invention is applied to broadcast signal providing fields.

Various equivalent modifications are possible within the spirit and scope of the present invention, as those skilled in the relevant art will recognize and appreciate. Accordingly, it is intended that the present invention cover the modifications and variations of this invention provided they come within the scope of the appended claims and their equivalents.

1. A method of transmitting media data, the method comprising:
generating a media file comprising three-dimensional (3D) video data and metadata; and
transmitting the media file,
wherein the media file comprises left view image data and right view image data of the 3D video data as at least one track; and
wherein the metadata comprises stereoscopic composition type information of the 3D video data.

2. The method according to claim 1, wherein the 3D video data is scalable high efficiency video coding (SHVC)-encoded data.

3. The method according to claim 1, wherein the metadata further comprises information indicating whether two-dimensional (2D) service is capable of being provided using the 3D video data.

4. The method according to claim 3, wherein the metadata further comprises information indicating a number of tracks for the 2D service, included in the media file.

5. The method according to claim 1, wherein the metadata further comprises information indicating an identifier (ID) of a track for a 2D service of at least one track included in the media file.

6. The method according to claim 1, wherein, when the track included in the media file comprises a plurality of layers, the metadata comprises information on a number of the layers included in the track, information on a number of layers for a 2D service among the plurality of layers, and information on an identifier of the layer for the 2D service.

7. The method according to claim 1, wherein, when the track included in the media file comprises a plurality of layer, the metadata comprises information indicating a number of layers included in at least one track corresponding to a corresponding one of a left view and right view for a 3D service among the plurality of layers.

8. A media data transmission device comprising:
a file generator configured to generate a media file comprising three-dimensional (3D) video data and metadata; and
a transmitter configured to transmit the media file,
wherein the media file comprises left view image data and right view image data of the 3D video data as at least one track; and
wherein the metadata comprises stereoscopic composition type information of the 3D video data.

9. The media data transmission device according to claim 8, wherein the 3D video data is scalable high efficiency video coding (SHVC)-encoded data.

10. The media data transmission device according to claim 8, wherein the metadata further comprises information indicating whether two-dimensional (2D) service is capable of being provided using the 3D video data.

11. The media data transmission device according to claim 10, wherein the metadata further comprises information indicating a number of tracks for the 2D service, included in the media file.

12. The media data transmission device according to claim 8, wherein the metadata further comprises information indicating an identifier (ID) of a track for a 2D service of at least one track included in the media file.

13. The media data transmission device according to claim 8, wherein, when the track included in the media file comprises a plurality of layers, the metadata comprises information on a number of the layers included in the track, information on a number of layers for a 2D service among the plurality of layers, and information on an identifier of the layer for the 2D service.

14. The media data transmission device according to claim 8, wherein, when the track included in the media file comprises a plurality of layer, the metadata comprises information indicating a number of layers included in at least one track corresponding to a corresponding one of a left view and right view for a 3D service among the plurality of layers.
